(19) United States
(12) Patent Application Publication
(10) Pub. No.: US 2026/0269932 A1
(43) Pub. Date: Sep. 10, 2026

(54) SINGLE-DIRECTION CROSSLINKS IN SATELLITE COMMUNICATION SYSTEMS

(71) Applicant: Viasat, Inc., Carlsbad, CA (US)

(72) Inventor: Kenneth V. BUER, Bluff City, TN (US)

(21) Appl. No.: 19/165,995

(22) PCT Filed: Mar. 14, 2024
(86) PCT No.: PCT/US2024/019890

§ 371 Date: Sep. 16, 2025

Related U.S. Application Data
(60) Provisional application No. 63/491,022, filed on Mar. 17, 2023.

(51) Int. Cl. H04B 7/185; H04B 7/0408; H04B 7/06

(52) U.S. Cl. CPC H04B 7/18532; H04B 7/0408; H04B 7/0617; H04B 7/18513; H04B 7/18515; H04B 7/18517; H04B 7/18519; H04B 7/18521

(57) ABSTRACT

Satellites in a communication system may be equipped with phased array antenna systems that includes various configurations of antenna arrays. One or more first satellites may be configured as part of a forward link path to relay forward link signaling from a gateway terminal to a user terminal. One or more second satellites may be configured as part of a return link path to relay return link signaling from the user terminal to a gateway terminal. The first satellites, the second satellites, or both may include at least one crosslink relay configured to receive signaling from a first satellite via a reception antenna array on a first side of the crosslink relay within a crosslink frequency band, and configured to transmit signaling to a second satellite via a transmission antenna array on a second side of the crosslink relay within the crosslink frequency band.

### CROSS REFERENCES

The present application for patent is a 371 national phase filing of International Patent Application No. PCT/US2024/019890 by Buer, entitled “SINGLE-DIRECTION CROSSLINKS IN SATELLITE COMMUNICATION SYSTEMS,” filed Mar. 14, 2024, which claims the benefit of and priority to U.S. Provisional Patent Application No. 63/491,022 by Buer, entitled “LOW EARTH ORBIT SATELLITE SYSTEM,” filed Mar. 17, 2023, each of which is assigned to the assignee hereof, and each of which is expressly incorporated by reference in its entirety herein.

### FIELD OF TECHNOLOGY

The following relates to communication systems, including techniques for single-direction crosslinks in satellite communication systems.

### BACKGROUND

In some communication systems, terrestrial-based terminals may support wireless signaling of a communication service via a constellation of satellites, which may include satellites that are in respective non-geostationary orbits (NGSOs), such as a low Earth orbit (LEO) or a medium Earth orbit (MEO). For example, a satellite in such a system may be configured with one or more antennas that support communications with or between terminals (e.g., gateway terminals, user terminals) of a ground segment, and may support various aspects of reconfiguration to perform the communications as the satellite traverses along an orbital path (e.g., for communications with different terminals or different locations). Some NGSO satellite communication systems may implement a relatively large quantity of satellites to maintain a service quality, such as a continuous service coverage for user terminals via one or more satellites of a constellation. To support deployment of a relatively large quantity of satellites (e.g., in an NGSO satellite communication system), various design tradeoffs are considered among satellite characteristics, including cost, complexity, performance, power consumption, reliability, weight, size, form factor, and others.

### SUMMARY

The described techniques relate to communication systems, including such systems that may implement satellites in a non-geostationary orbit (NGSO) to support wireless signaling of a communication service. Such a communication system may include one or more satellites that support relaying signals between target devices, such as signals between gateway terminals and user terminals. For example, a satellite in a satellite communication system may support receiving uplink signals (e.g., forward uplink signals from gateway terminals, return uplink signals from user terminals) and transmitting downlink signals (e.g., forward downlink signals to user terminals, return downlink signals to gateway terminals) that are based on the received uplink signals (e.g., in accordance with a bent pipe payload configuration, in accordance with a processing payload configuration). In some implementations, signals of a satellite communication system may be relayed via multiple satellites in the constellation, such that one or more satellites in the satellite communication system may support receiving crosslink signals (e.g., from another satellite), transmitting crosslink signals (e.g., to another satellite), or both.

A communication satellite in an satellite communication system may be equipped with an antenna system that includes various configurations of antenna arrays to receive and transmit signals, and a transponder system coupled with such antenna arrays that is configured to route signals between one or more reception ports (e.g., of a reception system) and one or more transmission ports (e.g., of a transmission system) of the antenna system. In some examples, an antenna array or associated circuitry may be configured to perform directional reception (e.g., receive beamforming), directional transmission (e.g., transmit beamforming), or both along one or more directions (e.g., beam directions, one or more directions concurrently, one or more directions in accordance with a beam hopping configuration). In some examples, a transponder system between an array for signal reception and an array for signal transmission may perform one or more aspects of signal processing, such as frequency conversion, demodulation or modulation, multiplexing, signal extraction or insertion, analog-to-digital conversion or digital-to-analog conversion, or other examples of signal processing.

To support payloads that may be efficiently implemented in a relatively large quantity of satellites (e.g., in an NGSO satellite communication system), a satellite may be configured with particular combinations of components in a reception system (e.g., one or more reception antenna systems, one or more reception subsystems), a transmission system (e.g., one or more transmission antenna systems, one or more transmission subsystems), and a transponder system between the reception system and the transmission system (e.g., to support various aspects of relayed communications). For example, in accordance with examples disclosed herein, a satellite may include a reception system having one or more antenna elements (e.g., reception elements, direct-radiating antenna elements, a reception array, a panel array, a phased array) on a face of the satellite (e.g., a side of the satellite, a nadir face), and a transmission system having one or more antenna elements (e.g., transmission elements, direct radiating antenna elements, a transmission array, a panel array, a phased array) on the same face of the satellite. In some examples, such a reception system and transmission system may be configured to concurrently support forward link signaling (e.g., from a gateway terminal to one or more user terminals) and return link signaling (e.g., from one or more user terminals to a gateway terminal), which may implement signal orthogonality such as different polarizations or different frequency ranges between forward link signaling and return link signaling.

A transponder system in such a satellite may be configured with a forward link pathway (e.g., a forward link signal path) and a return link pathway (e.g., a return link signal path). For example, a forward link pathway may be coupled between a first output port of the reception system and a first input port of the transmission system. In some examples, the forward link pathway may be associated with a first signal polarization (e.g., of signals received by the reception system, of signals transmitted by the transmission system, or both). Further, a return link pathway may be coupled between a second output port of the reception system and a second input port of the transmission system and, in some examples, the return link pathway may be associated with a second signal polarization (e.g., orthogonal to the first signal polarization). In some such implementations, the reception system and the transmission system may be configured for signaling in different frequency ranges (e.g., non-overlapping frequency ranges), which may improve signal isolation between uplink and downlink signaling. In such a communication system, user terminals may be located relatively near to gateway terminals that serve communications with the user terminals (e.g., within a beamforming scan capability of the reception system and the transmission system, within a service coverage area), such that implementing respective antenna elements of the reception system and the transmission system on a same face of the satellite may support a relatively efficient payload.

In some examples, a satellite (e.g., an NGSO satellite) in accordance with the disclosed techniques may also be configured to support crosslink signaling, which may implement one or more additional antenna systems (e.g., one or more additional arrays, on different faces of the satellite). For example, a satellite may include another reception system (e.g., another reception array, another panel array) on another face of the satellite (e.g., opposite from a face including forward/return link antenna systems, a zenith face), or may include another reception system and another transmission system on different faces (e.g., opposite faces) of the satellite (e.g., faces perpendicular to a nadir face, supporting a crosslink relay that may be independent of a forward link relay, or a return link relay, or both). A corresponding transponder system may include one or more additional signal paths (e.g., in addition to a forward link pathway and a return link pathway), supporting various combinations of couplings and associated signal processing between the output ports and input ports of the multiple antenna systems on different faces of the satellite.

A satellite (e.g., an NGSO satellite) in such configurations may also include a control system (e.g., one or more controllers) that support various operational modes of the satellite. For example, such a control system may be configured to enable various signal paths (e.g., beam signal paths, relay paths, transponders) of a transponder system to support various couplings between reception systems and transmission systems, including related aspects of signal processing. Additionally, or alternatively, such a control system may configure aspects of directional reception, directional transmission, or both, such as modifying beam weights or beam hopping at one or more beamforming networks of the reception system, the transmission system, or both. Additionally, or alternatively, such a control system may be configured to modify orbital characteristics of the satellite (e.g., in coordination with enabling transponder signal paths and configuring beamforming parameters), such as modifying an alignment of the satellite (e.g., body-steering the satellite to align satellite faces or antenna systems along various directions, using an angular momentum system of the satellite), or changing the orbital path itself (e.g., changing an altitude of the satellite, redirecting the orbital path of the satellite, using a thruster). In various implementations, such control systems may perform operations based on a configuration at the satellite (e.g., a preconfiguration, a hardware configuration, a software configuration), based on signaling received at the satellite (e.g., command signaling, parameter signaling, instructions, from a network controller, from a terminal), based on detections at the satellite (e.g., sensor measurements, communications measurements, of characteristics of the satellite, of signal quality characteristics, of characteristics of communications relayed by the satellite, of environmental characteristics), or any combination thereof.

Thus, in accordance with these and other aspects of the present disclosure, a satellite may be configured for a satellite communication system (e.g., an NGSO communication system) with a payload that supports efficient deployment of a constellation of a relatively high quantity of satellites. Further, a satellite communication system may be configured to operate such a constellation of satellites in a relatively flexible manner, such as configuring satellites for various physical orientations, signaling orientations (e.g., beamforming orientations), and transponder configurations (e.g., signal path configurations, between one or more reception systems and one or more transmission systems) for uplink signaling, downlink signaling, crosslink signaling, or various combinations thereof. Such techniques may provide particular advantages for trading off characteristics such as cost, complexity, performance, power consumption, reliability, weight, size, form factor, and others for deploying and operating various satellite communication systems, such as NGSO satellite communication systems.

Further scope of the applicability of the described methods and systems will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

FIG. 1 shows a diagram of a communication system that supports single-direction crosslinks in satellite communication systems in accordance with examples as disclosed herein.

FIGS. 2A and 2B show an example of a satellite that supports single-direction crosslinks in satellite communication systems in accordance with examples as disclosed herein.

FIGS. 3A and 3B show an example of a satellite that supports single-direction crosslinks in satellite communication systems in accordance with examples as disclosed herein.

FIG. 4 shows an example of a payload that supports single-direction crosslinks in satellite communication systems in accordance with examples as disclosed herein.

FIGS. 5A through 5G show examples of payload configurations that support single-direction crosslinks in satellite communication systems in accordance with examples as disclosed herein.

FIG. 6 shows an example of a communication system implementation that supports single-direction crosslinks in satellite communication systems in accordance with examples as disclosed herein.

FIG. 7 shows an example of a method that supports single-direction crosslinks in satellite communication systems in accordance with examples as disclosed herein.

### DETAILED DESCRIPTION

A satellite communication system may include a constellation of satellites (e.g., NGSO satellites) that supports relaying signals between target devices, such as signals between gateway terminals and user terminals. For example, a satellite in a satellite communication system may support receiving uplink signals (e.g., forward uplink signals from gateway terminals, return uplink signals from user terminals) and transmitting downlink signals (e.g., forward downlink signals to user terminals, return downlink signals to gateway terminals) that are based on the received uplink signals (e.g., in accordance with a bent pipe payload configuration, in accordance with a processing payload configuration). In some implementations, signals of a satellite communication system may be relayed via multiple satellites in the constellation, such that one or more satellites in the satellite communication system may support receiving crosslink signals (e.g., from another satellite), transmitting crosslink signals (e.g., to another satellite), or both.

A communication satellite in an satellite communication system may be equipped with an antenna system that includes various configurations of antenna arrays to receive and transmit signals, and a transponder system coupled with such antenna arrays that is configured to route signals between one or more reception ports (e.g., of a reception system) and one or more transmission ports (e.g., of a transmission system) of the antenna system. In some examples, an antenna array or associated circuitry may be configured to perform directional reception (e.g., receive beamforming), directional transmission (e.g., transmit beamforming), or both along one or more directions (e.g., beam directions, one or more directions concurrently, one or more directions in accordance with a beam hopping configuration). In some examples, a transponder system between an array for signal reception and an array for signal transmission may perform one or more aspects of signal processing, such as frequency conversion, demodulation or modulation, multiplexing, signal extraction or insertion, analog-to-digital conversion or digital-to-analog conversion, or other examples of signal processing.

To support payloads that may be efficiently implemented in a relatively large quantity of satellites (e.g., in an NGSO satellite communication system), an NGSO satellite may be configured with particular combinations of components in a reception system (e.g., one or more reception antenna systems, one or more reception subsystems), a transmission system (e.g., one or more transmission antenna systems, one or more transmission subsystems), and a transponder system between the reception system and the transmission system (e.g., to support various aspects of relayed communications). For example, in accordance with examples disclosed herein, a satellite may include a reception system having one or more antenna elements (e.g., reception elements, direct-radiating antenna elements, a reception array, a panel array, a phased array) on a face of the satellite (e.g., a side of the satellite, a nadir face), and a transmission system having one or more antenna elements (e.g., transmission elements, direct radiating antenna elements, a transmission array, a panel array, a phased array) on the same face of the satellite. In some examples, such a reception system and transmission system may be configured to concurrently support forward link signaling (e.g., from a gateway terminal to one or more user terminals) and return link signaling (e.g., from one or more user terminals to a gateway terminal), which may implement signal orthogonality such as different polarizations or different frequency ranges between forward link signaling and return link signaling.

A transponder system in such a satellite may be configured with a forward link pathway (e.g., a forward link signal path) and a return link pathway (e.g., a return link signal path). For example, a forward link pathway may be coupled between a first output port of the reception system and a first input port of the transmission system. In some examples, the forward link pathway may be associated with a first signal polarization (e.g., of signals received by the reception system, of signals transmitted by the transmission system, or both). Further, a return link pathway may be coupled between a second output port of the reception system and a second input port of the transmission system and, in some examples, the return link pathway may be associated with a second signal polarization (e.g., orthogonal to the first signal polarization). In some such implementations, the reception system and the transmission system may be configured for signaling in different frequency ranges (e.g., non-overlapping frequency ranges), which may improve signal isolation between uplink and downlink signaling. In such a communication system, user terminals may be located relatively near to gateway terminals that serve communications with the user terminals (e.g., within a beamforming scan capability of the reception system and the transmission system, within a service coverage area), such that implementing respective antenna elements of the reception system and the transmission system on a same face of the satellite may support a relatively efficient payload.

In some examples, a satellite (e.g., an NGSO satellite) in accordance with the disclosed techniques may also be configured to support crosslink signaling, which may implement one or more additional antenna systems (e.g., one or more additional arrays, on different faces of the satellite). For example, a satellite may include another reception system (e.g., another reception array, another panel array) on another face of the satellite (e.g., opposite from a face including forward/return link antenna systems, a zenith face), or may include another reception system and another transmission system on different faces (e.g., opposite faces) of the satellite (e.g., faces perpendicular to a nadir face, supporting a crosslink relay that may be independent of a forward link relay, or a return link relay, or both). A corresponding transponder system may include one or more additional signal paths (e.g., in addition to a forward link pathway and a return link pathway), supporting various combinations of couplings and associated signal processing between the output ports and input ports of the multiple antenna systems on different faces of the satellite.

A satellite (e.g., an NGSO satellite) in such configurations may also include a control system (e.g., one or more controllers) that support various operational modes of the satellite. For example, such a control system may be configured to enable various signal paths (e.g., beam signal paths, relay paths, transponders) of a transponder system to support various couplings between reception systems and transmission systems, including related aspects of signal processing. Additionally, or alternatively, such a control system may configure aspects of directional reception, directional transmission, or both, such as modifying beam weights or beam hopping at one or more beamforming networks of the reception system, the transmission system, or both. Additionally, or alternatively, such a control system may be configured to modify orbital characteristics of the satellite (e.g., in coordination with enabling transponder signal paths and configuring beamforming parameters), such as modifying an alignment of the satellite (e.g., body-steering the satellite to align satellite faces or antenna systems along various directions, using an angular momentum system of the satellite), or changing the orbital path itself (e.g., changing an altitude of the satellite, redirecting the orbital path of the satellite, using a thruster). In various implementations, such control systems may perform operations based on a configuration at the satellite (e.g., a preconfiguration, a hardware configuration, a software configuration), based on signaling received at the satellite (e.g., command signaling, parameter signaling, instructions, from a network controller, from a terminal), based on detections at the satellite (e.g., sensor measurements, communications measurements, of characteristics of the satellite, of signal quality characteristics, of characteristics of communications relayed by the satellite, of environmental characteristics), or any combination thereof.

Thus, in accordance with these and other aspects of the present disclosure, a satellite may be configured for a satellite communication system (e.g., an NGSO communication system) with a payload that supports efficient deployment of a constellation of a relatively high quantity of satellites. Further, a satellite communication system may be configured to operate such a constellation of satellites in a relatively flexible manner, such as configuring satellites for various physical orientations, signaling orientations (e.g., beamforming orientations), and transponder configurations (e.g., signal path configurations, between one or more reception systems and one or more transmission systems) for uplink signaling, downlink signaling, crosslink signaling, or various combinations thereof. Such techniques may provide particular advantages for trading off characteristics such as cost, complexity, performance, power consumption, reliability, weight, size, form factor, and others for deploying and operating various satellite communication systems, such as NGSO satellite communication systems.

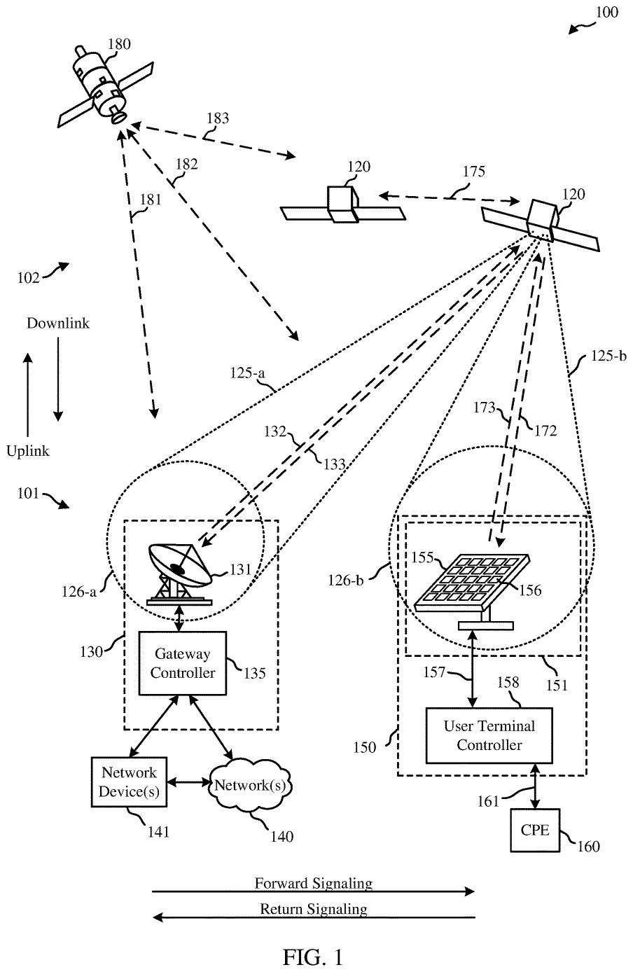

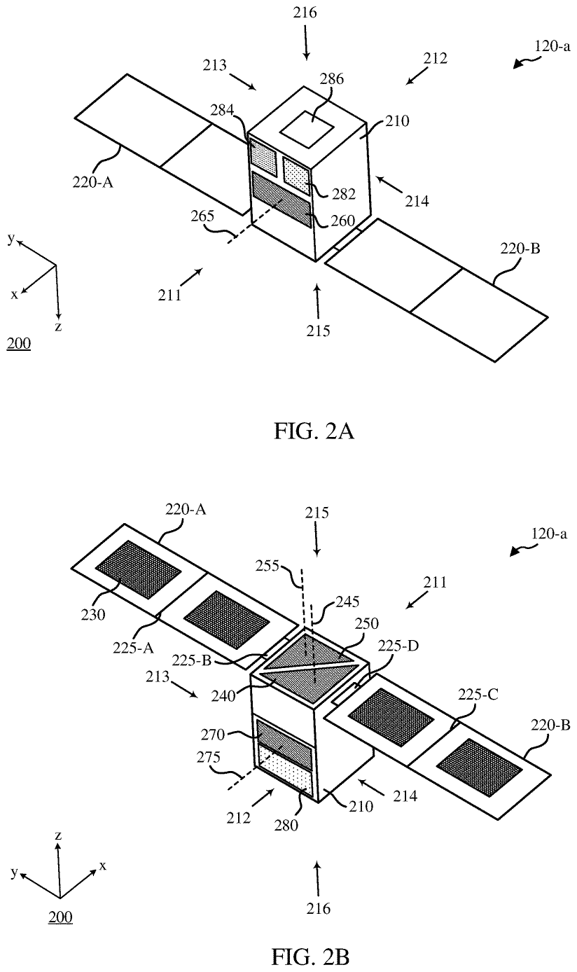

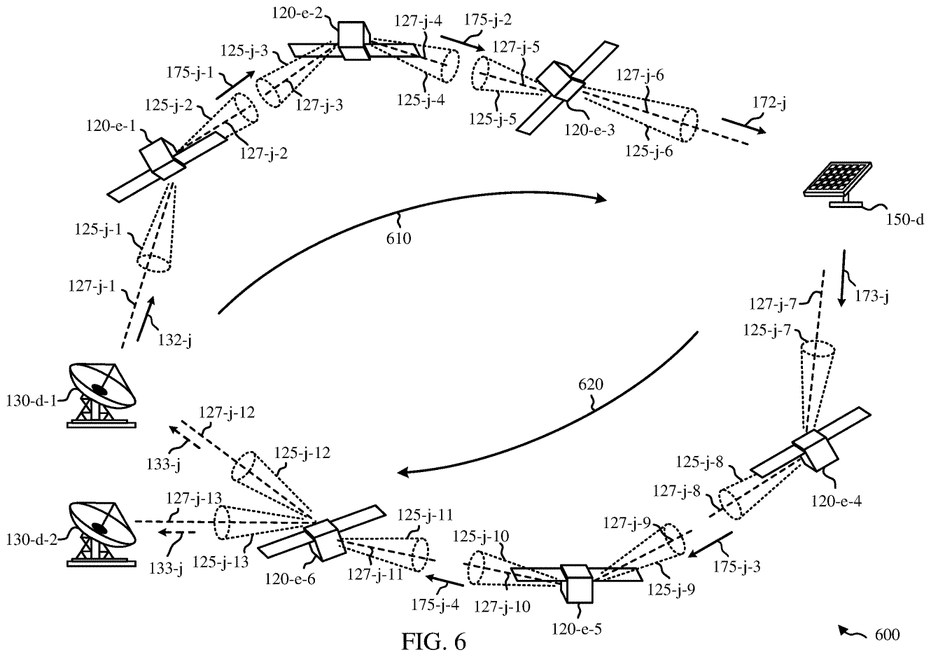

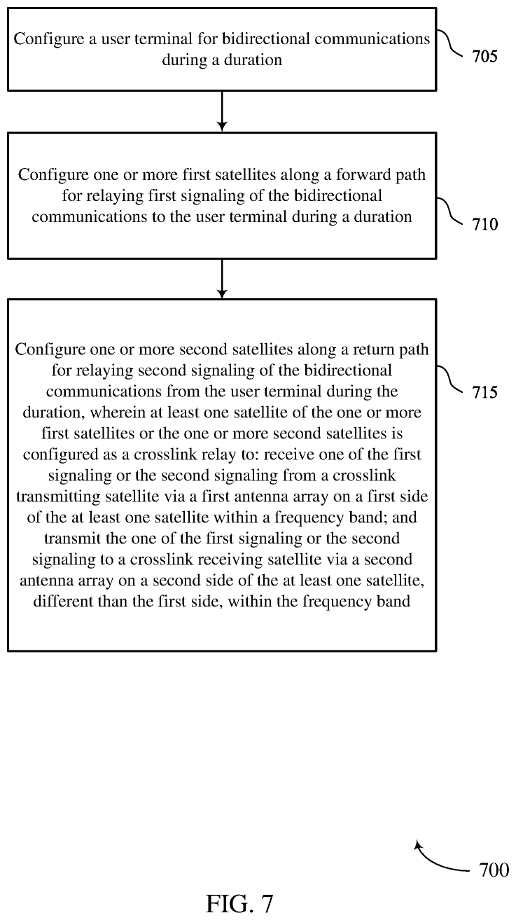

Features of the disclosure are initially described in the context of a communication system with reference to FIG. 1. Features of the disclosure are also described in the context of example satellites, payloads, and payload implementations with reference to FIG. 2A through 5G. Features of the disclosure are also described in the context of plots, satellite, user terminal, and gateway terminal implementations (e.g., communication system implementations), and methods with reference to FIGS. 6 and 7.

FIG. 1 shows a diagram of a communication system 100 (e.g., a satellite communication system) that supports single-direction crosslinks in satellite communication systems in accordance with examples as disclosed herein. A communication system 100 may use various architectures to support a communication service, such as an architecture that includes a ground segment 101 and space segment 102. A space segment 102 may include one or more satellites 120 (e.g., communications satellites). A ground segment 101 may include ground terminals, such as one or more user terminals 150 (e.g., service consumer terminals) and one or more gateway terminals 130 (e.g., access node terminals, network terminals, service provider terminals), as well as network devices 141 such as network operations centers (NOCs), satellite and gateway terminal command centers, and others. In some implementations, terminals of the communication system 100 (e.g., gateway terminals 130) may be communicatively coupled with each other, or with one or more networks 140, or a combination thereof (e.g., via a mesh network, via a star network, via a wired network, via a wireless network).

Satellites 120 may include any suitable type of satellite configured for wireless communication (e.g., for providing a communication service) with or between gateway terminals 130 and user terminals 150. In some examples, one or more of the satellites 120 (e.g., all of the satellites 120) may be in a respective orbit for which a position of the satellite 120 relative to Earth changes over time (e.g., an NGSO, such as a low Earth orbit (LEO) or medium Earth orbit (MEO)). Although at least some techniques are described herein with reference to a satellite 120 being an example of a device that supports relaying communications between ground terminals, one or more techniques described herein may be applicable to other types of devices operable to relay signaling (e.g., between ground terminals), which may have a generally overhead location relative to ground terminals (e.g., a plane, an unmanned aerial vehicle, a drone, a dirigible), or may be ground-based relays, including mobile or stationary relay devices.

The communication system 100 may support uplink signaling (e.g., from the ground segment 101 to the space segment 102), downlink signaling (e.g., from the space segment 102 to the ground segment 101), crosslink signaling (e.g., between devices of the space segment 102, such as between satellites 120), or any combination thereof. The communication system 100 also may support forward signaling (e.g., from gateway terminals 130 to user terminals 150), and return signaling (e.g., from user terminals 150 to gateway terminals 130), among other signaling (e.g., signaling between gateway terminals 130, signaling between user terminals 150, signaling between satellites 120) or any combination thereof. For example, a satellite 120 may receive uplink signals 132 (e.g., forward uplink signals) from one or more gateway terminals 130, and also may transmit downlink signals 172 (e.g., forward downlink signals) to one or more user terminals 150, which may be associated with (e.g., include) relaying forward link signaling. Additionally, or alternatively, a satellite 120 may receive uplink signals 173 (e.g., return uplink signals) from one or more user terminals 150, and also may transmit downlink signals 133 (e.g., return downlink signals) to one or more gateway terminals 130, which may be associated with relaying return link signaling. Additionally, or alternatively, a first satellite 120 may transmit crosslink signals 175 that may be received by a second satellite 120, which may include forward crosslink signaling (e.g., between forward uplink signals 132 and forward downlink signals 172), return crosslink signaling (e.g., between return uplink signals 173 and return downlink signals 133), or a combination thereof.

Various physical layer modulation and coding techniques may be supported for the communication of signals between gateway terminals 130 and user terminals 150 (e.g., via one or more satellites 120), such as multi-frequency time-division multiple access (MF-TDMA), time division multiple access (TDMA), frequency division multiple access (FDMA), orthogonal frequency division multiple access (OFDMA), code division multiple access (CDMA), or any hybrid or other schemes known in the art. In various examples, physical layer techniques may be the same for each of the signals 132, 133, 172, 173, and 175, or at least some of such signals may use different physical layer techniques than other such signals. A satellite 120 may support communications using one or more frequency bands, and any quantity of sub-bands thereof. For example, one or more of the satellites 120 may respectively support operations in any one or more of a W-band, a V-band, a Ka-band, a K-band, a Ku-band, an X-band, a C-band, an S-band, an L-band, or a V-band, among other bands or combinations of bands.

A satellite 120 may include a system of one or more antennas (e.g., one or more antenna systems, one or more transmission subsystems, one or more reception subsystems), such as a panel array antenna, a phased array antenna, a direct-radiating phased array antenna, a phased array fed reflector (PAFR) antenna, or any other components known in the art for transmission or reception of signals of a communication service. In some examples, an antenna system may support communication via one or more beamformed beams 125 (e.g., a beam associated with directional transmission, a beam associated with directional reception, a beam associated with directional transmission and directional reception), which may be referred to as spot beams, service beams, satellite beams, or any other suitable terminology. Signals may be passed via an array of feed elements of an antenna system (e.g., via a beamformer) of a satellite 120 to transmit or receive a spatial electromagnetic radiation pattern (e.g., scan volume) of the beams 125. In some examples, a beam 125 may use or be otherwise associated with a single carrier (e.g., for a beam signal of a given frequency or contiguous frequency range).

In some examples, a beam 125 may be configured (e.g., by location, by frequency range, by polarization) to support only gateway terminals 130 (e.g., a single gateway terminal 130), in which case the beam 125 may be referred to as a gateway beam or a gateway spot beam (e.g., gateway beam 125-a). For example, a gateway beam 125-a may be configured to support one or more uplink signals 132 between the satellite 120 and a gateway terminal 130 (e.g., forward uplink signals, as a receive beam of the satellite 120), one or more downlink signals 133 between the satellite 120 and a gateway terminal 130 (e.g., return downlink signals, as a transmit beam of the satellite 120), or a combination thereof. In some examples, a satellite 120 may support a first gateway beam 125 (e.g., an uplink gateway beam, a forward gateway beam) for receiving uplink signals 132 (e.g., forward uplink signals, to output a forward uplink beam signal), and may support a second gateway beam 125 (e.g., a downlink gateway beam, a return gateway beam) for transmitting downlink signals 133 (e.g., return downlink signals, to obtain a return downlink beam signal). In various examples, such techniques may include gateway beams 125 that are aligned along the same direction from a satellite 120 (e.g., toward the same gateway terminal 130, for concurrently supporting forward and return traffic), or aligned along different directions from a satellite 120 (e.g., toward respective different gateway terminals 130 for forward and return traffic), or supported via different antenna systems (e.g., a reception antenna system and a transmission antenna system) or portions thereof of a satellite 120, or both.

In some examples, a beam 125 may be configured (e.g., by location, by frequency range, by polarization) to support only user terminals 150 (e.g., one or more user terminals 150), in which case the beam 125 may be referred to as a user beam or a user spot beam (e.g., user beam 125-b). For example, a user beam 125-b may be configured to support one or more downlink signals 172 (e.g., forward downlink signals, as a transmit beam of the satellite 120), one or more uplink signals 173 (e.g., return uplink signals, as a receive beam of the satellite 120) between the satellite 120 and user terminals 150, or a combination thereof. In some examples, a satellite 120 may support a first user beam 125 (e.g., a downlink user spot beam, a forward user spot beam) for transmitting downlink signals 172 (e.g., forward downlink signals, to output a forward downlink beam signal), and may support a second user beam 125 (e.g., an uplink user spot beam, a return user spot beam) for receiving uplink signals 173 (e.g., return uplink signals, to obtain a return uplink beam signal). In various examples, such techniques may include user beams 125 aligned along the same direction from a satellite 120 (e.g., toward the same portion of a service area, for concurrently supporting forward and return traffic in a same area), or user beams 125 along different directions from a satellite 120 (e.g., toward respective different portions of a service area, for supporting forward and return traffic in different areas), or supported via different antenna systems (e.g., a transmission antenna system and a reception antenna system) or portions thereof of a satellite 120, or both.

In some examples, a beam 125 may be configured to service both user terminals 150 and gateway terminals 130. For example, a beam 125 may be configured to support any combination of downlink signals 172, uplink signals 173, uplink signals 132, or downlink signals 133 between a satellite 120 and user terminals 150 and gateway terminals 130. In some examples, a satellite 120 may use a beam 125 for transmitting crosslink signals 175, or for receiving crosslink signals 175, or both (not shown). Such techniques may be supported by a satellite 120 using a same crosslink beam 125 for transmitting and receiving crosslink signals 175, or using a first crosslink beam 125 for transmitting crosslink signals 175 and a second crosslink beam 125 for receiving crosslink signals 175, which may be supported by a same antenna systems or different antenna systems of the satellite 120.

A beam 125 may support a communication service with target devices (e.g., user terminals 150, gateway terminals 130, satellites 120) that are located within a volume of a beam 125, such as being located in a beam coverage area 126 (e.g., a spot beam coverage area), or projection thereof (e.g., at different distances from a plane or surface of the beam coverage area 126). A beam coverage area 126 may be defined by an area of the electromagnetic radiation pattern of the associated beam 125, as projected on the ground or other reference surface, having a signal characteristic (e.g., signal strength, signal-to-noise ratio (SNR), signal-to-interference-plus-noise ratio (SINR)) that is above or otherwise satisfies a threshold. A spot beam coverage area 126 may cover any suitable service area (e.g., circular, elliptical, hexagonal, local, regional, national, planar, non-planar) and may support a communication service with any quantity of target devices located in the beam coverage area 126, which may include target devices located within the associated beam 125 (e.g., within a volume of the associated beam 125), but not necessarily at the reference surface of a beam coverage area 126, such as airborne terminals.

In some examples, a satellite 120 may support multiple beamformed beams 125 each associated with a respective beam coverage area 126, each of which may or may not overlap with another (e.g., adjacent) beam coverage area 126. For example, the satellite 120 may support one or more service areas (e.g., service coverage areas) using any quantity of beam coverage areas 126. A service area may be broadly defined as a coverage area from which, and/or to which, either a terrestrial transmission source, or a terrestrial receiver may participate in (e.g., transmit and/or receive signals associated with) a communication service via one or more satellite 120, and may be served by one or more beam coverage areas 126 via one or more satellites 120 (e.g., for a respective durations during which a satellite 120 in an NGSO is able to serve one or more beam coverage areas 126 that are at least partially overlapping with the service area). In some systems, the service coverage area for each communication link (e.g., a forward uplink coverage area, a forward downlink coverage area, a return uplink coverage area, and/or a return downlink coverage area) may be different.

User terminals 150 may include various devices configured to communicate signals with a satellite 120, or other target device, which may include fixed terminals (e.g., ground-based stationary terminals) or mobile terminals (e.g., terminals on boats, terminals on aircraft, terminals on ground-based vehicles), among other types of terminals. A user terminal 150 may communicate information via the satellite 120 or other target device, which may include communications via a gateway terminal 130 to a destination device such as a network device 141, or some other device or distributed server associated with a network 140. A user terminal 150 may communicate signals according to a variety of physical layer transmission modulation and coding techniques, including, for example, those defined with the DVB-S2, WiMAX, LTE, and DOCSIS standards, among other standards.

A user terminal 150 may include an antenna 155 that is configured for receiving downlink signals 172 (e.g., from a satellite 120), for transmitting uplink signals 173 (e.g., to a satellite 120), or both. An antenna 155 may be part of an antenna assembly 151 (e.g., a user terminal antenna assembly), which may also include various hardware for mounting or orienting the antenna 155. An antenna assembly 151 may also include circuits and/or processors for converting (e.g., performing frequency conversion, modulating/demodulating, multiplexing/demultiplexing, filtering, forwarding) between radio frequency (RF) communication signals (e.g., downlink signals 172, uplink signals 173) and user terminal communications signals 157 communicated between the antenna 155 and a user terminal controller 158. Such circuits and/or processors may be included in an antenna assembly 151, which may be referred to as an integrated antenna assembly or processor-integrated antenna assembly. Additionally, or alternatively, the user terminal controller 158 may include circuits for performing various RF signal operations (e.g., receiving, performing frequency conversion, modulating/demodulating, multiplexing/demultiplexing, etc.). The antenna assembly 151 may also be known as a satellite outdoor unit (ODU), and the user terminal controller 158 may be known as an indoor unit (IDU).

In some examples, a user terminal 150 may be configured for uni-directional or bi-directional communications with the satellite 120 via a beam 125 (e.g., user beam 125-b). In some implementations, an antenna 155 may include an array (e.g., a two-dimensional array, a panel array, a phased array) of feed elements 156 that are physically arranged in a feed array assembly, and signals of respective feed elements 156 may be manipulated according to various beamforming techniques (e.g., phase and/or amplitude manipulation) to support terminal beams (e.g., terminal spot beams, not shown), such as transmit beams (e.g., for directional transmission) and receive beams (e.g., for directional reception). In other words, communication via an antenna 155 may be electronically configurable using the array of feed elements 156 to align signal transmission and/or reception along a desired direction (e.g., a terminal beam orientation). In some other implementations, a signaling direction of an antenna 155 may be mechanically configurable (e.g., mechanically steerable, with or without one or more reflectors, such as parabolic reflectors), or both electronically and mechanically configurable, or an antenna 155 may implement an omnidirectional antenna, among other techniques. Accordingly, an antenna 155 may be configured to track a satellite 120 in an NGSO to support directional communication signaling with the satellite 120.

A user terminal 150 may be connected via a wired or wireless connection 161 to one or more instances of consumer premises equipment (CPE) 160, and may provide network access service (e.g., access to a network 140, Internet access) or other communication services (e.g., broadcast media, multicast media) to CPEs 160 via one or more devices of the communication system 100. CPEs 160 may include user devices such as, but not limited to, computers, local area networks, internet appliances, wireless networks, mobile phones, personal digital assistants (PDAs), other handheld devices, netbooks, notebook computers, tablet computers, laptops, display devices (e.g., TVs, computer monitors), printers, sensors, vehicles, and other equipment. CPEs 160 may also include any equipment located at a premises of a subscriber, including routers, firewalls, switches, private branch exchanges (PBXs), Voice over Internet Protocol (VOIP) gateways, among others. In some examples, the user terminal 150 supports two-way communications between one or more CPEs 160 and one or more networks 140 (e.g., via one or more satellites 120, via one or more gateway terminals 130).

A gateway terminal 130 may service uplink signals 132 and downlink signals 133 (e.g., to and from one or more satellites 120). Gateway terminals 130 may also be known as ground stations, gateways, or hubs. A gateway terminal 130 may include a gateway antenna system 131 and a gateway controller 135 (e.g., an access node controller). A gateway antenna system 131 may be two-way capable and designed with adequate transmit power and receive sensitivity to communicate reliably with one or more satellites 120. In some examples, a gateway antenna system 131 may include a parabolic reflector with high directivity in the direction of a satellite 120 and low directivity in other directions. A gateway antenna system 131 may include a variety of other configurations that support operating features such as high isolation between orthogonal polarizations, high efficiency in the operational frequency bands, low noise, and other features.

In some examples, a gateway terminal 130 (e.g., a gateway controller 135, an access node controller) may schedule traffic to user terminals 150. Additionally, or alternatively, traffic scheduling may be performed in other parts of communication system 100 (e.g., at one or more network devices 141, which may include NOCs and/or gateway command centers). A satellite 120 may communicate with a gateway terminal 130 by transmitting downlink signals 133, receiving uplink signals 132, or both via one or more beams 125 (e.g., a gateway beam 125-a, which may be associated with a respective gateway beam coverage area 126-a). A gateway beam 125-a may, for example, support a communications service for one or more user terminals 150 (e.g., relayed by the satellite 120), or any other communications between the satellite 120 and the gateway terminal 130.

A gateway terminal 130 may provide an interface between the network 140 and the satellite 120, and may be configured to relay information directed between the network 140 and one or more user terminals 150. A gateway terminal 130 may format information for delivery to respective user terminals 150. Additionally, or alternatively, a gateway terminal 130 may be configured to receive signals from the satellite 120 (e.g., from one or more user terminals 150) directed to a destination accessible via network 140. A gateway terminal 130 may also format the received signals for transmission to a network 140.

The network(s) 140 may be any type of network and can include, for example, the Internet, an Internet Protocol (IP) network, an intranet, a wide-area network (WAN), a metropolitan area network (MAN), a local-area network (LAN), a virtual private network (VPN), a virtual LAN (VLAN), a fiber optic network, a hybrid fiber-coax network, a cable network, a public switched telephone network (PSTN), a public switched data network (PSDN), a public land mobile network, and/or any other type of network supporting communications between devices as described herein. Network(s) 140 may include both wired and wireless connections as well as optical links. Network(s) 140 may connect one or more gateway terminals 130 with other gateway terminals 130 that may be in communication with the satellites 120 or with other satellites. One or more network device(s) 141 may be coupled with a gateway terminal 130 and may control aspects of the communication system 100. In various examples a network device 141 may be co-located or otherwise nearby a gateway terminal 130, or may be a remote installation that communicates with a gateway terminal 130 and/or network(s) 140 via wired and/or wireless communications link(s).

In some examples, the communication system 100 (e.g., a space segment 102) may include a set (e.g., a constellation) of multiple satellites 120 to support a communications service. For example, service areas of such a communications service may be configured such that, at a given time, communications may be served by one or more satellites 120 passing over one or more service areas. In some examples, such techniques may also be supported by the communication system 100 including one or more satellites 180, which may include a satellite in a different orbit (e.g., a geostationary orbit) than the satellites 120. A satellite 180 may be implemented to support various techniques of the communication system 100. For example, a satellite 180 may be configured to support data signaling with or between gateway terminals 130 (e.g., via signals 181, which may include uplink signaling, downlink signaling, or both), with or between user terminals 150 (e.g., via signals 182, which may include uplink signaling, downlink signaling or both), or a combination thereof (e.g., as a relay between gateway terminals 130 and user terminals 150). Additionally, or alternatively, a satellite 180 may be configured to support data signaling with or via satellites 120 (e.g., via signals 183, as GEO link signals), including configurations in which signals 183 support crosslink relay signaling (e.g., of forward communications, of return communications) via the satellite 180. Additionally, or alternatively, a satellite 180 may support transmitting configuration signaling, such as for configuring operations of gateway terminals 130 (e.g., via signals 181), for configuring operations of user terminals 150 (e.g., via signals 182), or for configuring operations of satellites 120 (e.g., via signals 183), or any combination thereof.

In accordance with examples as disclosed herein, a satellite 120 may be configured for a communication system 100 with a payload that supports efficient deployment of a constellation of a relatively high quantity of satellites 120. Further, a communication system 100 may be configured to operate such a constellation of satellites 120 in a relatively flexible manner, such as configuring satellites 120 for various physical orientations, signaling orientations (e.g., beamforming orientations), and transponder configurations (e.g., signal path configurations, between one or more reception systems and one or more transmission systems of the satellite) for uplink signaling, downlink signaling, crosslink signaling, or various combinations thereof. Such techniques may provide particular advantages for trading off characteristics such as cost, complexity, performance, power consumption, reliability, weight, size, form factor, and others for deploying and operating a communication system 100.

FIGS. 2A and 2B show an example of a satellite 120-a that supports single-direction crosslinks in satellite communication systems in accordance with examples as disclosed herein. A satellite 120-a may be configured to be deployed in an NGSO, and support various aspects of the described techniques in a communication system 100. For example, a satellite 120-a may support targeted functionality for receiving and transmitting beam signals, which may allow for a relatively small size and relatively low complexity of the satellite 120-a. In some examples, a relatively small size of a satellite 120-a, among other factors, may support relatively low cost and overhead associated with deploying the satellite 120-a in a communication system 100. For example, multiple satellites 120-a may be deployed from a same launch vehicle payload, rather than launching and deploying satellites 120-a individually. Although some techniques are described with reference to a satellite 120-a operating in an NGSO, in some other examples, one or more of the described techniques may be implemented in a satellite 120 or a satellite 180 operating in a geostationary orbit, among other implementations.

A satellite 120-a may have a generally prismatic shape, and may be described with reference to an x-direction, a y-direction, and a z-direction of a coordinate system 200. A satellite 120-a may include a body portion 210 having sides (e.g., faces, which may be flat faces or curved faces), which may include a side 211, a side 212, a side 213, a side 214, a side 215, and a side 216. Although, in some examples, the sides of a satellite 120-a may be orthogonal, in some other examples, the sides of a satellite 120-a may be in different orientations, such as in a satellite 120-a having a trapezoidal prism shape, a rhomboidal prism shape, a hexagonal prism shape, or other shape.

In some examples, a satellite 120-a may include one or more panels 220 that are deployable from the body portion 210, such as panels 220-a and 220-b that are rotatably coupled with the body portion 210 using hinges 225. In some implementations, a panel 220 may carry one or more solar elements 230, which may be positioned on one or both sides of respective panels 220 and may provide power for operating components of a satellite 120-a. For example, the satellite 120-a may include a first solar panel array configured to deploy from a side 213 and a second solar panel array configured to deploy from a side 214. In some examples, a control system of a satellite 120-a may manage the deployment of the panels 220 using the hinges 225.

The satellite 120-a may support wireless communication between ground terminals, for example, by receiving uplink signaling (e.g., forward uplink signaling, return uplink signaling, uplink signals 132, uplink signals 173) using a reception array 240 (e.g., an uplink array, a panel array, a direct radiating array) and transmitting downlink signaling (e.g., forward downlink signaling, return downlink signaling, downlink signals 172, downlink signals 133) using a transmission array 250 (e.g., a downlink array, a panel array, a direct radiating array). For example, a reception array 240 may be configured for receiving signaling from ground terminals, and a transmission array 250 may be configured for transmitting signaling to ground terminals.

In some implementations, a satellite 120-a may also support wireless communication with or via other satellites 120 or satellites 180, for example, by receiving crosslink signaling (e.g., forward crosslink signaling, return crosslink signaling, crosslink signals 175, signals 183) using a reception array 260 (e.g., a crosslink reception array, a panel array, a direct radiating array) and, in some examples, transmitting crosslink signaling (e.g., forward crosslink signaling, return crosslink signaling, crosslink signals 175, signals 183) using a transmission array 270 (e.g., a crosslink transmission array, a panel array, a direct radiating array). For example, a reception array 260 may be configured for receiving signaling from other satellites, and a transmission array 270 may be configured for transmitting signaling to other satellites. Including an additional reception array 260 and an additional transmission array 270 may allow the satellite 120-a to communicate crosslink signals with an additional degree of freedom (e.g., for orienting the satellite 120-a, for orienting beams 125), for aligning beams 125 toward various target devices. Thus, a satellite 120-a may, in some examples, include two high-power transmission arrays.

Because signal transmissions may be associated with relatively high power usage, in some examples, the satellite 120-a may be operated in a power-limited configuration in which only one of the transmission array 250 or the transmission array 270 is enabled (e.g., at a given time). In various implementations, such a power-limited configuration may be a strict configuration of the satellite 120-a in which case the satellite 120-a never enables both the transmission array 250 and the transmission array 270 concurrently. In some other examples, such a power-limited configuration may be implemented situationally, such as when the satellite 120-a itself is operating in a low-power mode (e.g., associated with relatively low power supplied by one or more solar panels, associated with a relatively low amount of stored energy in a battery). In other words, the satellite 120-a, in some examples, may enable both the transmission array 250 and the transmission array 270 based on an amount of available power satisfying a threshold, which may be based on a power involved in supporting communications via the transmission array 250 and the transmission array 270. In some other examples, a reception array 260, a transmission array 270, or both may be omitted from a satellite 120-a (e.g., in an implementation of a satellite 120-a that may not support crosslinks, in an implementation of a satellite 120-a that supports crosslinks using one or both of a reception array 240 or a transmission array 250).

A reception array 240, a transmission array 250, a reception array 260, and a transmission array 270 may be physically arranged on (e.g., located on, fixed to) a satellite 120-a to support efficient communication of beam signals (e.g., via beams 125) with user terminals 150, gateway terminals 130, and other satellites 120 or satellites 180. For example, a reception array 240 and a transmission array 250 may both be located on the side 215 of a satellite 120-a, and a reception array 260 and a transmission array 270 may be located on different sides, such as sides that are opposite from one another. For example, a reception array 260 may be located on the side 211 of the satellite 120-a and a transmission array 270 may be located on the side 212 of the satellite 120-a (e.g., a side of the satellite 120-a opposite from the reception array 260), or on another side of a satellite 120-a (e.g., a side 213, a side 214) that is different than a side that includes a reception array 260 (e.g., providing two sides of the satellite 120-a for signal reception and two sides of the satellite 120-a for signal transmission). In some examples, a reception array 240 and a transmission array 250 may be discrete assemblies of antenna elements (e.g., an assembly of reception elements separate from an assembly of transmission elements), which may support relatively improved signal isolation and packaging, among other advantages. In some other examples, a reception array 240 and a transmission array 250 may refer to antenna elements that are interleaved (e.g., reception and transmission elements that are distributed among at least partially overlapping surface areas), or may be implemented as a single array that implements antenna elements for both reception and transmission (e.g., as transceiver elements).

To support communications with a ground segment 101 using the reception array 240, the transmission array 250, or both, a satellite 120-a may be oriented such that the side 215 (e.g., a nominal direction of the side 215, an axis of the side 215, the positive z-direction of the satellite 120-a) is aligned toward Earth (e.g., toward a service area, toward a location of a service area). Additionally, or alternatively, to support signal reception from another satellite 120 or a satellite 180 using the reception array 260, a satellite 120-a may be oriented such that the side 211 is generally aligned toward another satellite 120 or a satellite 180 (e.g., within a scan range of a beamformer of the reception array 260). Additionally, or alternatively, to support signal transmission to another satellite 120 or a satellite 180 using the transmission array 270, a satellite 120-a may be oriented such that the side 212 is generally aligned toward another satellite 120 or a satellite 180 (e.g., within a scan range of a beamformer of the transmission array 270). Such orientations may be configured based on the one or more types of relaying supported by the satellite 120-a at a given time.

A reception array 240, a transmission array 250, a reception array 260, and a transmission array 270 may each be associated with an axis (e.g., a nominal axis, a boresight axis, a boresight direction, an outward direction), which may be a nominal direction of the respective array. In some examples, such a nominal direction may be associated with a direction of peak gain capability (e.g., a direction of maximum radiated power, direction of maximum reception sensitivity, a direction of lowest distortion) of the array. For example, the reception array 240 may be associated with an axis 245, and the transmission array 250 may be associated with an axis 255, each of which may be aligned along the positive z-direction from the satellite 120-a (e.g., along a direction that is fixed with respect to the body portion 210, along a direction from the side 215, along parallel directions). Thus, aligning the reception array 240, the transmission array 250, or both toward a target may be associated with orienting the satellite 120-a such that the positive z-direction is aligned toward the target. Additionally, a reception array 260 may be associated with an axis 265, which may be aligned along the positive x-direction from the satellite 120-a (e.g., a direction perpendicular to or otherwise different than the axis 245, a direction perpendicular to or otherwise different than the axis 255, a direction different than the axis 245 and the axis 255). In some implementations, aligning the reception array 260 toward a target (e.g., a second target, along a second target direction) may additionally, or alternatively, be associated with orienting the satellite 120-a such that the positive x-direction is aligned toward the target. Additionally, a transmission array 270 may be associated with an axis 275, which may be aligned along the negative x-direction from the satellite 120-a (e.g., a direction perpendicular to or otherwise different than the axis 245, a direction perpendicular to or otherwise different than the axis 255, a direction different than the axis 245 and the axis 255, a direction opposite from or otherwise different than the axis 265). In some implementations, aligning the transmission array 270 toward a target (e.g., a third target, along a third target direction) may additionally, or alternatively, be associated with orienting the satellite 120-a such that the negative x-direction is aligned toward the target.

Thus, the satellite 120-a illustrates an example in which a reception array 240 (e.g., an axis 245) and a transmission array 250 (e.g., an axis 255) may be oriented along one direction from the satellite 120-a, a reception array 260 (e.g., an axis 265) may be oriented along a different direction from the satellite 120-a, and a transmission array 270 (e.g., an axis 275) may be oriented along a different direction from the satellite 120-a, providing multiple degrees of flexibility for orienting beams 125. Although, in the example of satellite 120-a, the direction of the axis 265 is separated from the direction of the axes 245 and 255 by 90 degrees (e.g., on a perpendicular face), in some other examples in accordance with the described techniques, the direction of an axis 265 may be separated from the direction of axes 245 and 255 by a different angle, such as 30 degrees, 45 degrees, 60 degrees, 120 degrees, 135 degrees, among others (e.g., as a fixed angle of separation between arrays). Further, although, in the example of satellite 120-a, the direction of the axis 275 is separated from the direction of the axis 265 by 180 degrees (e.g., pointing in opposite directions), in some other examples in accordance with the described techniques, the direction of an axis 275 may be separated from the direction of an axis 265 by a different angle, such as 45 degrees, 60 degrees, 90 degrees, 120 degrees, 135 degrees, among others (e.g., as a fixed angle of separation between arrays). Such techniques may be supported by faces of a satellite 120, or affixed arrays of antenna elements, that are not flat, such as with one or more curved arrays or other shapes of arrays that are otherwise associated with axes 245, 255, 265, and 275 (e.g., for a satellite 120 with one or more curved surfaces, such as cylindrical or spherical surfaces). Moreover, although, in the example of satellite 120-a, the axis 245 and the axis 255 are parallel, in some other examples, directions of the axis 245 and the axis 255 may be separated by a fixed angle, such as 10 degrees, 20 degrees, 30 degrees, 45 degrees, or some other fixed angle (e.g., between outward directions of sides of a satellite 120, between nominal directions of curved arrays of a satellite 120).

In some examples, a reception array 240 and a transmission array 250 may have a similar cross-sectional area, or a same quantity of antenna elements, or both. In some other examples, one of a reception array 240 or a transmission array 250 may be relatively larger than the other, or may have a relatively larger quantity of antenna elements, or may have relatively larger antenna elements, or a combination thereof. For example, the reception array 240 may be configured for receiving signals in a first frequency range, and the transmission array 250 may be configured for transmitting signals in a second frequency range that is non-overlapping with the first frequency range. In some examples, a reception array 260 may be configured for receiving signals in a third frequency range that is non-overlapping with the first frequency range and the second frequency range, and a transmission array 270 may be configured for transmitting signals in the third frequency range.

For examples in which the first frequency range is relatively higher than the second frequency range, a reception array 240 may be relatively smaller than a transmission array 250, which may be associated with the relatively shorter wavelengths of the relatively higher frequencies. Likewise, for examples in which the third frequency range is between the first frequency range and the second frequency range, a reception array 260, a transmission array 270, or both may be sized between the reception array 240 and the transmission array 250. However, in various other implementations, such relative sizing or quantities of antenna elements may be reversed or otherwise different between a reception array 240, a transmission array 250, a reception array 260, and a transmission array 270 (e.g., depending on relative frequencies supported by the respective arrays). Additionally, or alternatively, relative sizing or quantities of antenna elements may be balanced between a reception array 240, a transmission array 250, a reception array 260, and a transmission array 270 based on other criteria, such as link balancing or biasing via a satellite 120-a (e.g., balancing performance characteristics between forward link communications and return link communications, biasing performance characteristics to support relatively higher forward link throughput, balancing performance characteristics between gateway terminals and user terminals, such as associated antenna characteristics), among other balancing.

In some examples, a reception array 240, a transmission array 250, or both may have a triangular cross-section. For example, when sharing a face of a satellite 120-a, dividing the surface area of the face into triangles may support the reception array 240 and the transmission array 250 having more-uniform beamforming characteristics than if the surface area was divided into adjacent rectangles or other shapes. In some other examples, an area of a shared face of a satellite 120-a may be divided into rectangular cross-sections or other shapes for a reception array 240 and a transmission array 250 and, in operation, the satellite 120-a may be rotated such that any beamforming or other signaling asymmetries may be aligned favorably along a particular rotational direction. For example, a relatively longer dimension of the reception array 240 or the transmission array 250 may be aligned along a particular direction, such as a direction of separation between beams 125, which may reduce beamforming scan losses at angles relative to axes 245 and 255 or relative to the z-direction of the satellite 120-a.

A reception system of a satellite 120-a (e.g., a reception antenna system, an uplink antenna system, a reception system including a reception array 240, a crosslink reception antenna system, a reception system including a reception array 260) may support receiving beam signals (e.g., uplink signals 132, uplink signals 173, crosslink signals 175, signals 183, via a beam 125) from one or more target devices, such as one or more user terminals 150, one or more gateway terminals 130, another satellite 120, a satellite 180, or a combination thereof. For example, a reception array 240 may include one or more reception elements (e.g., reception antenna elements, reception feed elements) located on the side 215 that are configured to receive signaling from target devices, and a reception array 260 may include one or more reception elements on the side 211 that are configured to receive signaling from target devices.

In some implementations, reception elements of a reception array 240 may support reception of respective component signals associated with different polarizations, and may be associated with or may include respective ports (e.g., one or more ports, respective input ports, respective output ports) configured for component signals that are associated with a particular polarization. For example, a set of reception elements of the reception array 240 may receive first component signals (e.g., electromagnetic component signals) of a first receive beam signal, each first component signal having a first polarization. The received first component signals may be converted (e.g., into electrical signals, into electrical component signals) and output using a set of first antenna element ports (e.g., output ports). Thus, at least some of the reception elements may receive a portion or component of a first receive beam signal, and may output an associated electrical signal from respective first ports (e.g., to a first reception beamforming network corresponding to the first polarization). In some examples, the set of reception elements may also receive second component signals of a second receive beam signal, each second component signal having a second polarization (e.g., different than the first polarization, orthogonal to the first polarization). The received second component signals may be converted and output using a set of second antenna element ports. Thus, at least some of the reception elements also may receive a portion or component of a second receive beam signal, and may output an associated electrical signal from respective second ports (e.g., to a second reception beamforming network corresponding to the second polarization).

In some implementations, reception elements of a reception array 260 may support reception of respective component signals associated with a crosslink polarization (e.g., a single polarization, for signals received from another satellite 120 or from a satellite 180), which may be the same as one of the first polarization or the second polarization associated with reception elements of the reception array 240, or a different type of polarization. For example, a set of reception elements of the reception array 260 may receive third component signals of a third receive beam signal, each third component signal having the crosslink polarization. In some other examples, crosslink signaling supported by the satellite 120-a may be non-polarized. The received third component signals may be converted and output using a set of third antenna element ports (e.g., output ports). Thus, at least some of the reception elements of the reception array 260 may receive a portion or component of a third receive beam signal, and may output an associated electrical signal from respective third ports (e.g., to a third reception beamforming network corresponding to the crosslink polarization or lack thereof).

In some examples, a reception array 240 may be configured for receiving signaling in accordance with a first polarization that is associated with forward link communications and signaling in accordance with a second polarization that is associated with return link communications, in which case the first polarization may be orthogonal to the second polarization. For example, a first polarization may be an example of an LHCP, and a second polarization may be an example of an RHCP. Additionally, or alternatively, a first polarization and a second polarization may be linearly polarized, such as the first polarization having a vertical polarization and the second polarization having a horizontal polarization. A crosslink polarization supported by the reception array 260 may be an LHCP, an RHCP, a vertical polarization, or a horizontal polarization.

One or more reception systems of a satellite 120-a may include one or more beamforming networks, which may be configured to support directional reception via the reception array 240 (e.g., via a plurality of antenna elements of the reception array 240) relative to the axis 245, or to support directional reception via the reception array 260 (via a plurality of antenna elements of the reception array 260) relative to the axis 265. For example, such beamforming networks of the one or more reception systems may each be configured to output one or more beam signals in accordance with a respective beam 125 (e.g., a reception beam) using component signals from the set of reception elements of the reception array 240 or from the set of reception elements of the reception array 260.

In some implementations, one or more reception systems of a satellite 120-a may include a first beamforming network coupled with outputs of a set of first antenna element ports (e.g., associated with the reception array 240), which may receive a set of first component signals (e.g., forward link component signals) from the set of first antenna element ports. The first beamforming network may output a single beam signal (e.g., a forward link beam signal) associated with a first polarization, for example, to a transponder (e.g., to a forward link transponder, to a forward link signal path, to a part of a transponder system,), which may route the beam signal to a transmission system, such as a transmission system that includes a transmission array 250 and a transmission array 270. In some implementations, the one or more reception systems may also include a second beamforming network coupled with outputs of a set of second antenna element ports (e.g., associated with the reception array 240), which may receive a set of second component signals (e.g., return link component signals) from the set of second ports. The second beamforming network may output a single beam signal (e.g., a return link beam signal) associated with the second polarization, for example, to a transponder (e.g., to a return link transponder, to a return link signal path, to a part of the transponder system), that may route the beam signal to the transmission system. In some implementations, a reception system may also include a third beamforming network coupled with outputs of a set of third antenna element ports (e.g., associated with the reception array 260), which may receive a set of third component signals (e.g., crosslink component signals) from the set of third ports. The third beamforming network may output a single beam signal (e.g., a crosslink link beam signal) associated with the crosslink polarization, for example, to a transponder (e.g., to a crosslink signal path, to a part of the transponder system), that may route the beam signal to the transmission system.

A transmission system of a satellite 120-a (e.g., a transmission antenna system, a downlink antenna system, a transmission system including a transmission array 250, a crosslink transmission system, a transmission system including a transmission array 270) may support transmitting beam signals (e.g., downlink signals 133, downlink signals 172, crosslink signals 175, signals 183, via a beam 125) to one or more target devices, such as one or more user terminals 150, one or more gateway terminals 130, another satellite 120, a satellite 180, or a combination thereof. For example, a transmission array 250 may include one or more transmission elements (e.g., transmission antenna elements, transmission feed elements) located on the side 215 that are configured to transmit signaling to the target devices, and a transmission array 270 may include one or more transmission elements on the side 212 that are configured to transmit signaling from target devices. A transmission antenna element may include a physical transducer that converts an electrical signal (e.g., an electrical component signal) to an electromagnetic signal (e.g., an electromagnetic component signal).

A transmission system of a satellite 120-a may include one or more beamforming networks (e.g., transmit beamforming networks), which may be configured to support directional transmission via the transmission array 250 (e.g., via a plurality of antenna elements of the transmission array 250) relative to the axis 255, or to support directional transmission via the transmission array 270 (e.g., via a plurality of antenna elements of the transmission array 270) relative to the axis 275. For example, such beamforming networks of the transmission system may each be configured to transmit one or more beam signals in accordance with a respective beam 125 (e.g., a transmit beam) using components signals output to the set of transmission elements of the transmission array 250 or output to the set of transmission elements of the transmission array 270.

In some implementations, a transmission system may include a first beamforming network coupled with inputs of a set of first antenna element ports (e.g., of the transmission array 250). The first beamforming network may receive a single beam signal (e.g., a transmit beam signal, a forward link beam signal) associated with a first polarization, for example, from a transponder, which may route the beam signal from one or more reception systems that include the reception array 240 and the reception array 260. The first beamforming network may output a set of first component signals (e.g., forward link component signals) to the set of first antenna element ports for transmitting a single beam 125 associated with the first polarization. In some implementations, a transmission system may also include a second beamforming network coupled with inputs of a set of second antenna element ports (e.g., of the transmission array 250). The second beamforming network may receive a single beam signal (e.g., a return link beam signal) associated with a second polarization, for example, from a transponder, which may route the beam signal from the one or more reception systems. The second beamforming network may output a set of second component signals (e.g., return link component signals) to the set of second antenna element ports for transmitting a single beam 125 associated with the second polarization. In some implementations, a transmission system may also include a third beamforming network coupled with inputs of a set of third antenna element ports (e.g., of the transmission array 270). The third beamforming network may receive a single beam signal (e.g., a crosslink beam signal), for example, from a transponder, which may route the beam signal from the one or more reception systems. The third beamforming network may output a set of third component signals (e.g., crosslink component signals) to the set of third antenna element ports for transmitting a single beam 125 (e.g., associated a crosslink polarization or lack thereof).

In some implementations, transmission elements of the transmission array 250 may support transmission of respective component signals associated with different polarizations, and may be associated with or may include respective ports (e.g., respective input ports, respective output ports) configured for component signals that are associated with a particular polarization. For example, the set of transmission elements may receive the first component signals (e.g., electrical component signals, from a first transmission beamforming network corresponding to a first polarization) of a first transmit beam signal (e.g., a forward link beam signal) using a set of first antenna element ports (e.g., input ports), and the first component signals may be converted by the transmission elements into electromagnetic signals (e.g., electromagnetic component signals) that are transmitted by the transmission elements in accordance with a first polarization. Thus, at least some of the transmission elements may receive a portion or component of a first transmit beam signal, and may transmit an associated electromagnetic signal having a first polarization. In some examples, the set of transmission elements may receive second component signals (e.g., from a second transmission beamforming network corresponding to a second polarization) of a second transmit beam signal (e.g., a return link beam signal) using a set of second antenna element ports (e.g., input ports), and the second component signals may be converted by the transmission elements into electromagnetic signals that are transmitted by the transmission elements in accordance with a second polarization. Thus, at least some of the transmission elements may also receive a portion or component of a second transmit beam signal, and may transmit an associated electromagnetic signal having a second polarization (e.g., different than the first polarization, orthogonal to the first polarization).

In some examples, a transmission array 250 may transmit signaling in accordance with a first polarization that associated with forward link communications (e.g., signaling to user terminals 150), and a second polarization that is associated with return link communications (e.g., signaling to gateway terminals 130), in which case the first polarization may be orthogonal to the second polarization. For example, a first polarization may be an example of an LHCP, and a second polarization may be an example of an RHCP. Additionally, or alternatively, a first polarization and a second polarization may be linearly polarized, such as the first polarization having a vertical polarization and the second polarization having a horizontal polarization. In some implementations, a transmission array 250 may implement the same polarization as a reception array 240 for forward communications (e.g., implementing LHCP for a forward link), and the same polarization as a reception array 240 for return communications (e.g., implementing RHCP for a return link). In some other implementations, a transmission array 250 may implement a different polarization as a reception array 240, or a reception array 260, or both for forward communications, or for return communications, or both. In various examples, a transmission array 270 may transmit crosslink signaling in accordance with a crosslink polarization or without a polarization.

In some implementations, a satellite 120-a may include additional components to support wireless communications with gateway terminals 130, user terminals 150, other satellites 120, or a satellite 180, among other devices. For example, the satellite 120-a may include a patch antenna 284 (e.g., an S-band patch antenna), an omni antenna 282 (e.g., an omnidirectional antenna), or both, which may support communication (e.g., transmitting control signaling, receiving control signaling) in a limited frequency range (e.g., between 2 GHz and 4 GHZ, non-overlapping or otherwise different than the reception array 240, the transmission array 250, the reception array 260, and the transmission array 270). In some examples, one or more of such antennas may communicate control signaling (e.g., via a control band), such as scheduling information, orbital adjustment information, and others. Additionally, or alternatively, a patch antenna 284, an omni antenna 282, or both may support transmitting or receiving signals 182, receiving uplink signals 132, receiving uplink signals 173, transmitting downlink signals 133, transmitting downlink signals 172, transmitting or receiving crosslink signals 175, or any combination thereof, among other examples. In some examples, a patch antenna 284, an omni antenna 282, or both may be located on a side of the satellite 120-a that is different than a reception array 240 and a transmission array 250, such as a side 211, or a side 216 (e.g., opposite from the reception array 240 and the transmission array 250).

In some implementations, a satellite 120-a may include a tracking system 280 (e.g., a star tracker) to support detecting telemetry information of the satellite 120-a. For example, a tracking system 280 may measure positions of stars or other objects to determine a location of the satellite 120-a, a velocity of the satellite 120-a, an orientation of the satellite 120-a, or any combination thereof. In some examples, a satellite 120-a may determine or calculate an orbital path or other telemetry information using the characteristics of the satellite 120-a determined by the tracking system 280, and may transmit the telemetry information (e.g., using a telemetry beacon) or may use the telemetry information to control an orientation of the satellite 120-a (e.g., using an angular momentum system) or to determine a respective direction for one or more beams 125, among other implementations.

In some implementations, a satellite 120-a may include one or more components that support controlling orbital parameters of the satellite 120-a. For example, a satellite 120-a may include one or more thrusters 286 which, in some examples, may be located on a side of the satellite 120-a that is different than the reception array 240, the transmission array 250, the reception array 260, and the transmission array 270 (e.g., on a side 216), or one or more other sides. A thruster 286 may be operable to modify the orbital path of the satellite 120-a. Additionally, or alternatively, a satellite 120-a may include an angular momentum system (e.g., internal to the satellite 120-a, not shown) operable to orient (e.g., rotate) the satellite 120-a about one or more axes (e.g., to align one or more sides of the satellite 120-a along one or more target directions, to align an axis 245, an axis 255, an axis 265 an axis 275, or a combination thereof along one or more target directions).

A satellite 120-a may include a control system that supports various operations of the satellite 120-a. For example, such a control system may configure aspects of directional reception, directional transmission, or both, such as modifying beam weights or beam hopping at one or more beamforming networks of the reception system, the transmission system, or both. Additionally, or alternatively, such a control system may be configured to modify orbital characteristics of the satellite 120-a (e.g., in coordination with enabling transponder signal paths and configuring beamforming parameters), such as modifying an alignment of the satellite 120-a (e.g., body-steering the satellite to align satellite faces, such as a side 215, a side 211, or a side 212, or antenna systems, such as axes 245, 255, 265, or 275, along various directions, using an angular momentum system of the satellite 120-a), or changing the orbital path itself (e.g., changing an altitude of the satellite 120-a, redirecting the orbital path of the satellite 120-a, using a thruster 286). In various implementations, such a control system may perform operations based on a configuration at the satellite 120-a (e.g., a preconfiguration, a hardware configuration, a software configuration), based on signaling received at the satellite 120-a (e.g., command signaling, parameter signaling, instructions, from a network controller, from a terminal, via signals 132, via signals 173, via signals 183, via a reception array 240, via a patch antenna 284, via an omni antenna 282), based on detections at the satellite 120-a (e.g., sensor measurements, communications measurements, of characteristics of the satellite 120-a, of signal quality characteristics, of characteristics of communications relayed by the satellite 120-a, of environmental characteristics), or any combination thereof.

Although, in some examples, a reception array 240 and a transmission array 250 may be configured for communications with terminals of a ground segment, a reception array 240 and a transmission array 250 may additionally, or alternatively, be configured for communications with or via another satellite, such as another satellite 120 or another satellite 180. For example, to support aspects of a GEO link (e.g., a LEO-to-GEO link), a satellite 120-a may support wireless communications by receiving signals 183 using a reception array 240, or transmitting signals 183 using a transmission array 250, or both (e.g., via respective beams 125). In some examples, such techniques may be supported by aligning the positive z-direction of the satellite 120-a toward a satellite 180 (e.g., a geosynchronous satellite, for at least a portion of an orbital path of the satellite 120-a).

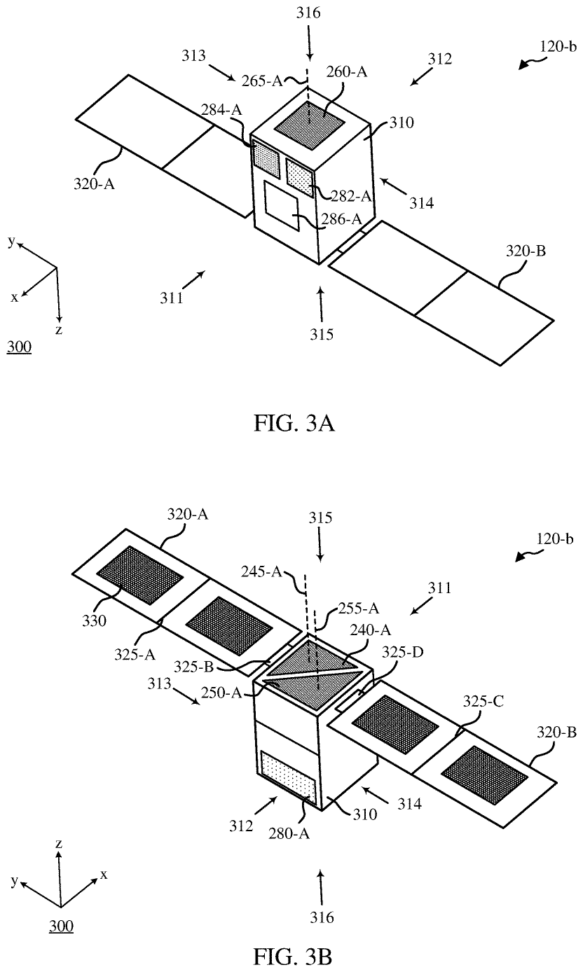

FIGS. 3A and 3B show an example of a satellite 120-b that supports single-direction crosslinks in satellite communication systems in accordance with examples as disclosed herein. A satellite 120-b may be configured to be deployed in an NGSO, and support various aspects of the described techniques in a communication system 100. For example, a satellite 120-b may support targeted functionality for receiving and transmitting beam signals, which may allow for a relatively small size and relatively low complexity of the satellite 120-b. In some examples, a relatively small size of a satellite 120-b, among other factors, may support relatively low cost and overhead associated with deploying the satellite 120-b in a communication system 100. For example, multiple satellites 120-b may be deployed from a same launch vehicle payload, rather than launching and deploying satellites 120-b individually. Although some techniques are described with reference to a satellite 120-b operating in an NGSO, in some other examples, one or more of the described techniques may be implemented in a satellite 120 or a satellite 180 operating in a geostationary orbit, among other implementations.

A satellite 120-b may have a generally prismatic shape, and may be described with reference to an x-direction, a y-direction, and a z-direction of a coordinate system 300. A satellite 120-b may include a body portion 310 having sides (e.g., faces, which may be flat faces or curved faces), which may include a side 311, a side 312, a side 313, a side 314, a side 315, and a side 316. Although, in some examples, the sides of a satellite 120-b may be orthogonal, in some other examples, the sides of a satellite 120-b may be in different orientations, such as in a satellite 120-b having a trapezoidal prism shape, a rhomboidal prism shape, a hexagonal prism shape, or other shape.

In some examples, a satellite 120-b may include one or more panels 320 that are deployable from the body portion 310, such as panels 320-a and 320-b that are rotatably coupled with the body portion 310 using hinges 325. In some implementations, a panel 320 may carry one or more solar elements 330, which may be positioned on one or both sides of respective panels 320 and may provide power for operating components of a satellite 120-b. For example, the satellite 120-b may include a first solar panel array configured to deploy from a side 313 and a second solar panel array configured to deploy from a side 314. In some examples, a control system of a satellite 120-b may manage the deployment of the panels 320 using the hinges 325.

The satellite 120-b may support wireless communication between ground terminals, for example, by receiving uplink signaling (e.g., forward uplink signaling, return uplink signaling, uplink signals 132, uplink signals 173) using a reception array 240-a and transmitting downlink signaling using a transmission array 250-a. For example, a reception array 240-a may be configured for receiving signaling from ground terminals, and a transmission array 250-a may be configured for transmitting signaling to ground terminals. In some examples, a reception array 240-a or a transmission array 250-a may be configured in accordance with one or more aspects of a reception array 240 or a transmission array 250, respectively (e.g., similar to a satellite 120-a), as described with reference to FIGS. 2A and 2B.

The satellite 120-b may also support wireless communication with or via other satellites 120 or satellites 180, for example, by receiving crosslink signaling using a reception array 260-a (e.g., a crosslink reception array) and, in some examples, transmitting crosslink signaling using the transmission array 250-a (e.g., as a combined downlink-and-crosslink array). For example, the satellite 120-b may use the transmission array 250-a as a downlink array (e.g., to transmit downlink signals) and additionally, or alternatively, may use the same transmission array 250-a as a crosslink transmission array (e.g., for transmitting signals 175, for transmitting signals 183 to a satellite 180 as a GEO link). Using the transmission array 250-a as both a downlink array and a crosslink transmission array may allow the satellite 120-b to communicate crosslink signals without including a dedicated crosslink transmission array (e.g., without a transmission array 270), thereby including a single high-power transmission array. Because signal transmissions may be associated with relatively high power usage, using a single transmission array 250-a may thus allow the satellite 120-b to operate in accordance with a reduced power consumption or reduced heat generation, and have reduced cost, reduced weight, reduced complexity, and improved packaging considerations compared to a satellite 120 (e.g., a satellite 120-a) having a dedicated crosslink transmission array. Additionally, using a single transmission array 250-a may improve or simplify design of the satellite 120-b by allowing for greater flexibility in arranging (e.g., affixing) components such as the reception array 240-a, the transmission array 250-a, and the reception array 260-a.

A reception array 240-a, a transmission array 250-a, and a reception array 260-a may be physically arranged on (e.g., located on, fixed to) a satellite 120-b to support efficient communication of beam signals (e.g., via beams 125) with user terminals 150, gateway terminals 130, and other satellites 120 or satellites 180. For example, a reception array 240-a and a transmission array 250-a may both be located on the side 315 of a satellite 120-b, and a reception array 260-a may be located on the side 316 of the satellite 120-b (e.g., a second side of the satellite 120-b, a side opposite from the reception array 240-a and the transmission array 250-a), or on another side of a satellite 120-b (e.g., a side 311, a side 312, a side 313, a side 314) that is different than a side that includes a reception array 240-a and a transmission array 250-a (e.g., providing a second side of the satellite 120-b for signal reception).

To support communications with a ground segment 101 using the reception array 240-a, the transmission array 250-a, or both, a satellite 120-b may be oriented such that the side 315 (e.g., a nominal direction of the side 315, an axis of the side 315, the positive z-direction of the satellite 120-b) is aligned toward Earth (e.g., toward a service area, toward a location of a service area). Additionally, or alternatively, to support communications with one or more other satellites 120 or satellites 180 using the reception array 260-a, the transmission array 250-a, or both, a satellite 120-b may be oriented such that the side 315, or the side 316, or both is generally aligned toward another satellite 120 or a satellite 180 (e.g., within a scan range of a beamformer of the associated array).

A reception array 240-a, a transmission array 250-a, and a reception array 260-a may each be associated with an axis (e.g., a nominal axis, a boresight axis, a boresight direction, an outward direction), which may be a nominal direction of the respective array. In some examples, such a nominal direction may be associated with a direction of peak gain capability (e.g., a direction of maximum radiated power, direction of maximum reception sensitivity, a direction of lowest distortion) of the array. For example, the reception array 240-a may be associated with an axis 245-a, and the transmission array 250-a may be associated with an axis 255-a, each of which may be aligned along the positive z-direction from the satellite 120-b (e.g., along a direction that is fixed with respect to the body portion 310, along a direction from the side 315, along parallel directions). Thus, aligning the reception array 240-a, the transmission array 250-a, or both toward a target may be associated with orienting the satellite 120-b such that the positive z-direction is aligned toward the target. Additionally, a reception array 260-a may be associated with an axis 265-a, which may be aligned along the negative z-direction from the satellite 120-b (e.g., a direction parallel to the axis 245-a, a direction parallel to the axis 255-a, a direction different than the axis 245-a and the axis 255-a). In some implementations, aligning the reception array 260-a toward a target (e.g., a second target, along a second target direction) may additionally, or alternatively, be associated with orienting the satellite 120-b such that the negative z-direction is aligned toward the target.

Thus, the satellite 120-b illustrates an example in which a reception array 240-a (e.g., an axis 245-a) and a transmission array 250-a (e.g., an axis 255-a) may be oriented along one direction, and a reception array 260-a (e.g., an axis 265-a) may be oriented along a different direction, providing different degrees of flexibility for orienting beams 125. Although, in the example of satellite 120-b, the direction of the axis 265-a is separated from the direction of the axes 245-a and 255-a by 180 degrees (e.g., pointing in opposite directions), in some other examples in accordance with the described techniques, the direction of an axis 265-a may be separated from the direction of axes 245-a and 255-a by a different angle, such as 45 degrees, 60 degrees, 90 degrees, 120 degrees, 135 degrees, among others (e.g., as a fixed angle of separation between arrays). Further, such techniques may be supported by faces of a satellite 120, or affixed arrays of antenna elements, that are not flat, such as with one or more curved arrays or other shapes of arrays that are otherwise associated with axes 245-a, 255-a, and 265-a (e.g., for a satellite 120 with one or more curved surfaces, such as cylindrical or spherical surfaces). Moreover, although, in the example of satellite 120-b, the axis 245-a and the axis 255-a are parallel, in some other examples, directions of the axis 245-a and the axis 255-a may be separated by a fixed angle, such as 10 degrees, 20 degrees, 30 degrees, 45 degrees, or some other fixed angle (e.g., between outward directions of sides of a satellite 120, between nominal directions of curved arrays of a satellite 120).

A reception system of a satellite 120-b (e.g., a reception antenna system, an uplink antenna system, a reception system including a reception array 240-a, a crosslink reception antenna system, a reception system including a reception array 260-a) may support receiving beam signals (e.g., uplink signals 132, uplink signals 173, crosslink signals 175, signals 183, via a beam 125) from one or more target devices, such as one or more user terminals 150, one or more gateway terminals 130, another satellite 120, a satellite 180, or a combination thereof. For example, a reception array 240-a may include one or more reception elements (e.g., reception antenna elements, reception feed elements) located on the side 315 that are configured to receive signaling from target devices, and a reception array 260-a may include one or more reception elements on the side 316 that are configured to receive signaling from target devices.

In some implementations, reception elements of a reception array 240-a may support reception of respective component signals associated with different polarizations, and may be associated with or may include respective ports (e.g., one or more ports, respective input ports, respective output ports) configured for component signals that are associated with a particular polarization. For example, a set of reception elements of the reception array 240-a may receive first component signals (e.g., electromagnetic component signals) of a first receive beam signal, each first component signal having a first polarization. The received first component signals may be converted (e.g., into electrical signals, into electrical component signals) and output using a set of first antenna element ports (e.g., output ports). Thus, at least some of the reception elements may receive a portion or component of a first receive beam signal, and may output an associated electrical signal from respective first ports (e.g., to a first reception beamforming network corresponding to the first polarization). In some examples, the set of reception elements may also receive second component signals of a second receive beam signal, each second component signal having a second polarization (e.g., different than the first polarization, orthogonal to the first polarization). The received second component signals may be converted and output using a set of second antenna element ports. Thus, at least some of the reception elements also may receive a portion or component of a second receive beam signal, and may output an associated electrical signal from respective second ports (e.g., to a second reception beamforming network corresponding to the second polarization).

In some implementations, reception elements of a reception array 260-a may support reception of respective component signals associated with a crosslink polarization (e.g., a single polarization, for signals received from another satellite 120 or from a satellite 180), which may be the same as one of the first polarization or the second polarization associated with reception elements of the reception array 240-a. For example, a set of reception elements of the reception array 260-a may receive third component signals of a third receive beam signal, each third component signal having the crosslink polarization. The received third component signals may be converted and output using a set of third antenna element ports (e.g., output ports). Thus, at least some of the reception elements of the reception array 260-a may receive a portion or component of a third receive beam signal, and may output an associated electrical signal from respective third ports (e.g., to a third reception beamforming network corresponding to the crosslink polarization).

In some examples, a reception array 240-a may be configured for receiving signaling in accordance with a first polarization that is associated with forward link communications and signaling in accordance with a second polarization that is associated with return link communications, in which case the first polarization may be orthogonal to the second polarization. For example, a first polarization may be an example of an LHCP, and a second polarization may be an example of an RHCP. In various examples, a crosslink polarization supported by the reception array 260-a may thus be either LHCP or RHCP. Additionally, or alternatively, a first polarization and a second polarization may be linearly polarized, such as the first polarization having a vertical polarization and the second polarization having a horizontal polarization, and a crosslink polarization supported by the reception array 260-a may thus be either vertical polarization or horizontal polarization.

One or more reception systems of a satellite 120-b may include one or more beamforming networks, which may be configured to support directional reception via the reception array 240-a (e.g., via a plurality of antenna elements of the reception array 240-a) relative to the axis 245-a, or to support directional reception via the reception array 260-a (via a plurality of antenna elements of the reception array 260-a) relative to the axis 265-a. For example, such beamforming networks of the one or more reception systems may each be configured to output one or more beam signals in accordance with a respective beam 125 (e.g., a reception beam) using component signals from the set of reception elements of the reception array 240-a or from the set of reception elements of the reception array 260-a.

In some implementations, one or more reception systems of a satellite 120-b may include a first beamforming network coupled with outputs of a set of first antenna element ports (e.g., associated with the reception array 240-a), which may receive a set of first component signals (e.g., forward link component signals) from the set of first antenna element ports. The first beamforming network may output a single beam signal (e.g., a forward link beam signal) associated with a first polarization, for example, to a transponder (e.g., to a forward link transponder, to a forward link signal path, to a part of a transponder system,), which may route the beam signal to a transmission system, such as a transmission system that includes a transmission array 250-a. In some implementations, the one or more receptions system may also include a second beamforming network coupled with outputs of a set of second antenna element ports (e.g., associated with the reception array 240-a), which may receive a set of second component signals (e.g., return link component signals) from the set of second ports. The second beamforming network may output a single beam signal (e.g., a return link beam signal) associated with the second polarization, for example, to a transponder (e.g., to a return link transponder, to a return link signal path, to a part of the transponder system), that may route the beam signal to a transmission system, such as a transmission system that includes a transmission array 250-a. In some implementations, a reception system may also include a third beamforming network coupled with outputs of a set of third antenna element ports (e.g., associated with the reception array 260-a), which may receive a set of third component signals (e.g., crosslink component signals) from the set of third ports. The third beamforming network may output a single beam signal (e.g., a crosslink link beam signal) associated with the crosslink polarization, for example, to a transponder (e.g., to a crosslink signal path, to a part of the transponder system), that may route the beam signal to a transmission system, such as a transmission system that includes a transmission array 250-a.

A transmission system of a satellite 120-b (e.g., a transmission antenna system, a combined crosslink/downlink antenna system, a transmission system including a transmission array 250-a) may support transmitting beam signals (e.g., downlink signals 133, downlink signals 172, crosslink signals 175, via a beam 125) to one or more target devices, such as one or more user terminals 150, one or more gateway terminals 130, or a combination thereof. For example, the transmission array 250-a may include one or more transmission elements (e.g., transmission antenna elements, transmission feed elements) located on the side 315 that are configured to transmit signaling to the target devices. A transmission antenna element may include a physical transducer that converts an electrical signal (e.g., an electrical component signal) to an electromagnetic signal (e.g., an electromagnetic component signal).

A transmission system of a satellite 120-b may include one or more beamforming networks (e.g., transmit beamforming networks), which may be configured to support directional transmission via the transmission array 250-a (e.g., via a plurality of antenna elements of the transmission array 250-a) relative to the axis 255-a. For example, such beamforming networks of the transmission system may each be configured to transmit one or more beam signals in accordance with a respective beam 125 (e.g., a transmit beam) using components signals output to the set of transmission elements of the transmission array 250-a.

In some implementations, a transmission system may include a first beamforming network coupled with inputs of a set of first antenna element ports. The first beamforming network may receive a single beam signal (e.g., a transmit beam signal, a forward link beam signal or a crosslink beam signal) associated with a first polarization, for example, from a transponder, which may route the beam signal from one or more reception systems that include the reception array 240-a and the reception array 260-a. The first beamforming network may output a set of first component signals (e.g., forward link component signals or crosslink component signals) to the set of first antenna element ports for transmitting a single beam 125 associated with the first polarization. In some implementations, a transmission system may also include a second beamforming network coupled with inputs of a set of second antenna element ports. The second beamforming network may receive a single beam signal (e.g., a return link beam signal) associated with a second polarization, for example, from a transponder, which may route the beam signal from the one or more reception systems. The second beamforming network may output a set of second component signals (e.g., return link component signals) to the set of second antenna element ports for transmitting a single beam 125 associated with the second polarization.

In some implementations, transmission elements of the transmission array 250-a may support transmission of respective component signals associated with different polarizations, and may be associated with or may include respective ports (e.g., respective input ports, respective output ports) configured for component signals that are associated with a particular polarization. For example, the set of transmission elements may receive the first component signals (e.g., electrical component signals, from a first transmission beamforming network corresponding to a first polarization) of a first transmit beam signal (e.g., a forward link signal, a crosslink signal) using a set of first antenna element ports (e.g., input ports), and the first component signals may be converted by the transmission elements into electromagnetic signals (e.g., electromagnetic component signals) that are transmitted by the transmission elements in accordance with a first polarization. Thus, at least some of the transmission elements may receive a portion or component of a first transmit beam signal, and may transmit an associated electromagnetic signal having a first polarization. In some examples, the set of transmission elements may receive second component signals (e.g., from a second transmission beamforming network corresponding to a second polarization) of a second transmit beam signal (e.g., a return link beam signal) using a set of second antenna element ports (e.g., input ports), and the second component signals may be converted by the transmission elements into electromagnetic signals that are transmitted by the transmission elements in accordance with a second polarization. Thus, at least some of the transmission elements may also receive a portion or component of a second transmit beam signal, and may transmit an associated electromagnetic signal having a second polarization (e.g., different than the first polarization, orthogonal to the first polarization).

In some examples, a transmission array 250-a may transmit signaling in accordance with a first polarization that associated with forward link communications (e.g., signaling to user terminals 150) and crosslink communications (e.g., to another satellite 120, to a satellite 180), and a second polarization that is associated with return link communications (e.g., signaling to gateway terminals 130), in which case the first polarization may be orthogonal to the second polarization. For example, a first polarization may be an example of an LHCP, and a second polarization may be an example of an RHCP. Additionally, or alternatively, a first polarization and a second polarization may be linearly polarized, such as the first polarization having a vertical polarization and the second polarization having a horizontal polarization. In some implementations, a transmission array 250-a may implement the same polarization as a reception array 240-a and a reception array 260-a for forward and crosslink communications (e.g., implementing LHCP for a forward link or crosslink), and the same polarization as a reception array 240-a for return communications (e.g., implementing RHCP for a return link). In some other implementations, a transmission array 250-a may implement a different polarization as a reception array 240-a, or a reception array 260-a, or both for forward communications, or for return communications, or both.

In some implementations, a satellite 120-b may include additional components to support wireless communications with gateway terminals 130, user terminals 150, other satellites 120, or a satellite 180, among other devices. For example, the satellite 120-b may include a patch antenna 284-a (e.g., an S-band patch antenna), an omni antenna 282-a (e.g., an omnidirectional antenna), or both, which may support communication (e.g., transmitting control signaling, receiving control signaling) in a limited frequency range (e.g., between 2 GHz and 4 GHz, non-overlapping with or otherwise different than the reception array 240-a, the transmission array 250-a, and the reception array 260-a). In some examples, a patch antenna 284-a, an omni antenna 282-a, or both may be located on a side of the satellite 120-b that is different than a reception array 240-a and a transmission array 250-a, such as a side 311, or a side 316 (e.g., opposite from the reception array 240-a and the transmission array 250-a).

In some implementations, a satellite 120-b may include a tracking system 280-a (e.g., a star tracker) to support detecting telemetry information of the satellite 120-b. A tracking system 280-a may be located on a face of the satellite 120-b that is different than a face that includes a reception array 240-a, a transmission array 250-a, or a reception array 260-a, such as being located on a side 312.

In some implementations, a satellite 120-b may include one or more components that support controlling orbital parameters of the satellite 120-b. For example, a satellite 120-b may include one or more thrusters 286-a which, in some examples, may be located on a side of the satellite 120-b that is different than the reception array 240-a, the transmission array 250-a, and the reception array 260-a (e.g., on a side 311), or one or more other sides. Additionally, or alternatively, a satellite 120-b may include an angular momentum system (e.g., internal to the satellite 120-b, not shown) operable to orient (e.g., rotate) the satellite 120-b about one or more axes (e.g., to align one or more sides of the satellite 120-b along one or more target directions, to align an axis 245-a, an axis 255-a, an axis 265-a, or a combination thereof along one or more target directions).

A satellite 120-b may include a control system that supports various operations of the satellite 120-b. For example, such a control system may configure aspects of directional reception, directional transmission, or both, such as modifying beam weights or beam hopping at one or more beamforming networks of the reception system, the transmission system, or both. Additionally, or alternatively, such a control system may be configured to modify orbital characteristics of the satellite 120-b (e.g., in coordination with enabling transponder signal paths and configuring beamforming parameters), such as modifying an alignment of the satellite 120-b (e.g., body-steering the satellite to align satellite faces, such as a side 315 or a side 316, or antenna systems, such as axes 245-a, 255-a, or 265-a, along various directions, using an angular momentum system of the satellite 120-b), or changing the orbital path itself (e.g., changing an altitude of the satellite 120-b, redirecting the orbital path of the satellite 120-b, using a thruster 386-a). In various implementations, such a control system may perform operations based on a configuration at the satellite 120-b (e.g., a preconfiguration, a hardware configuration, a software configuration), based on signaling received at the satellite 120-b (e.g., command signaling, parameter signaling, instructions, from a network controller, from a terminal, via signals 132, via signals 173, via signals 183, via a reception array 240-a, via a patch antenna 384, via an omni antenna 382), based on detections at the satellite 120-b (e.g., sensor measurements, communications measurements, of characteristics of the satellite 120-b, of signal quality characteristics, of characteristics of communications relayed by the satellite 120-b, of environmental characteristics), or any combination thereof.

Although, in some examples, a reception array 240-a and a transmission array 250-a may be configured for communications with terminals of a ground segment, a reception array 240-a and a transmission array 250-a may, additionally, or alternatively, be configured for communications with or via another satellite, such as another satellite 120 or another satellite 180. For example, to support aspects of a GEO link, a satellite 120-b may support wireless communications by receiving signals 183 using a reception array 240-a, or transmitting signals 183 using a transmission array 250-a, or both (e.g., via respective beams 125). In some examples, such techniques may be supported by aligning the positive z-direction of the satellite 120-b toward a satellite 180 (e.g., a geosynchronous satellite, for at least a portion of an orbital path of the satellite 120-b).

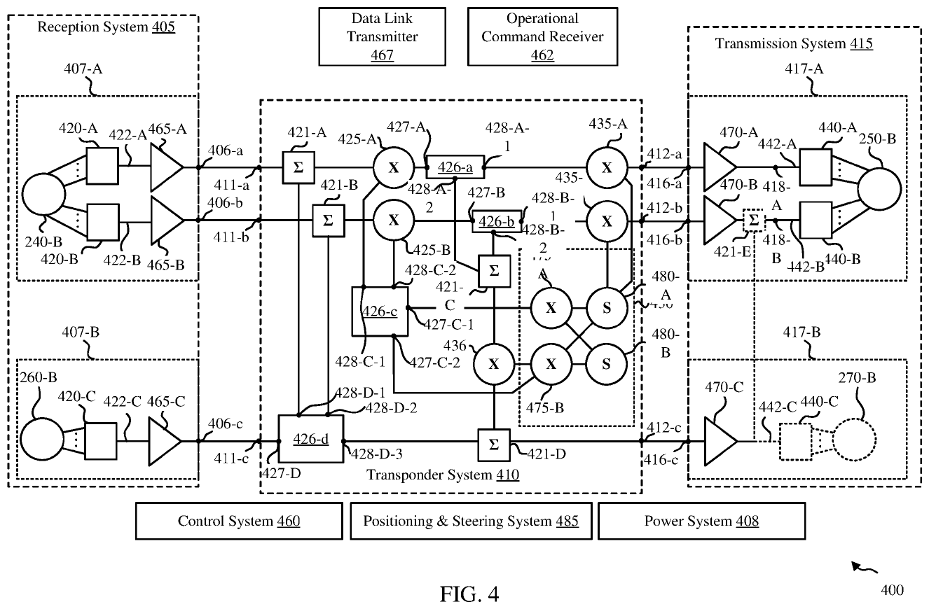

FIG. 4 shows an example of a payload 400 that supports single-direction crosslinks in satellite communication systems in accordance with examples as disclosed herein. The payload 400 may be implemented in a satellite 120, such as a satellite 120-a or a satellite 120-b, among other implementations. For example, the payload 400 may include a reception system 405 (e.g., a reception subsystem, a reception antenna system), a transmission system 415 (e.g., a transmission subsystem, a transmission antenna system), and a transponder system 410 (e.g., a transponder subsystem, a set of transponders, a set of signal paths, a set of beam signal pathways) coupled with the reception system 405 and the transmission system 415. Although the reception system 405, the transponder system 410, and the transmission system 415 are provided with illustrative boundaries, constituent components may be distributed differently among other systems or subsystems in accordance with the described techniques.

The payload 400 may support relaying beam signals (e.g., signals associated with one or more beams 125) with or between one or more terminals of a ground segment 101 (e.g., between gateway terminals 130 and user terminals 150), with or between one or more other satellites (e.g., another satellite 120, a satellite 180), or a combination thereof. For example, the reception system 405 may include a reception subsystem 407-a (e.g., an uplink subsystem), which may include a reception array 240-b, and may include or be otherwise coupled with ports 406 (e.g., ports 406-a and 406-b, output ports, uplink ports). The reception array 240-b may include one or more antenna elements (e.g., reception elements) located on a side of the satellite 120, such as a side 215 or a side 315. In some examples, the reception subsystem 407-a may be configured to for reception in a first frequency range (e.g., an uplink frequency range, 81-86 GHZ). The reception subsystem 407-a may be operable to obtain and output, via the ports 406-a and 406-b, one or more beam signals (e.g., signals of respective beams 125, uplink beam signals, receive beam signals) that are based on component signals received via antenna elements of the reception array 240-b.

In some examples (e.g., for a payload in a satellite 120 that supports crosslink reception using a separate array), the reception system 405 may also include a reception subsystem 407-b (e.g., a crosslink reception subsystem), which may include a reception array 260-b, and may include or be otherwise coupled with a port 406-c (e.g., a crosslink port). The reception array 260-b may include one or more antenna elements (e.g., reception elements) located on a different side of the satellite 120, such as a side 211 or a side 316 (e.g., a side orthogonal to, opposite from, or otherwise different than the reception array 240-b). Such a physical arrangement may reduce interference when receiving signals from different target devices along different directions. In some examples, the reception subsystem 407-b may be configured for reception in a second frequency range (e.g., a crosslink frequency range, 61-66 GHZ, or another frequency range that is non-overlapping with the first frequency range). The reception subsystem 407-b may be operable to obtain and output, via the port 406-c, a beam signal (e.g., a signal of a beam 125, a crosslink beam signal, a receive beam signal) that is based on component signals received via antenna elements of the reception array 260-b. In some other examples, a reception subsystem 407-b and related circuitry may be omitted (e.g., for a payload in a satellite 120 that does not support crosslink reception, or a payload in a satellite 120 that supports crosslink reception via an reception subsystem 407-a).

The transmission system 415 may include a transmission subsystem 417-a (e.g., a downlink transmission subsystem), which may include a transmission array 250-b, and may include or otherwise be coupled with ports 416 (e.g., ports 416-a and 416-b, input ports, downlink ports). The transmission array 250-b may include one or more antenna elements (e.g., transmission elements) located on a side of the satellite 120, such as a side 215 or a side 315. In some examples, the transmission subsystem 417-a may be configured for transmission in at least a third frequency range (e.g., at least a downlink frequency range, 71-76 GHZ, or another frequency that is non-overlapping with the first frequency range and the second frequency range). The transmission subsystem 417-a may be operable to obtain (e.g., via the ports 416-a and 416-b) and transmit beam signals (e.g., signals of respective beams 125, downlink beam signals) that are based on component signals transmitted via antenna elements of the transmission array 250-b.

In some implementations (e.g., for a payload in a satellite 120 that supports crosslink transmission using a separate array, such as in a satellite 120-a), the transmission system 415 may also include a transmission subsystem 417-b (e.g., a crosslink transmission subsystem), which may include a transmission array 270-b, and may include or otherwise be coupled with a port 416-c (e.g., a crosslink port). The transmission array 270-a may include one or more antenna elements (e.g., transmission elements) located on a side of the satellite 120, such as a side 212 (e.g., a side opposite or otherwise different than the reception array 260-b). Such a physical arrangement may facilitate relaying crosslink signals along a different direction than receiving uplink signals or transmitting downlink signals. In some examples, the transmission subsystem 417-b may be configured for transmission in the second frequency range (e.g., a crosslink frequency range, 61-66 GHZ, such that the crosslink frequency range is centered between the uplink frequency range and the downlink frequency range, which may improve isolation among different types of signaling and hardware that supports such signaling). The transmission subsystem 417-b may be operable to obtain (e.g., via the port 416-c) and transmit a beam signal (e.g., signals of a respective beam 125, a crosslink beam signal) that are based on component signals transmitted via antenna elements of the transmission array 270-b.

In some other implementations (e.g., for a payload in a satellite 120 that does not support crosslink transmission using a separate array, such as in a satellite 120-b), a transmission array 270-b may be omitted, and signals from a port 412-b and a port 412-c may be combined to be conveyed along a single signal path of the transmission system 415 (e.g., provided to a single, shared beamforming network 440-b). For example, when such a combination is considered to be included in the transmission system 415, signal paths from the ports 416-b and 416-c may be combined via a coupler 421-e of the transmission system 415. In some other examples, such a combination may be considered to be included in the transponder system 410, in which case at least the coupler 421-e may instead be included in the transponder system 410, and the transponder system 410 may be considered to have two ports 412 (e.g., one corresponding to the illustrated port 412-a and one corresponding to a combination of the illustrated ports 412-b and 412-c. In these and other examples, the transmission system 415 may be considered to include two ports 418 (e.g., two input ports, two beam signal ports), illustrated as ports 418-a and 418-b. In some examples, the port 418-a may be a port that is dedicated to conveying a downlink signal (e.g., a return downlink beam signal) and the port 418-b may be a shared port operable to convey a downlink beam signal (e.g., a forward downlink beam signal), or a crosslink beam signal (e.g., along a forward link or a return link), or both. In some such examples, the second frequency range (e.g., the crosslink frequency range) may be configured to be adjacent to (e.g., contiguous with) the third frequency range (e.g., the downlink frequency range), such as a crosslink frequency range of 66-71 GHz, among other implementations of such frequencies, which may provide relatively improved antenna characteristics compared to when such ranges are not adjacent (e.g., spanning a bandwidth greater than 10 GHz). Thus, in some examples, the transmission subsystem 417-a may be configured for transmission in the second frequency range and the third frequency range.

The transponder system 410 (e.g., a transponder subsystem, a set of transponders, a set of signal paths between the reception system 405 and the transmission system 415) may be operable to couple with the ports 406 of the reception system 405 and receive the one or more beam signals from the reception system 405. For example, the transponder system 410 may include ports 411 (e.g., input ports, ports 411-a and 411-b, which may be uplink ports, and port 411-c which may be a crosslink port) that are operable to couple with respective ports 406 of the reception system 405. In some other examples, respective ports 411 and 406 may be referred to as or be equivalent to a common port or node. The transponder system 410 may also be operable to couple with the ports 416 of the transmission system 415 and output one or more beam signals to the transmission system 415. For example, the transponder system 410 may include ports 412 (e.g., output ports, ports 412-a and 412-b, which may be downlink ports, and port 412-c, which may be a crosslink port) that are operable to couple with respective ports 416 of the transmission system 415 (e.g., in a one-to-one correspondence). In some other examples, respective ports 412 and 416 may be referred to as or be equivalent to a common port or node. Thus, in various examples, the transponder system 410 may be considered as including three ports 411 (e.g., three inputs), coupled with respective ports 406 (e.g., three outputs) of the reception system 405, and the transponder system 410 may be considered as including ports 412 (e.g., three outputs, two outputs), coupled with respective ports 416 (e.g., three inputs, two inputs) of the transmission system 415, or ports coupled with respective ports 418 (e.g., two inputs) of the transmission system 415, depending on implementations of transmission subsystems 417. The transponder system 410 may thus support various signal paths for coupling its ports 412 with its ports 411 and performing various intervening signal processing.

The payload 400 may be operable to support different modes (e.g., signaling modes, communication modes, relaying modes, signal path modes, signal routing modes, beam signal modes), or combinations of modes, for relaying beam signals. Such modes, among other operations of a satellite 120 that includes the payload 400, may be controlled (e.g., configured, coordinated, initiated) at least in part by a control system 460 of the payload, which may be coupled with at least the reception system 405, the transponder system 410, and the transmission system 415, to configure one or more aspects of the respective components. For example, the control system 460 may support managing beamforming networks (e.g., beamforming networks 420, beamforming networks 440), activating and deactivating signal paths of the transponder system 410, managing satellite alignment (e.g., aligning the satellite 120 toward a target, altering an orbital path of the satellite 120), among other operations. The control system 460 may include any quantity of one or more processors, which may include processors that are co-located within the payload 400 or distributed throughout the payload 400. Any one or more of such processors may be configured (e.g., configured individually, configured collectively, by software configuration, by firmware configuration, by hardware configuration, or any combination thereof) to cause the satellite 120 (e.g., the payload 400) to perform various operations described herein.

In various modes, the payload 400 may support relaying return link signals (e.g., signaling from one or more user terminals 150 to a gateway terminal 130) or relaying forward link signals (e.g., signaling from a gateway terminal 130 to one or more user terminals 150), which may include relaying crosslink signals (e.g., signaling from another satellite 120 or a satellite 180, signaling to another satellite 120 or a satellite 180), or a combination thereof. To support such relaying, the payload 400 may receive component signals (e.g., return uplink component signals as electromagnetic component signals of uplink signals 173, crosslink component signals as electromagnetic components signals of crosslink signals 175) via antenna elements of the reception array 240-b, the reception array 260-b, or both (e.g., reception antenna elements). In some examples, component signals may be received by the antenna elements in accordance with a polarization, which may be assigned to certain types of communications. For example, component signals associated with return link signaling may be associated with a first polarization (e.g., RHCP), component signals associated with forward link signaling may correspond to a second polarization orthogonal to the first polarization (e.g., LHCP), and component signals associated with crosslink signaling may correspond to the first polarization, the second polarization, or another polarization, or may be non-polarized. In some examples, if the component signals are associated with return link signaling or forward link signaling, the component signals may be received (e.g., via the reception array 240-b) in a first frequency range (e.g., 81-86 GHZ) and, if the component signals are associated with crosslink signaling, the component signals may be received (e.g., via the reception array 260-b) in a second frequency range (e.g., 61-66 GHZ), or another frequency range that has the same bandwidth as the first frequency range.

Antenna elements of the reception array 240-b may output (e.g., via a respective output ports) respective first component signals (e.g., electrical component signals, associated with a first polarization) to a beamforming network 420-a and, in some examples, respective second component signals (e.g., associated with a second polarization) to a beamforming network 420-b. In some examples, a beamforming network 420-a and a beamforming network 420-b may be referred to as a single beamforming network 420 of the reception subsystem 407-a that is configured to support directional reception of single respective beams 125 of each of the different polarizations supported by a reception array 240-b. Antenna elements of the reception array 260-b may output respective component signals to a beamforming network 420-c. For at least some, if not all of the respective antenna elements, a beamforming network 420 may apply a gain, a phase adjustment, or a time adjustment, or any combination thereof to the component signals in accordance with a direction of beamforming (e.g., a direction of a receive beam 125, in accordance with receive beam weights configured by the control system 460) to generate a reception beam signal (e.g., a return link uplink beam signal, a forward link uplink beam signal, or a crosslink beam signal) that is based on the component signals received from the antenna elements.

Each beamforming network 420 may include an output 422 (e.g., a single output, an output 422-a corresponding to output of a return link uplink beam signal, an output 422-b corresponding to output of a forward link uplink beam signal, an output 422-c corresponding to output of a crosslink beam signal), which may be configured to output reception beam signals to the transponder system 410 (e.g., via a port 406-a, 406-b, or 406-c). In some examples, the outputs 422 may be configured to output a reception beam signal in the same frequency range as the component signals were received). In some examples, an output 422 may be supported by activating (e.g., by the control system 460) a respective amplifier 465 (e.g., an amplifier 465-a, an amplifier 465-b, an amplifier 465-c).

The transponder system 410 may include various signals paths between the ports 411 and the ports 412. For example, the transponder system 410 may include a first signal path between the port 411-b and the port 412-b (e.g., for a forward uplink-to-downlink relay), a second signal path between the port 411-c and the port 412-b (e.g., for a forward crosslink-to-downlink relay), a third signal path between the port 411-b and the port 412-c (e.g., for a forward uplink-to-crosslink relay), a fourth signal path between the port 411-c and the port 412-c (e.g., for a crosslink-to-crosslink relay), a fifth signal path between the port 411-a and the port 412-c (e.g., for a return uplink-to-crosslink relay), a sixth signal path between the port 411-c and the port 412-a (e.g., for a return crosslink-to-downlink relay), and a seventh signal path between the port 411-a and the port 412-a (e.g., for a return uplink-to-downlink relay), at least some of which may be supported concurrently by the transponder system 410 (e.g., for multi-directional relaying).

In some examples, the transponder system 410 may include one or more switching components 426, having inputs 427 (e.g., input ports) and outputs 428 (e.g., output ports), which may be operable to control (e.g., implement, configure, based on configuring the switching component 426 via the control system 460) coupling between components of the various signal paths. For example, the transponder system 410 may include a switching component 426-a (e.g., a single-pole double-throw (SPDT) switch), which may route a signal from an input 427-a to an output 428-a-1 or an output 428-a-2. The transponder system 410 may also include a switching component 426-b (e.g., an SPDT switch), which may route a signal from an input 427-b to an output 428-b-1 or an output 428-b-2. The transponder system 410 may also include a switching component 426-c (e.g., a double-pole double-throw (DPDT) switch), which may route a signal from an input 427-c-1 or an input 427-c-2 to an output 428-c-1 or an output 428-c-2. The transponder system 410 may also include a switching component 426-d (e.g., a single-pole triple-throw (SP3T) switch), which may route a signal from an input 427-d to an output 428-d-1, an output 428-d-2, or an output 428-d-3.

In some examples, the transponder system 410 may include one or more couplers 421 (e.g., signal path junctions) that support passing at least a portion of one or more signals input to a coupler 421 through an output of the coupler 421 (e.g., providing a coupling between components). For example, a coupler 421-a may pass a signal from the output 428-d-1, a signal from the port 411-a, or both to a frequency converter 425-a (e.g., an uplink-to-IF frequency converter). A coupler 421-b may pass a signal from the output 428-d-2, a signal from the port 411-b, or both to a frequency converter 425-b (e.g., an uplink-to-IF frequency converter). A coupler 421-c may pass a signal from the output 428-a-2, a signal from the output 428-b-2, or both to a frequency converter 436 (e.g., an IF-to-crosslink frequency converter). A coupler 421-d may pass a signal from the output 428-d-3, or a signal from the frequency converter 436, or both to port 412-c (e.g., to the beamforming network 440-b via the input 442-b). A coupler 421 may include one or more switches (e.g., operable using the control system 460) to support relaying the signals, or may support addition (e.g., summation) of signals, or both, among other examples. In some examples, a signal from a single component coupled with a coupler 421 may be passed by the coupler 421, which may be a result of one or more other components coupled with the coupler 421 being disabled (e.g., deactivated, deenergized).

Each signal path of the transponder system 410 may be coupled with one of the outputs 422 (e.g., directly, or via an amplifier 465, where applicable), and may be operable to receive a receive beam signal from a beamforming network 420 (e.g., via a port 411). In some implementations, the transponder system 410 may include one or more frequency conversions between a port 411 and a port 412. For example, the transponder system 410 may downconvert a receive beam signal (e.g., an uplink beam signal, from a reception subsystem 407-a) from a first frequency range (e.g., an uplink frequency range, 81-86 GHz) to an IF range to generate an IF signal using a frequency converter 425 (e.g., a downconverter, a frequency converter 425-a, a frequency converter 425-b) that receives the receive beam signal and converts the frequency for the IF signal to the IF frequency range. In some examples, the IF frequency range may be 11-16 GHZ, or another frequency range that has the same bandwidth as the first frequency range. In some cases, to support such a frequency conversion, a frequency converter 425 may receive (e.g., from a switching component 426-c, from an input 427-c-2) an oscillator signal having a first oscillator frequency (e.g., 70 GHz, to convert from a 81-86 GHz range to an 11-16 GHz range), such as from a frequency generator 430, and may output the IF signal having a frequency corresponding to the difference between the frequency of the receive beam signal and the first oscillator frequency.

Additionally, or alternatively, the transponder system 410 may downconvert a receive beam signal (e.g., a crosslink beam signal, from a reception subsystem 407-b) from a second frequency range (e.g., a crosslink frequency range, 61-66 GHz) to the IF frequency range to generate an IF signal using a frequency converter 425 that receives the second receive beam signal and converts the frequency for the second IF signal to the IF frequency range. In some cases, to support such a frequency conversion, the frequency converter 425 may receive (e.g., from a switching component 426-c, from an input 427-c-1) an oscillator signal having a second oscillator frequency (e.g., 50 GHz, to convert from a 61-66 GHz range to an 11-16 GHz range), such as from the frequency generator 430, and may output the second IF signal having a frequency corresponding to the difference between the frequency of the second receive beam signal and the second oscillator frequency.

In some examples, the payload 400 may be considered a processing payload, and may include circuitry for processing techniques such as analog-to-digital conversion, demodulation, signal extraction, demultiplexing, multiplexing, signal insertion, modulation, digital-to-analog conversion, and other processing techniques. In some such examples, such processing techniques may be implemented on IF signals between frequency converters 425 and frequency converters 435 and 436. In some other examples, the payload may be considered a non-processing payload (e.g., in a bent pipe payload configuration), and the IF signals may be forwarded through the transponder system 410 without such processing techniques.

Along the various signal paths, the transponder system 410 may also upconvert IF signals from the IF frequency range to another frequency range, such as a downlink frequency range to generate a downlink beam signal (e.g., a return link downlink beam signal, a forward link downlink beam signal), or to a crosslink frequency range to generate a crosslink beam signal. For example, the transponder system 410 may include frequency converters 435 (e.g., upconverters, frequency converters 435-a and 435-b) that receive an IF signal and convert the frequency for a downlink beam signal to a third frequency range (e.g., a downlink frequency range). In some examples, the third frequency range may be 71-76 GHZ, or another frequency range that has the same bandwidth as the first frequency range, the second frequency range, the IF frequency range, or a combination thereof. In some implementations, the first frequency range and the third frequency range may be non-overlapping, which may support aspects of the reception system 405 and the transmission system 415 (e.g., antenna elements, signal processing hardware) being configured in accordance with different operational frequencies, and avoiding crosstalk between the transmission system 415 and the reception system 405. In some cases, to support such a frequency conversion, the frequency converter 435 may receive an oscillator signal having a third oscillator frequency (e.g., 60 GHz, to convert from a 11-16 GHz range to a 71-76 GHz range), such as from the frequency generator 430 (e.g., from the oscillator 480-a), and may output a downlink beam signal (e.g., via a port 412-a or 412-b) having a frequency corresponding to the sum of the frequency of the IF signal and the third oscillator frequency.

The transponder system 410 may also include a frequency converter 436 that receives an IF signal (e.g., from a switching component 426-a or 426-b) and converts the frequency for a crosslink beam signal to the second frequency range (e.g., a 61-66 GHz range). In some cases, to support such a frequency conversion, the frequency converter 436 may receive an oscillator signal having the second oscillator frequency (e.g., 50 GHz, to convert from a 11-16 GHz range to a 61-66 GHz range), such as from the frequency generator 430, and may output a crosslink beam signal having a frequency corresponding to the sum of the frequency of the IF signal and the second oscillator frequency.

The transponder system 410 (e.g., a frequency converter 435, a frequency converter 436) may output one or more (e.g., one or two) downlink beam signals, or a crosslink beam signal, or both to the transmission system 415 (e.g., via one or more ports 412, via one or more ports 416), such as to a beamforming network 440 (e.g., a beamforming network 440-a, a beamforming network 440-b, a beamforming network 440-c a transmission beamformer). Each beamforming network 440 may include an input 442 (e.g., a single input), which may be configured to receive a beam signal (via a respective port 416) from the transponder system 410. In some examples, an input 442 may be configured to receive a downlink beam signal or a crosslink beam signal in the same frequency range as component signals are to be transmitted. In some examples, a beamforming network 440-a and a beamforming network 440-b may be referred to as a single beamforming network 440 of the transmission subsystem 417-a that is configured to support directional transmission of single respective beams 125 of each of the different polarizations supported by a transmission array 250-b.

In some examples, an input 442 may be supported by activating an associated amplifier 470. For at least some, if not all of the antenna elements of the transmission array 250-b or the transmission array 270-b (e.g., where applicable), a beamforming network 440 may apply a respective gain, a respective phase adjustment, or respective a time adjustment, or any combination thereof to the beam signal to generate component signals (e.g., return link component signals, forward link component signals, crosslink component signals) for the antenna elements. Such component signals may be provided to the antenna elements (e.g., to respective first input ports of the antenna elements) so that the transmission array 250-b or transmission array 270-b can transmit a downlink beam signal or a crosslink beam signal in accordance with a direction of beamforming (e.g., a direction of a transmit beam 125, in accordance with transmit beam weights configured by the control system 460).

A frequency generator 430 may be implemented in various configurations to support the frequency converters 425, 435, and 436 (e.g., to output oscillator signals at one or more frequencies). For example, a frequency generator 430 may output one or more oscillator signals using one or more oscillators 480 (e.g., oscillator circuits), or a combination of one or more oscillators 480 and one or more frequency converters 475, among other configurations. In an example of the payload 400, the frequency generator 430 may be configured to generate oscillator signals at three frequencies (e.g., 70 GHZ, 60 GHz, and 50 GHz) using two oscillators 480 (e.g., at 60 GHz and 10 GHz). For example, oscillator 480-a may be configured to generate and output (e.g., to the frequency converter 435-a, the frequency converter 435-b, the frequency converter 475-a, and the frequency converter 475-b) an oscillator signal having the third oscillator frequency (e.g., 60 GHz). The oscillator 480-b may be configured to generate and output (e.g., to the frequency converter 475-a and the frequency converter 475-b) an oscillator signal having a fourth frequency (e.g., 10 GHz). In some other examples, a frequency generator 430 may include three oscillators 480 that generate oscillator signals at the respective frequencies for the frequency converters 425 and 435, and 436 (e.g., 70 GHz, 60 GHz, and 50 GHz) directly.

The oscillator 480-b may be used by the frequency generator 430 to generate oscillator signals having other frequencies. For example, the frequency generator 430 may include a frequency converter 475-a, which may generate and output (e.g., to a switching component 426-c) an oscillator signal having the first oscillator frequency equal to a sum of the frequencies of the oscillator 480-a and the oscillator 480-b (e.g., 70 GHz, as a sum of the third and fourth oscillator frequencies, as a sum of 60 GHz and 10 GHZ). The frequency generator 430 may also include a frequency converter 475-b, which may generate and output (e.g., to a switching component 426-c) an oscillator signal having the second oscillator frequency equal to a difference of the frequency of the oscillator 480-a the oscillator 480-b (e.g., 50 GHz, as a difference between the third oscillator frequency and the fourth oscillator frequency, as a difference between 60 GHz and 10 GHz). However, other configurations of a frequency generator 430 may be implemented in accordance with the described techniques, such as including a separate oscillator 480 for each oscillator frequency used by a frequency converter 425, 435, or 436 (e.g., omitting frequency converters 475), among other implementations.

The payload 400 may include or may implement a positioning and steering system 485, which may manage operations related to modifying orbital characteristics of a satellite 120 that includes the payload 400, such as modifying the orbital path of the satellite 120 (e.g., a speed along an orbital path, an altitude of an orbital path, a heading of the orbital path), or an orientation of the satellite 120 (e.g., for steering the satellite 120 along the orbital path, for orienting an axis 245 of the reception array 240-b, for orienting an axis 255 of the transmission array 250-b, for orienting an axis 265 of the reception array 260-b, for orienting an axis 275 of the transmission array 270-b where applicable, for orienting a side 215 or a side 315 of the satellite 120, for orienting a side 211 of the satellite 120, for orienting a side 212 of the satellite 120, for orienting a side 316 of the satellite, or a combination thereof). For example, the positioning and steering system 485 may include a thruster 286, which may be operated, at least in part, by the control system 460 to modify the orbital path of the satellite 120. Additionally, or alternatively, the positioning and steering system 485 may include an angular momentum system, such as a reaction wheel, control moment gyroscope (CMG), or both. The control system 460 may implement the angular momentum system (e.g., to steer the satellite 120, by converting between angular momentum and electrical energy) to adjust the orientation of the satellite 120, for example to support improved communication of beam signals.

In some cases, the payload 400 may receive power from the satellite 120 (e.g., from solar elements 230 or 330), for example, using a power system 408 (e.g., a direct current (DC) power converter). In some cases, the power system 408 may include or may couple with power storage system, such as an on-board battery. The power system 408 may extract power from the battery to power aspects of the payload 400, may transfer power to the battery, or both. Additionally, or alternatively, the power system 408 may be coupled with the positioning and steering system 485. For example, the power system 408 may extract power from the angular momentum system, may transfer power to the angular momentum system, or both (e.g., to impose an angular acceleration or deceleration on the satellite 120).

In some cases, the control system 460 may operate according to signaling received by the satellite 120. Such signaling may be associated with a frequency band central to the IF frequency range (e.g., 13.5 GHZ). For example, the payload 400 may include an operational command receiver 462, which may decode commands (e.g., command messages) received by the reception system 405. In some examples, the operational command receiver 462 may decode messages included in a forward uplink beam signal (e.g., commands from a gateway terminal 130). For example, a signal path from the reception system 405 may include a coupler (not shown) that supports relaying at least a portion of an IF signal to both the frequency converter 435-b and the operational command receiver 462. The coupler may include one or more switches (e.g., operable using the control system 460) to support relaying the IF signal to the operational command receiver 462, may support addition (e.g., summation) of signals, or both, among other examples. In some cases, the operational command receiver 462 may receive a schedule that includes information such as beam weights (e.g., array beam pointing information for the beamforming networks 420 and 440), instructions for body steering maneuvers, beam hopping information, or the like, which may be provided to the control system 460.

Additionally, or alternatively, the satellite 120 may transmit signaling to indicate a status of the satellite 120 using a data link transmitter 467 (e.g., a command transmitter). Such signaling may also be associated with a frequency band central to the IF frequency range (e.g., 13.5 GHZ). For example, the data link transmitter 467 may generate a beacon that includes information such as telemetry, a health status of the satellite 120, a payload status (e.g., a status of the payload 400), or other information. The data link transmitter 467 may transmit the generated beacon signal to a coupler (not shown), which may add the beacon signal to a downlink beam signal. For example, the coupler may include one or more switches or other circuitry that supports summing the beacon signal with an IF signal.

Thus, the payload 400 illustrates various examples for supporting communications with a reception system 405, a transponder system 410, and a transmission system 415 having specific ports that are allocated to certain types of communications, and therefore certain types of signaling characteristics. For example, the reception system 405 (e.g., subsystems 407 thereof) may be configured for an uplink frequency range (e.g., 81-86 GHZ) and a crosslink frequency range (e.g., 61-66 GHZ, 66-71 GHZ) and the transmission system 415 (e.g., subsystems thereof) may be configured for a downlink frequency range (e.g., 71-76 GHz) and the crosslink frequency range (e.g., 61-66 GHz). Orthogonality for different ports between forward, return, and crosslink communications at the reception system 405 and the transmission system 415 may be provided by different frequencies and orthogonal polarizations, such as allocating RHCP to return communications and LHCP to forward communications, where crosslink communications may be polarized or non-polarized.

In some examples, the transponder system 410 may therefore include a single signal path for forward communications between the reception system 405 and the transmission system 415 that includes a net frequency conversion from the uplink frequency range to the downlink frequency range and maintains a forward link polarization, a single signal path for return communications between the reception system 405 and the transmission system 415 that includes the net frequency conversion from the uplink frequency range to the downlink frequency range and maintains a return link polarization association, and a single signal path for crosslink communications between the reception system 405 and the transmission system 415 that omits a frequency conversion (e.g., maintains the crosslink frequency range) and maintains the crosslink polarization or lack thereof. The payload 400 also illustrates examples for mapping of inputs and outputs for various relaying and associated signal characteristic conversions between uplink, downlink, and crosslink signaling. Such configurations may provide an efficient means for unidirectional or multi-directional forward and return signal relaying in a satellite 120 (e.g., a satellite 120-a, a satellite 120-b) that includes the payload 400, including such relaying that may involve crosslink signaling with another satellite 120 or a satellite 180.

In some examples, the gains for the forward link transponder (e.g., between output 422-b and input 442-b), the return link transponder (e.g., between output 422-a and input 442-a), and the crosslink transponder (e.g., between output 422-c and input 442-c) of the payload 400 may be different, and configured based on the respective signaling characteristics. For example, an amplifier 465-a may be configured with a gain that is based on a transmission power of antenna assemblies 151, an amplifier 465-b may have a gain that is based on a transmission power of gateway antenna systems 131, and an amplifier 465-c may have a gain that is based on a transmission power of satellites 120 or satellites 180. Further, an amplifier 470-a may be configured with a gain that is based on a reception sensitivity of gateway antenna systems 131, an amplifier 470-b may have a gain that is based on a reception sensitivity of antenna assemblies 151, and an amplifier 470-c may have a gain that is based on a reception sensitivity of satellites 120 or satellites 180. In some examples, such gains may be biased to favor certain types of communications versus another. For example, a forward link transponder may be configured with a gain that is relatively higher than or lower than a gain of a return link transponder (e.g., within a given power constraint of a satellite 120 that includes the payload 400), among other examples. Although the amplifiers 465 are illustrated as components of a reception system 405 and the amplifiers 470 are illustrated as components of a transmission system 415, in some other examples, amplifiers 465, amplifiers 470, or both may be considered to be components of a transponder system 410, or otherwise support a configuration of a net gain of a given signal path of the payload 400 for certain types of communications with certain types of devices.

Additionally, or alternatively, in some examples, configurations for scan angles among the beamforming networks 420 and beamforming networks 420 may be different, such as being different between any combination of uplink, downlink, or crosslink communications, different between forward and return communications, or a combination thereof, or among other differences for various aspects of link balancing or biasing. For example, the payload 400 may be configured for relaying signaling with gateway terminals 130 within a relatively smaller portion of a service area than for relaying signaling with user terminals 150. In such examples, the beamforming network 420-b, the beamforming network 440-a, or both may be configured in accordance with a first range of scan angles, and the beamforming network 420-a, the beamforming network 440-b, or both may be configured in accordance with a second range of scan angles that is greater than the first range of scan angles. In some examples, scan angles for the beamforming networks 420-c and 440-c (e.g., for crosslink reception or transmission) may be configured independently from beamforming networks 420-a, 420-b, 440-a, and 440-b.

In some such examples, a communication system 100 may thus be configured such that an axis 245, an axis 255, or both of a satellite 120 that includes the payload 400 may be aligned more-closely with a gateway terminal 130 than a user terminal 150 being served by the gateway terminal 130. In some examples, to support communications of a coverage area via a gateway terminal 130, a satellite 120 that includes the payload 400 may be configured to orient the positive z-direction toward a location of the coverage area that is within a first range of angular separation from a direction of the gateway terminal 130. With such an orientation, the satellite 120 may support communications with one or more user terminals 150 that are each located along respective other directions that are within a second range of angular separation from the positive z-direction, where the second range of angular separation may be greater than the first range of angular separation.

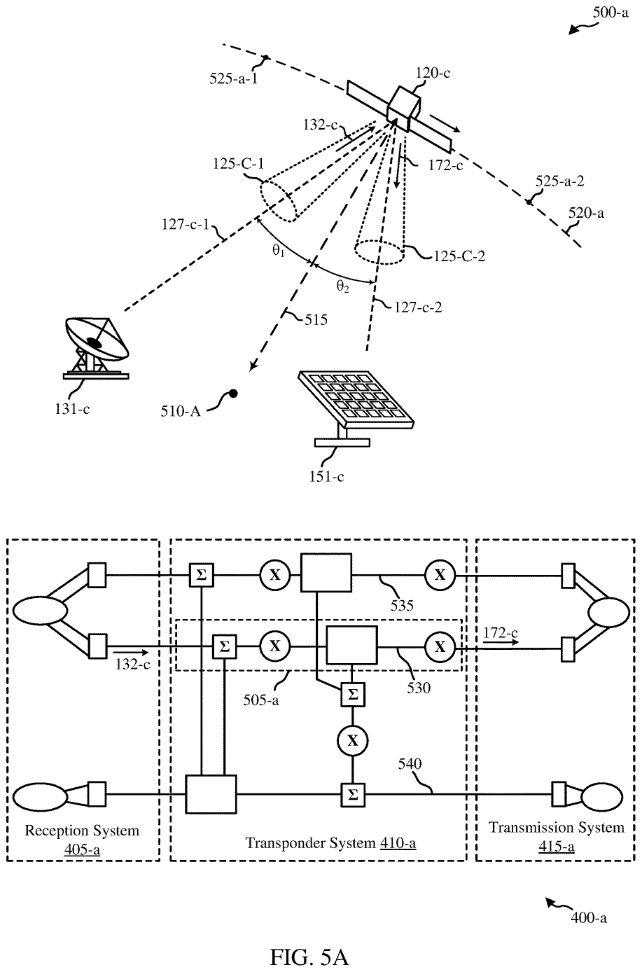

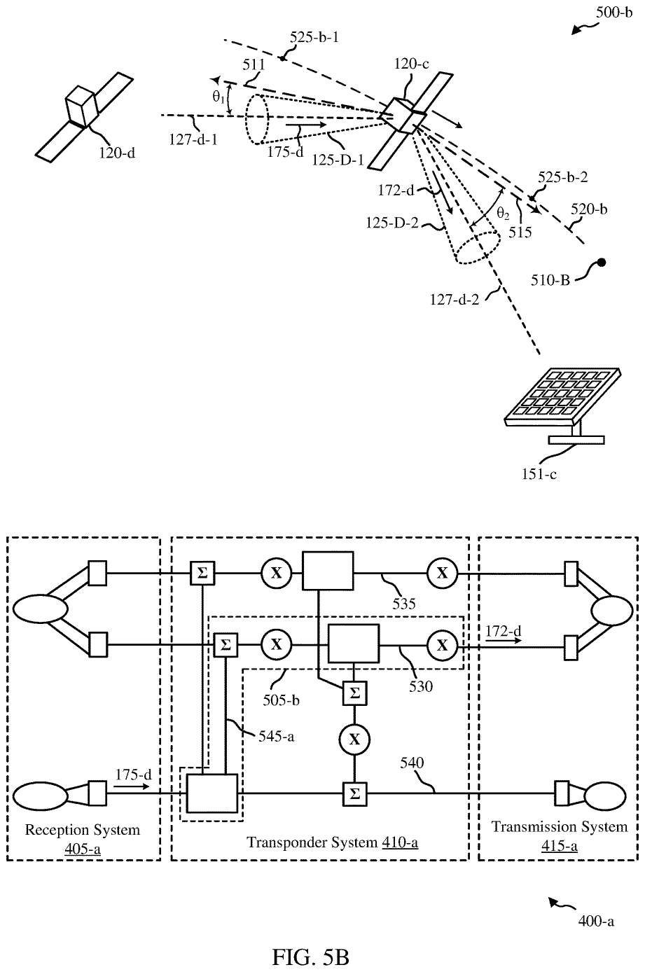

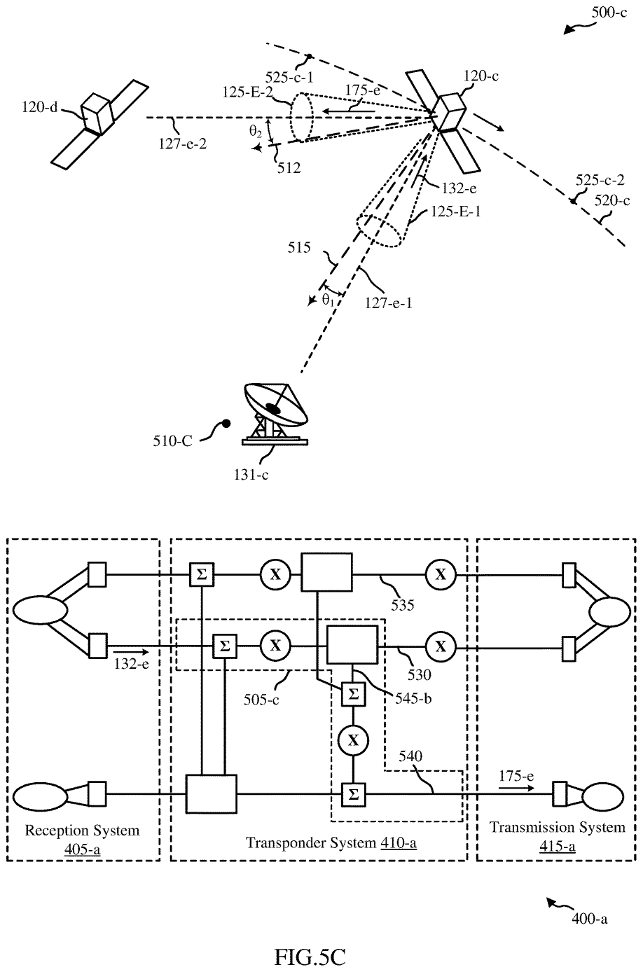

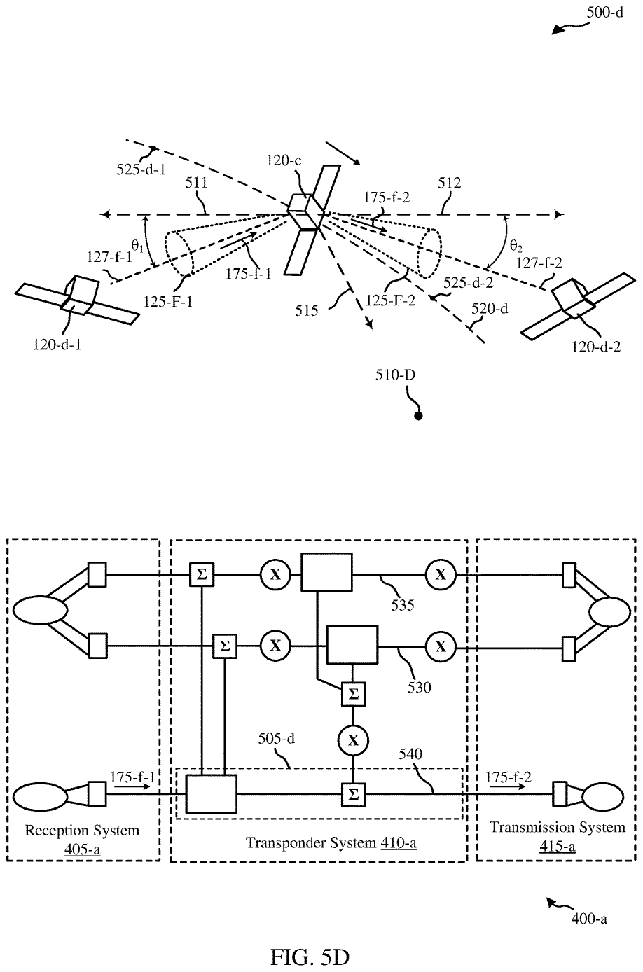

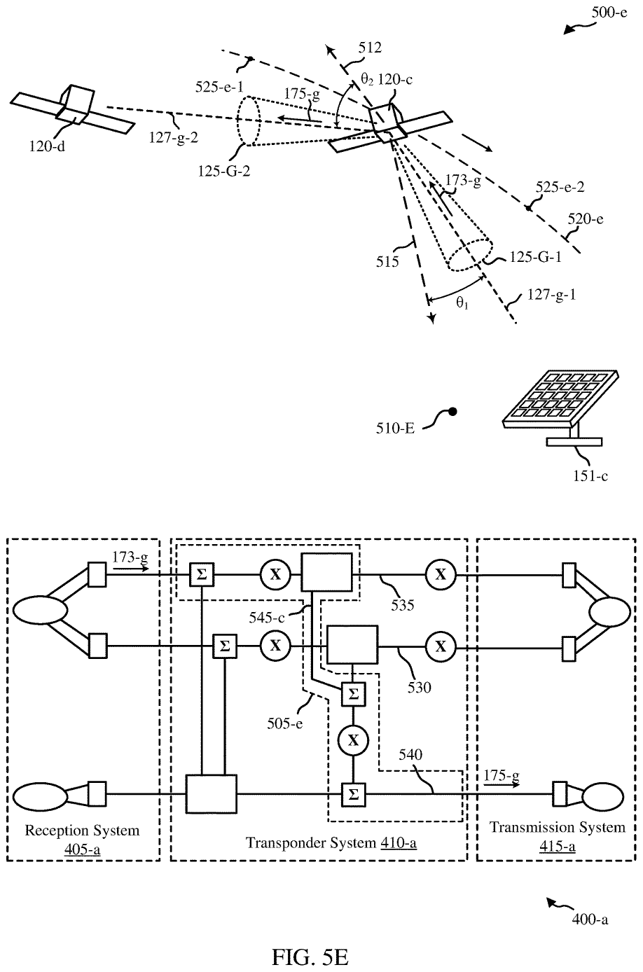

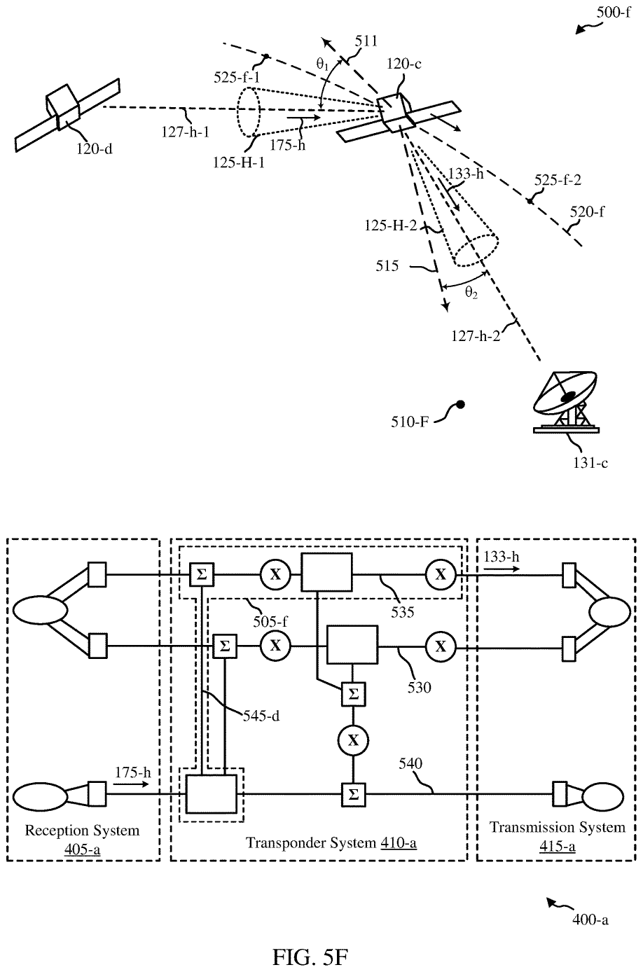

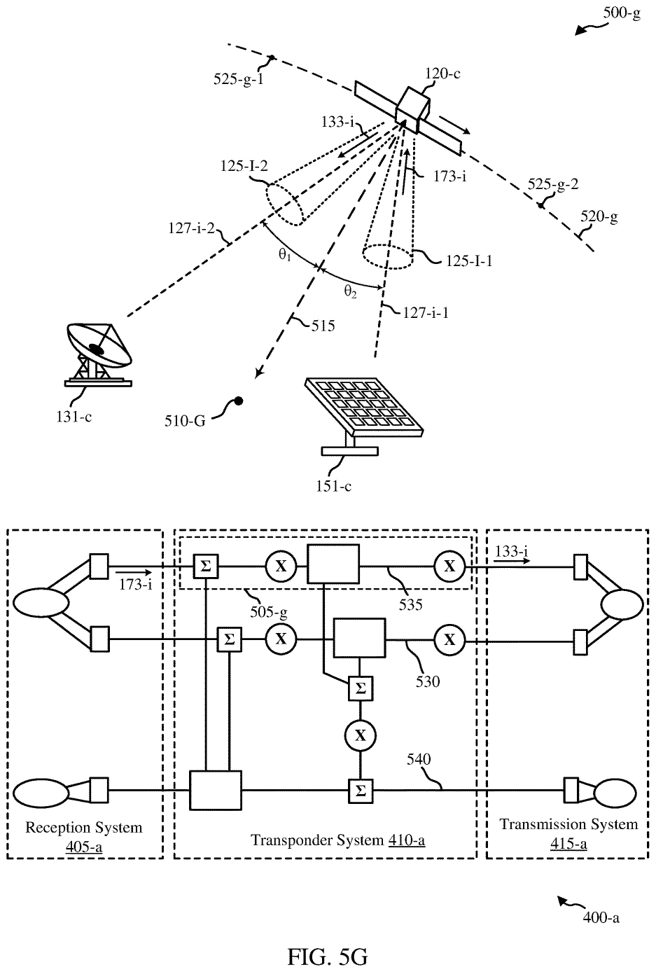

FIGS. 5A through 5G show examples of payload implementations 500 that support single-direction crosslinks in satellite communication systems in accordance with examples as disclosed herein. Each of the payload implementations 500 may be supported by a satellite 120-c, which may be an example of aspects of a satellite 120 (e.g., a satellite 120-a, a satellite 120-b) described herein. The satellite 120-c may include a payload 400-a (e.g., with some components omitted for illustrative clarity), which may be an example of aspects of a payload 400 described with reference to FIG. 4. The payload 400-a may support one or more modes of operation for a satellite 120-c to relay communication between gateway antenna systems 131 (e.g., associated with gateway terminals 130) and antenna assemblies 151 (e.g., antenna assemblies of user terminals 150), which may include a crosslink relay via one or more other satellites 120 or satellite 180, among other devices. To support such modes of operation, the payload 400-a may support one or more configurations (e.g., one or more signal path configurations, one or more relay configurations) that support return link signaling, forward link signaling, or a combination thereof. For example, the payload 400-a may be configured to support signal paths 505, such that each of the signal paths 505 includes one of a pathway 530 (e.g., a single forward pathway), a pathway 535 (e.g., a single return pathway), or a pathway 540 (e.g., a single crosslink pathway), and some of the signal paths 505 also include a pathway 545 (e.g., a transfer pathway).

To support the various configurations, or combinations thereof, the satellite 120-c may be configured to orient itself (e.g., body steer, using a control system 460, using a positioning and steering system 485) along various directions to support signal relaying performance of the payload 400-a (e.g., through a duration during which the satellite 120-c traverses a portion of an orbital path 520, while one or more signal paths 505 are activated). For example, the satellite 120-c may be configured to steer a direction 515 from the satellite 120-c (e.g., an axis of or from the satellite 120-c), which may correspond to an outward direction from a side 215, a side 315, a positive z-direction of the satellite 120-c, an axis 245, an axis 255, or a combination thereof. Additionally, or alternatively, the satellite 120-c may be configured to steer a direction 511 from the satellite 120-c (e.g., for examples in which the satellite 120-c includes a reception array 260 for crosslink reception), which, for various configurations of reception arrays 260, may correspond to an outward direction from a side 211, an outward direction from a side 316, a positive x-direction of the satellite 120-c, a negative z-direction of the satellite 120-c, an axis 265, or a combination thereof. Additionally, or alternatively, the satellite 120-c may be configured to steer a direction 512 from the satellite 120-c (e.g., for examples in which the satellite 120-c includes a transmission array 270 for crosslink transmission), which may correspond to an outward direction from a side 212, a negative x-direction of the satellite 120-c, an axis 275, or a combination thereof. In some other examples (e.g., when the satellite 120-c includes a transmission array 250 that is configured for downlink and crosslink transmission), the direction 515 and the direction 512 may be equivalent.

In some examples, the satellite 120-c may be aligned in a nadir-down orientation, such that a positioning and steering system 485 is configured to orient the direction 515 toward the center of the earth or other angle relative to the earth as it traverses along an orbital path 520. In some other examples, a positioning and steering system 485 may be configured to orient the direction 515 toward a target 510 as the satellite 120-c traverses an orbital path 520 (e.g., steering the direction 515 toward the target 510 as the satellite 120-c traverses a portion of the orbital path 520 between locations 525). In some examples, a target 510 may be a fixed location (e.g., a ground location, a location within a service area associated with a set of one or more user terminals 150, a location within a service area associated with a set of one or more gateway terminals 130, a center of a service area), and the satellite 120-c may steer the direction 515 toward the target 510 continuously or discontinuously (e.g., in accordance with multiple discrete steering impulses) between locations 525 of the orbital path 520, among other examples. In some other examples, a control system 460 may be configured to orient the satellite 120-c (e.g., the direction 515, the direction 511, the direction 512, or a combination thereof) relative to one or more target devices, which may be based on one or more of the payload implementations 500 that are configured at the satellite 120-c at a given time.

The satellite 120-c may be configured to perform such operations by various means. For example, the satellite 120-c may determine such configurations based on information stored at the satellite 120-c, such as information about communications allocations, terminal locations, characteristics of the orbital path 520, information about a target 510, and other information. In some examples, the satellite 120-c may be configured by one or more controllers of a ground segment 101, which may involve signaling any one or more aspects of the above information from the ground segment 101 to the satellite 120-c (e.g., via uplink signals 132, signals 181, signals 183, signals 173, signals 175 or a combination thereof, signals from a gateway terminal 130 received along an earlier point on the orbital path 520, which may be relayed via another satellite 120 or a satellite 180). For example, a network device 141 or a gateway terminal 130 (e.g., a network controller) may determine various aspects of the configuration of the satellite 120-c to support one or more configurations for relaying signaling (e.g., forward signaling or return signaling, which may involve a crosslink), and may configure the satellite 120-c by way of signaling to the satellite 120-c.

FIG. 5A shows an example of a payload implementation 500-a that supports a first configuration (e.g., a forward uplink-to-downlink relay configuration) of the payload 400-a, which may include relaying signaling from a gateway antenna system 131-c to an antenna assembly 151-c.

In the first configuration, the reception system 405-a (e.g., the reception subsystem 407-a) may be configured to receive an uplink signal 132-c (e.g., a receive beam signal, a forward uplink signal, in accordance with an uplink frequency range, in accordance with a forward link polarization) from the gateway antenna system 131-c in accordance with a beam 125-c-1 (e.g., a receive beam). The beam 125-c-1 may be formed using a beamforming network 420-b, for example, which may be configured by the control system 460 (e.g., to implement receive beam weights at the beamforming network 420-b to align directional reception along the beam direction 127-c-1, to generate the beam 125-c-1 in accordance with a scan angle θ1, relative to the direction 515).

To support the first configuration, the control system 460 may also be configured to activate (e.g., enable, configure) a signal path 505-a of the transponder system 410-a (e.g., including pathway 530) that couples the port 411-b with the port 412-b to route the beam signal from the reception system 405-a to the transmission system 415-a. Such an activation may include, for example, activating a beamforming network 420-b or a beamforming network 440-b, activating an amplifier 465-b or an amplifier 470-b, activating ports 406-b, 411-b, 412-b, 416-b or connections therebetween, activating pathway 530, activating frequency converters 425-b or 435-b, configuring switching component 426-b to couple input 427-b with output 428-b-1, configuring switching component 426-c to couple input 427-c-1 with output 428-c-2, or any combination thereof, among other activations. The signal path 505-a may therefore implement frequency conversions of the frequency converters 425-b and 435-b (e.g., to convert from the uplink frequency range to the IF range and from the IF range to the downlink frequency range).

In the first configuration, the transmission system 415-a (e.g., the transmission subsystem 417-a) may therefore transmit a downlink signal 172-c (e.g., a transmit beam signal, a forward downlink signal, in accordance with a downlink frequency range, in accordance with a forward link polarization) to the antenna assembly 151-c that is based at least in part on (e.g., includes information of, is a relay of) the uplink signal 132-c. The transmission system 415-a may transmit the downlink signal 172-c in accordance with a beam 125-c-2 (e.g., a transmit beam). The beam 125-c-2 may be formed using a beamforming network 440-b, for example, which may be configured by the control system 460 (e.g., to implement transmit beam weights at the beamforming network 440-b to align directional transmission along the beam direction 127-c-2, to generate the beam 125-c-2 in accordance with a scan angle θ2).

In some implementations, the first configuration may be supported by steering the direction 515 toward a target 510-a (e.g., through a duration as the satellite 120-c traverses between points 525-a-1 and 525-a-2). In some implementations, steering the satellite 120-c to support the first configuration may be based at least in part on a combination of a location of the gateway antenna system 131-c and a location of the antenna assembly 151-c (e.g., in combination with a location of the satellite 120-c). For example, the positioning and steering system 485 may be configured to steer the satellite 120-c based at least in part on an orientation of the direction 515 relative to the location of the gateway antenna system 131-c and the location of the antenna assembly 151-c. In some examples, the orientation for the direction 515 may be determined (e.g., at the satellite 120-c, at a network controller of a ground segment 101) based on beam performance, such as roll-off characteristics of or differences between a reception array 240 and a transmission array 250, or transmission and reception capabilities of target devices (e.g., antenna assembly 151-c, gateway antenna system 131-c), or a combination thereof. In some examples, the orientation for the direction 515 may be continuously calculated to be between (e.g., to bisect) the angle between the beam direction 127-c-1 and the beam direction 127-c-2 as the satellite 120-c traverses the orbital path 520-a, which may mitigate scan angles of the beamforming networks 420 and 440 and improve signal integrity (e.g., by maintaining θ₁ to be equal to θ₂ or within a threshold difference of θ₂, or to select θ₁ and θ₂ to support the same or similar scan rolloff characteristics or otherwise balance link characteristics).

FIG. 5B shows an example of a payload implementation 500-b that supports a second configuration (e.g., a forward crosslink-to-downlink relay configuration) of the payload 400-a, which may include relaying signaling from a satellite 120-d (e.g., in a geostationary orbit or traversing along an NGSO) to an antenna assembly 151-c.

In the second configuration, the reception system 405-a (e.g., the reception subsystem 407-b) may be configured to receive a crosslink signal 175-d (e.g., a forward crosslink signal, in accordance with a crosslink frequency range, in accordance with a crosslink polarization or lack thereof) from the satellite 120-d in accordance with a beam 125-d-1. The beam 125-d-1 may be formed using a beamforming network 420-c, for example, which may be configured by the control system 460 (e.g., to implement receive beam weights at the beamforming network 420-c to align directional reception along the beam direction 127-d-1, to generate the beam 125-d-1 in accordance with a scan angle θ₁, relative to the direction 511).

To support the second configuration, the control system 460 may also be configured to activate (e.g., enable, configure) a signal path 505-b of the transponder system 410-a (e.g., including pathways 545-a and 530) that couples the port 411-c with the port 412-b to route the beam signal from the reception system 405-a to the transmission system 415-a. Such an activation may include, for example, activating a beamforming network 420-c or a beamforming network 440-b, activating an amplifier 465-c or an amplifier 470-b, activating ports 406-c, 411-c, 412-b, 416-b or connections therebetween, activating pathways 545-a and 530, activating frequency converters 425-b or 435-b, configuring switching component 426-b to couple input 427-b with output 428-b-1, configuring switching component 426-c to couple input 427-c-2 with output 428-c-2, or any combination thereof, among other activations. The signal path 505-b may therefore implement frequency conversions of the frequency converters 425-b and 435-b (e.g., to convert from the crosslink frequency range to the IF range and from the IF range to the downlink frequency range).

In the second configuration, the transmission system 415-a (e.g., the transmission subsystem 417-a) may therefore transmit a downlink signal 172-d (e.g., a forward downlink signal, in accordance with a downlink frequency range, in accordance with a forward link polarization) to the antenna assembly 151-c that is based at least in part on the crosslink signal 175-d. The transmission system 415-a may transmit the downlink signal 172-d in accordance with a beam 125-d-2. The beam 125-d-2 may be formed using a beamforming network 440-b, for example, which may be configured by the control system 460 (e.g., to implement transmit beam weights at the beamforming network 440-b to align directional transmission along the beam direction 127-d-2, to generate the beam 125-d-2 in accordance with a scan angle θ₂, relative to the direction 515).

In some implementations, the second configuration may be supported by steering the direction 515 toward a target 510-b (e.g., through a duration as the satellite 120-c traverses between points 525-b-1 and 525-b-2). In some implementations, steering the satellite 120-c to support the second configuration may be based at least in part on a combination of a location of the satellite 120-d and a location of the antenna assembly 151-c (e.g., in combination with a location of the satellite 120-c). For example, the positioning and steering system 485 may be configured to steer the satellite 120-c based at least in part on an orientation of the direction 511 relative to the location of the satellite 120-d and on an orientation of the direction 515 relative to the location of the antenna assembly 151-c. In some examples, the orientation for the directions 511 and 515 may be determined (e.g., at the satellite 120-c, at a network controller of a ground segment 101) based on beam performance, such as roll-off characteristics of or differences between a reception array 260 and a transmission array 250, or transmission and reception capabilities of target devices (e.g., satellite 120-d, antenna assembly 151-c), or a combination thereof. In some examples, the orientation for the directions 511 and 515 may be continuously calculated as the satellite 120-c traverses the orbital path 520-b, which may mitigate scan angles of the beamforming networks 420 and 440 and improve signal integrity (e.g., by maintaining θ₁ to be equal to θ₂ or within a threshold difference of θ₂, or to select θ₁ and θ₂ to support the same or similar scan rolloff characteristics or otherwise balance link characteristics).

FIG. 5C shows an example of a payload implementation 500-c that supports a third configuration (e.g., a forward uplink-to-crosslink relay configuration) of the payload 400-a, which may include relaying signaling from a gateway antenna system 131-c to a satellite 120-d (e.g., in a geostationary orbit or traversing along an NGSO).

In the third configuration, the reception system 405-a (e.g., the reception subsystem 407-a) may be configured to receive an uplink signal 132-e (e.g., a forward uplink signal, in accordance with an uplink frequency range, in accordance with a forward polarization) from the gateway antenna system 131-c in accordance with a beam 125-e-1. The beam 125-e-1 may be formed using a beamforming network 420-b, for example, which may be configured by the control system 460 (e.g., to implement receive beam weights at the beamforming network 420-b to align directional reception along the beam direction 127-e-1, to generate the beam 125-e-1 in accordance with a scan angle θ₁, relative to the direction 515).

To support the third configuration, the control system 460 may also be configured to activate (e.g., enable, configure) a signal path 505-c of the transponder system 410-a (e.g., including pathways 545-b and 540) that couples the port 411-b with the port 412-c to route the beam signal from the reception system 405-a to the transmission system 415-a. Such an activation may include, for example, activating a beamforming network 420-b or a beamforming network 440-c, activating an amplifier 465-b or an amplifier 470-c, activating ports 406-b, 411-b, 412-c, 416-c or connections therebetween, activating pathways 545-b and 540, activating frequency converters 425-b or 436, configuring switching component 426-b to couple input 427-b with output 428-b-2, configuring switching component 426-c to couple input 427-c-1 with output 428-c-2, or any combination thereof, among other activations. The signal path 505-c may therefore implement frequency conversions of the frequency converters 425-b and 436 (e.g., to convert from the uplink frequency range to the IF range and from the IF range to the crosslink frequency range).

In the third configuration, the transmission system 415-a (e.g., a transmission subsystem 417-a or 417-b, depending on which is configured for crosslink transmission) may therefore transmit a crosslink signal 175-e (e.g., a forward crosslink signal, in accordance with a crosslink frequency range, in accordance with a crosslink polarization or lack thereof) to the satellite 120-d that is based at least in part on the uplink signal 132-e. The transmission system 415-a may transmit the crosslink signal 175-e in accordance with a beam 125-e-2. The beam 125-e-2 may be formed using a beamforming network 440-c, for example, which may be configured by the control system 460 (e.g., to implement transmit beam weights at the beamforming network 440-c to align directional transmission along the beam direction 127-e-2, to generate the beam 125-e-2 in accordance with a scan angle θ₂, relative to the direction 512).

In some implementations, the third configuration may be supported by steering the direction 515 toward a target 510-c (e.g., through a duration as the satellite 120-c traverses between points 525-c-1 and 525-c-2). In some implementations, steering the satellite 120-c to support the third configuration may be based at least in part on a combination of a location of the gateway antenna system 131-c and a location of the satellite 120-d (e.g., in combination with a location of the satellite 120-c). For example, the positioning and steering system 485 may be configured to steer the satellite 120-c based at least in part on an orientation of the direction 515 relative to the location of the gateway antenna system 131-c and an orientation of the direction 512 relative to the location of the satellite 120-d. In some examples, the orientations for the directions 515 and 512 may be determined (e.g., at the satellite 120-c, at a network controller of a ground segment 101) based on beam performance, such as roll-off characteristics of or differences between a reception array 240 and a transmission array 250 or 270, or transmission and reception capabilities of target devices (e.g., gateway antenna system 131-c, satellite 120-d), or a combination thereof. In some examples, the orientations for the directions 515 and 512 may be continuously calculated to be between (e.g., to bisect) the angle between the beam direction 127-e-1 and the beam direction 127-e-2 as the satellite 120-c traverses the orbital path 520-c, which may mitigate scan angles of the beamforming networks 420 and 440 and improve signal integrity (e.g., by maintaining θ₁ to be equal to θ₂ or within a threshold difference of θ₂, or to select θ₁ and θ₂ to support the same or similar scan rolloff characteristics or otherwise balance link characteristics).

FIG. 5D shows an example of a payload implementation 500-d that supports a fourth configuration (e.g., a crosslink-to-crosslink relay configuration, for forward or return relaying) of the payload 400-a, which may include relaying signaling from a satellite 120-d-1 to a satellite 120-d-2 (e.g., each in a geostationary orbit or traversing along an NGSO).

In the fourth configuration, the reception system 405-a (e.g., the reception subsystem 407-b) may be configured to receive a crosslink signal 175-f-1 (e.g., a forward receive crosslink signal or a return receive crosslink signal, in accordance with a crosslink frequency range, in accordance with a crosslink polarization or lack thereof) from the satellite 120-d-1 in accordance with a beam 125-f-1. The beam 125-f-1 may be formed using a beamforming network 420-c, for example, which may be configured by the control system 460 (e.g., to implement receive beam weights at the beamforming network 420-c to align directional reception along the beam direction 127-f-1, to generate the beam 125-f-1 in accordance with a scan angle θ₁, relative to the direction 511).

To support the fourth configuration, the control system 460 may also be configured to activate (e.g., enable, configure) a signal path 505-d of the transponder system 410-a (e.g., including pathway 540) that couples the port 411-c with the port 412-c to route the beam signal from the reception system 405-a to the transmission system 415-a. Such an activation may include, for example, activating a beamforming network 420-c or a beamforming network 440-c, activating an amplifier 465-c or an amplifier 470-c, activating ports 406-c, 411-c, 412-c, 416-c or connections therebetween, activating pathway 540, or any combination thereof, among other activations. The signal path 505-d may therefore be implemented without a frequency conversion (e.g., maintaining the signaling in the crosslink frequency range).

In the fourth configuration, the transmission system 415-a (e.g., a transmission subsystem 417-a or 417-b, depending on which is configured for crosslink transmission) may therefore transmit a crosslink signal 175-f-2 (e.g., a forward transmit crosslink signal, a return crosslink transmit signal, in accordance with a crosslink frequency range, in accordance with a crosslink polarization or lack thereof) to the satellite 120-d-2 that is based at least in part on the crosslink signal 175-f-1. The transmission system 415-a may transmit the crosslink signal 175-f-2 in accordance with a beam 125-f-2. The beam 125-f-2 may be formed using a beamforming network 440-c, for example, which may be configured by the control system 460 (e.g., to implement transmit beam weights at the beamforming network 440-c to align directional transmission along the beam direction 127-f-2, to generate the beam 125-f-2 in accordance with a scan angle θ₂, relative to the direction 512).

In some implementations, the fourth configuration may be supported by steering the direction 515 toward a target 510-d (e.g., through a duration as the satellite 120-c traverses between points 525-d-1 and 525-d-2). In some implementations, steering the satellite 120-c to support the fourth configuration may be based at least in part on a combination of a location of the satellite 120-d-1 and a location of the satellite 120-d-2 (e.g., in combination with a location of the satellite 120-c). For example, the positioning and steering system 485 may be configured steer the satellite 120-c based at least in part on an orientation of the direction 511 relative to the location of the satellite 120-d-1 and on an orientation of the direction 512 relative to the location of the satellite 120-d-2. In some examples, the orientation for the directions 515, 511, or 512 may be determined (e.g., at the satellite 120-c, at a network controller of a ground segment 101) based on beam performance, such as roll-off characteristics of or differences between a reception array 260 and a transmission array 250 or 270, or transmission and reception capabilities of target devices (e.g., satellites 120-d-1 and 120-d-2), or a combination thereof. In some examples, the orientation for the directions 515, 511, or 512 may be continuously calculated as the satellite 120-c traverses the orbital path 520-d, which may mitigate scan angles of the beamforming networks 420 and 440 and improve signal integrity (e.g., by maintaining θ₁ to be equal to θ₂ or within a threshold difference of θ₂, or to select θ₁ and θ₂ to support the same or similar scan rolloff characteristics or otherwise balance link characteristics).

FIG. 5E shows an example of a payload implementation 500-e that supports a fifth configuration (e.g., a return uplink-to-crosslink relay configuration) of the payload 400-a, which may include relaying signaling from an antenna assembly 151-c to a satellite 120-d (e.g., in a geostationary orbit or traversing along an NGSO).

In the fifth configuration, the reception system 405-a (e.g., the reception subsystem 407-a) may be configured to receive an uplink signal 173-g (e.g., a return uplink signal, in accordance with an uplink frequency range, in accordance with a return polarization) from the antenna assembly 151-c in accordance with a beam 125-g-1. The beam 125-g-1 may be formed using a beamforming network 420-a, for example, which may be configured by the control system 460 (e.g., to implement receive beam weights at the beamforming network 420-a to align directional reception along the beam direction 127-g-1, to generate the beam 125-g-1 in accordance with a scan angle θ₁, relative to the direction 515).

To support the fifth configuration, the control system 460 may also be configured to activate (e.g., enable, configure) a signal path 505-e of the transponder system 410-a (e.g., including pathways 545-c and 540) that couples the port 411-a with the port 412-c to route the beam signal from the reception system 405-a to the transmission system 415-a. Such an activation may include, for example, activating a beamforming network 420-a or a beamforming network 440-c, activating an amplifier 465-a or an amplifier 470-c, activating ports 406-a, 411-a, 412-c, 416-c or connections therebetween, activating pathways 545-c and 540, activating frequency converters 425-a or 436, configuring switching component 426-a to couple input 427-a with output 428-a-2, configuring switching component 426-c to couple input 427-c-1 with output 428-c-1, or any combination thereof, among other activations. The signal path 505-e may therefore implement frequency conversions of the frequency converters 425-a and 436 (e.g., to convert from the uplink frequency range to the IF range and from the IF range to the crosslink frequency range).

In the fifth configuration, the transmission system 415-a (e.g., a transmission subsystem 417-a or 417-b, depending on which is configured for crosslink transmission) may therefore transmit a crosslink signal 175-g (e.g., a return crosslink signal, in accordance with a crosslink frequency range, in accordance with a crosslink polarization or lack thereof) to the satellite 120-d that is based at least in part on the uplink signal 173-g. The transmission system 415-a may transmit the crosslink signal 175-g in accordance with a beam 125-g-2. The beam 125-g-2 may be formed using a beamforming network 440-c, for example, which may be configured by the control system 460 (e.g., to implement transmit beam weights at the beamforming network 440-c to align directional transmission along the beam direction 127-g-2, to generate the beam 125-g-2 in accordance with a scan angle θ₂, relative to the direction 512).

In some implementations, the fifth configuration may be supported by steering the direction 515 toward a target 510-e (e.g., through a duration as the satellite 120-c traverses between points 525-e-1 and 525-e-2). In some implementations, steering the satellite 120-c to support the fifth configuration may be based at least in part on a combination of a location of the antenna assembly 151-c and a location of the satellite 120-d (e.g., in combination with a location of the satellite 120-c). For example, the positioning and steering system 485 may be configured steer the satellite 120-c based at least in part on an orientation of the direction 515 relative to the location of the antenna assembly 151-c and on an orientation of the direction 512 relative to the location of the satellite 120-d. In some examples, the orientations for the directions 515 and 512 may be determined (e.g., at the satellite 120-c, at a network controller of a ground segment 101) based on beam performance, such as roll-off characteristics of or differences between a reception array 240 and a transmission array 250 or 270, or transmission and reception capabilities of target devices (e.g., antenna assembly 151-c, satellite 120-d), or a combination thereof. In some examples, the orientations for the directions 515 of 512 may be continuously calculated to be between (e.g., to bisect) the angle between the beam direction 127-g-1 and the beam direction 127-g-2 as the satellite 120-c traverses the orbital path 520-e, which may mitigate scan angles of the beamforming networks 420 and 440 and improve signal integrity (e.g., by maintaining θ₁ to be equal to θ₂ or within a threshold difference of θ₂, or to select θ₁ and θ₂ to support the same or similar scan rolloff characteristics or otherwise balance link characteristics).

FIG. 5F shows an example of a payload implementation 500-f that supports a sixth configuration (e.g., a return crosslink-to-downlink relay configuration) of the payload 400-a, which may include relaying signaling from a satellite 120-d (e.g., in a geostationary orbit or traversing along an NGSO) to a gateway antenna system 131-c.

In the sixth configuration, the reception system 405-a (e.g., the reception subsystem 407-b) may be configured to receive a crosslink signal 175-h (e.g., a return crosslink signal, in accordance with a crosslink frequency range, in accordance with a crosslink polarization or lack thereof) from the satellite 120-d in accordance with a beam 125-h-1. The beam 125-h-1 may be formed using a beamforming network 420-c, for example, which may be configured by the control system 460 (e.g., to implement receive beam weights at the beamforming network 420-c to align directional reception along the beam direction 127-h-1, to generate the beam 125-h-1 in accordance with a scan angle θ₁, relative to the direction 511).

To support the sixth configuration, the control system 460 may also be configured to activate (e.g., enable, configure) a signal path 505-f of the transponder system 410-a (e.g., including pathways 545-d and 535) that couples the port 411-c with the port 412-a to route the beam signal from the reception system 405-a to the transmission system 415-a. Such an activation may include, for example, activating a beamforming network 420-c or a beamforming network 440-a, activating an amplifier 465-c or an amplifier 470-a, activating ports 406-c, 411-c, 412-a, 416-a or connections therebetween, activating pathways 545-d and 535, activating frequency converters 425-a or 435-a, configuring switching component 426-a to couple input 427-a with output 428-a-1, configuring switching component 426-c to couple input 427-c-2 with output 428-c-1, or any combination thereof, among other activations. The signal path 505-f may therefore implement frequency conversions of the frequency converters 425-b and 435-b (e.g., to convert from the crosslink frequency range to the IF range and from the IF range to the downlink frequency range).

In the sixth configuration, the transmission system 415-a (e.g., the transmission subsystem 417-a) may therefore transmit a downlink signal 133-h (e.g., a return downlink signal, in accordance with a downlink frequency range, in accordance with a return link polarization) to the gateway antenna system 131-c that is based at least in part on the crosslink signal 175-h. The transmission system 415-a may transmit the downlink signal 133-h in accordance with a beam 125-h-2. The beam 125-h-2 may be formed using a beamforming network 440-a, for example, which may be configured by the control system 460 (e.g., to implement transmit beam weights at the beamforming network 440-a to align directional transmission along the beam direction 127-h-2, to generate the beam 125-h-2 in accordance with a scan angle θ₂, relative to the direction 515).

In some implementations, the sixth configuration may be supported by steering the direction 515 toward a target 510-f (e.g., through a duration as the satellite 120-c traverses between points 525-f-1 and 525-f-2). In some implementations, steering the satellite 120-c to support the sixth configuration may be based at least in part on a combination of a location of the satellite 120-d and a location of the gateway antenna system 131-c (e.g., in combination with a location of the satellite 120-c). For example, the positioning and steering system 485 may be configured steer the satellite 120-c based at least in part on an orientation of the direction 511 relative to the location of the satellite 120-d and on an orientation of the direction 515 relative to the location of the gateway antenna system 131-c. In some examples, the orientations for the directions 515 and 511 may be determined (e.g., at the satellite 120-c, at a network controller of a ground segment 101) based on beam performance, such as roll-off characteristics of or differences between a reception array 260 and a transmission array 250, or transmission and reception capabilities of target devices (e.g., satellite 120-d, gateway antenna system 131-c), or a combination thereof. In some examples, the orientations for the directions 515 and 511 may be continuously calculated as the satellite 120-c traverses the orbital path 520-f, which may mitigate scan angles of the beamforming networks 420 and 440 and improve signal integrity (e.g., by maintaining θ₁ to be equal to θ₂ or within a threshold difference of θ₂, or to select θ₁ and θ₂ to support the same or similar scan rolloff characteristics or otherwise balance link characteristics).

FIG. 5G shows an example of a payload implementation 500-g that supports a seventh configuration (e.g., a return uplink-to-downlink relay configuration) of the payload 400-a, which may include relaying signaling from an antenna assembly 151-c to a gateway antenna system 131-c.

In the seventh configuration, the reception system 405-a (e.g., the reception subsystem 407-a) may be configured to receive an uplink signal 173-i (e.g., a return uplink signal, in accordance with an uplink frequency range, in accordance with a return link polarization) from the antenna assembly 151-c in accordance with a beam 125-i-1. The beam 125-i-1 may be formed using a beamforming network 420-a, for example, which may be configured by the control system 460 (e.g., to implement receive beam weights at the beamforming network 420-a to align directional reception along the beam direction 127-i-1, to generate the beam 125-i-1 in accordance with a scan angle θ₁, relative to the direction 515).

To support the seventh configuration, the control system 460 may also be configured to activate (e.g., enable, configure) a signal path 505-g of the transponder system 410-a (e.g., including pathway 535) that couples the port 411-a with the port 412-a to route the beam signal from the reception system 405-a to the transmission system 415-a. Such an activation may include, for example, activating a beamforming network 420-a or a beamforming network 440-a, activating an amplifier 465-a or an amplifier 470-a, activating ports 406-a, 411-a, 412-a, 416-a or connections therebetween, activating pathway 535, activating frequency converters 425-a or 435-a, configuring switching component 426-a to couple input 427-a with output 428-a-1, configuring switching component 426-c to couple input 427-c-1 with output 428-c-1, or any combination thereof, among other activations. The signal path 505-g may therefore implement frequency conversions of the frequency converters 425-a and 435-a (e.g., to convert from the uplink frequency range to the IF range and from the IF range to the downlink frequency range).

In the seventh configuration, the transmission system 415-a (e.g., the transmission subsystem 417-a) may therefore transmit a downlink signal 133-i (e.g., a return downlink signal, in accordance with a downlink frequency range, in accordance with a return link polarization) to the gateway antenna system 131-c that is based at least in part on the uplink signal 173-i. The transmission system 415-a may transmit the downlink signal 133-i in accordance with a beam 125-i-2. The beam 125-i-2 may be formed using a beamforming network 440-a, for example, which may be configured by the control system 460 (e.g., to implement transmit beam weights at the beamforming network 440-a to align directional transmission along the beam direction 127-i-2, to generate the beam 125-i-2 in accordance with a scan angle θ₂, relative to the direction 515).

In some implementations, the seventh configuration may be supported by steering the direction 515 toward a target 510-g (e.g., through a duration as the satellite 120-c traverses between points 525-g-1 and 525-g-2). In some implementations, steering the satellite 120-c to support the seventh configuration may be based at least in part on a combination of a location of the gateway antenna system 131-c and a location of the antenna assembly 151-c (e.g., in combination with a location of the satellite 120-c). For example, the positioning and steering system 485 may be configured steer the satellite 120-c based at least in part on an orientation of the direction 515 relative to the location of the gateway antenna system 131-c and the location of the antenna assembly 151-c. In some examples, the orientation for the direction 515 may be determined (e.g., at the satellite 120-c, at a network controller of a ground segment 101) based on beam performance, such as roll-off characteristics of or differences between a reception array 240 and a transmission array 250, or transmission and reception capabilities of target devices (e.g., antenna assembly 151-c, gateway antenna system 131-c), or a combination thereof. In some examples, the orientation for the direction 515 may be continuously calculated to be between (e.g., to bisect) the angle between the beam direction 127-i-1 and the beam direction 127-i-2 as the satellite 120-c traverses the orbital path 520-g, which may mitigate scan angles of the beamforming networks 420 and 440 and improve signal integrity (e.g., by maintaining θ₁ to be equal to θ₂ or within a threshold difference of θ₂, or to select θ₁ and θ₂ to support the same or similar scan rolloff characteristics or otherwise balance link characteristics).

Although the payload implementations 500 are illustrated and described separately, a satellite 120-c that includes the payload 400-a may support modes in which multiple payload implementations 500 concurrently.

In some examples, the satellite 120-c may be operable to support any pair of configurations that implement different ports 406 (e.g., supporting any two of forward, return, or crosslink reception) and different ports 416. In some examples (e.g., in a power-limited configuration), the satellite 120-c may be operable to support a signal path that implements a beamforming network 440-a (e.g., for transmitting return downlink signaling) and either a beamforming network 440-b or a beamforming network 440-c (e.g., for transmitting either forward downlink signaling or crosslink signaling, but not both, for a configuration in accordance with a satellite 120-a), or a beamforming network 440-b for transmitting either forward downlink signaling or crosslink signaling (e.g., for a configuration in accordance with a satellite 120-b). For example, if any one of signal paths 505-a through 505-d is enabled, the others of these signal paths may be disabled. Additionally, or alternatively, if any one of signal paths 505-e through 505-g are enabled, the others of these signal paths may be disabled.

In some examples, for a mode that supports bidirectional relaying without crosslinks, the satellite 120-c may be configured to enable the signal path 505-a and the signal path 505-g (e.g., concurrently) and, in such a mode, the satellite 120-c may be configured to disable the other signal paths 505-b through 505-f (e.g., disabling amplifiers 465-c and 470-c, disabling beamforming networks 420-c and 440-c, disabling ports 406-c, 411-c, 412-c, 416-c or connections therebetween, disabling a switching component 426-d or interconnections thereof, among other disabling). In some other examples (e.g., in a non-power-limited configuration, when an available power satisfies a threshold), for a mode that supports tri-directional relaying, the satellite 120-c may be configured to enable the signal paths 505-a, 505-d, and 505-g concurrently.

In another example, for a first mode that supports bidirectional relaying with a forward crosslink, the satellite 120-c may be configured to enable the signal path 505-b and the signal path 505-g and, in such a mode, the satellite 120-c may be configured to disable signal paths 505-a and 505-c through 505-f. In another example, for a second mode that supports bidirectional relaying with a forward crosslink, the satellite 120-c may be configured to enable the signal path 505-c and the signal path 505-g and, in such a mode, the satellite 120-c may be configured to disable signal paths 505-a, 505-b, and 505-d through 505-f.

In another example, for a first mode that supports bidirectional relaying with a return crosslink, the satellite 120-c may be configured to enable the signal path 505-a and the signal path 505-e and, in such a mode, the satellite may be configured to disable other signal paths 505-b through 505-d, 505-f, and 505-g. In another example, for a second mode that supports bidirectional relaying with a return crosslink, the satellite 120-c may be configured to enable the signal path 505-a and the signal path 505-f and, in such a mode, the satellite may be configured to disable other signal paths 505-b through 505-e and 505-g.

In another example, for a mode that supports a return relay and a crosslink relay (e.g., in a power-limited configuration), the satellite 120-c may be configured to enable the signal path 505-d and the signal path 505-g and, in such a mode, the satellite 120-c may be configured to disable signal paths 505-a through 505-c, 505-e, and 505-f.

In each of such examples, the steering of the satellite 120-c may be balanced between the one or more enabled configurations, such as minimizing scan angles, balancing or biasing link characteristics, and other considerations.

The satellite 120-c may thus be operated in different modes, which may implement the first configuration through the seventh configuration, or a combination thereof (e.g., concurrently, for bidirectional relaying, for tridirectional relaying). In some examples, orienting the satellite 120-c may also include rotating the satellite 120-c about a central axis (e.g., about the z-direction, about a direction 515, when the signal paths 505-a and/or 505-g are enabled) of the satellite 120-c. For example, the control system 460 may configure the positioning and steering system 485 to rotate the satellite 120-c about the z-direction (e.g., about the direction 515) based on antenna parameters (e.g., directional sensitivity of a reception array 240, a reception array 260, a transmission array 250, or a transmission array 270, along the x-direction, along the y-direction, or both), or may orient the satellite 120-c to improve collection of energy using solar elements 230 or 330, among other examples.

In some examples, communicating signaling between a user terminal 150 and a gateway terminal 130 using a communication system 100 may include relaying the signaling through multiple satellites 120 in different modes using a combination of uplink signaling (e.g., signals 132, signals 173), downlink signaling (e.g., signals 172, signals 133), and crosslink signaling (e.g., signals 175, signals 183), including examples as described with reference to FIGS. 1 through 5G. In some cases, a satellite 120 may be configured for unidirectional crosslink communication, including use of a fixed crosslink reception array (e.g., a reception array 260), a fixed crosslink transmission array (e.g., a transmission array 250, a transmission array 270), or a combination thereof. For example, a satellite 120 may include a transmission array 270 (e.g., a crosslink transmission array) and a reception array 260 (e.g., crosslink reception array) arranged (positioned, located) on different faces of the satellite 120. In some examples, the transmission array 270 may be arranged on a first side of the satellite 120 (e.g., a side 212, a side 316), and the reception array 260 may be arranged on a second side of the satellite 120 opposite the first side (e.g., a side 211, a side 315). In some other examples, the transmission array 270 may be arranged on a first side of the satellite 120 (e.g., a side 212), and the reception array 260 may be arranged on a third side of the satellite 120 perpendicular to the first side (e.g., a side 213, a side 214, a side 215, or a side 216).

Arranging transmission arrays and reception arrays on different sides of a satellite 120 may allow the satellite 120 to reduce interference between reception signaling associated with the reception array and transmission signaling associated with the transmission array. Accordingly, the frequency range used for transmitting signaling using a transmission array (e.g., a transmission array 270) and the frequency range used for receiving signaling using a reception array (e.g., a reception array 260) may overlap (e.g., reception and transmission may use a same frequency range, such as a crosslink frequency range between 61 GHz and 66 GHZ), which may allow the satellite 120 to utilize an expanded frequency range compared with a satellite in which a transmission array and a reception array are arranged on a same side. Additionally, by utilizing an overlapping frequency range for transmission and reception, the design of the satellite 120 may be simplified, for example by allowing the satellite 120 to receive crosslink signaling and transmit crosslink signaling (e.g., by activating a signal path 505-d) without converting the frequency of signaling (e.g., without using frequency converters, diplexers, or the like).

In some examples, such an arrangement of transmission and reception arrays may allow a satellite 120 to efficiently relay forward link signaling or return link signaling within the communication system 100. For example, to support relaying a forward crosslink signal 175, a first satellite 120 may be configured to orient such that the reception antenna array may receive a forward link signal from a second satellite 120, and the transmission antenna array may transmit the forward link signal to a third satellite 120. However, due to the orientation of the transmission and reception arrays, the satellite 120 may not be able to relay a return crosslink signal 175 (e.g., receive a return link signal from the third satellite 120 and transmit a return crosslink signal to the second satellite 120) without reorienting. For example, such a satellite 120 may be configured for unidirectional crosslink relaying, which may involve a single crosslink pathway. Accordingly, to support efficient bidirectional communication using the communication system 100, the communication system 100 may utilize multiple satellites 120 for crosslink relays, each satellite 120 configured for unidirectional communication in a respective direction.

For example, a user terminal 150 may be configured for bidirectional communication with multiple sets of satellites 120. In such examples, one or more first satellites 120 (e.g., of a first set) may be configured as part of a forward link path to relay forward link signaling from a gateway terminal 130 to a user terminal 150. Additionally, one or more second satellites 120 (e.g., of a second set), different than the one or more first satellites 120, may be configured as part of a return link path to relay return link signaling from the user terminal 150 to a gateway terminal 130. The one or more first satellites 120, the one or more second satellites 120, or both may include at least one crosslink relay (e.g., a satellite 120 configured for relaying crosslink communications between two other satellites 120). Such a crosslink relay may be configured to receive signaling from a first satellite 120 via a reception antenna array (e.g., a reception array 260) on a first side of the crosslink relay within a crosslink frequency band, and may be configured to transmit signaling to a second satellite via a transmission antenna array (e.g., a transmission array 270) on a second side of the crosslink relay within the crosslink frequency band without a frequency between the reception and transmission.

FIG. 6 shows an example of a communication system implementation 600 (e.g., an implementation of a communication system 100) that supports single-direction crosslinks in satellite communication systems in accordance with examples as disclosed herein. The communication system implementation 600 may include a constellation of satellites 120-e that each implement one or more aspects of a payload 400 (e.g., in accordance with one or more payload implementations 500 at a time). The satellites 120-e may relay communication between one or more gateway terminals 130 (e.g., via respective gateway antenna systems 131) and user terminals 150 (e.g., via respective antenna assemblies 151), which may include crosslink relays via one or more satellites 120-e or satellites 180, among other devices. To support such communications, the satellites 120-e may be configured to steer (e.g., orient, body steer, using a control system, using a positioning and steering system) along various directions to support signal relaying performance of the respective payloads 400 through durations during which the satellites 120-e traverse one or more portions of respective orbital paths 520 (e.g., paths of respective NGSOs).

The satellites 120-e may support a communication service for (e.g., relay communication between) one or more gateway terminals 130 (e.g., gateway terminals 130-d-1 and 130-d-2) and one or more user terminals 150 (e.g., user terminal 150-d) located within one or more service areas during a duration in which the satellites 120-e provide service to the respective service area(s). For example, the satellites 120-e may be configured to relay forward link signaling (e.g., data signaling, control signaling, configuration signaling) from a gateway terminal 130-d to the user terminal 150-d, and to relay return link signaling (e.g., data signaling, control signaling, configuration signaling) from the user terminal 150-d to a gateway terminal 130-d, among other signaling (e.g., with one or more other user terminals 150, with one or more other gateway terminals 130, with one or more other satellites 120 or 180).

A communication system 100 may implement one or more forward paths 610 (e.g., a forward link path) configured to relay forward link signaling, and may implement one or more return paths 620 (e.g., a return link path) configured to relay return link signaling. As described herein, a forward path 610 may include a subset of one or more of the satellites 120-e (e.g., a forward link subset) that are configured for relaying forward link signaling to one or more user terminals 150 (e.g., of a target service area), and a return path 620 may include a subset of one or more of the satellites 120-e (e.g., a return link subset) that are configured for relaying return link signaling from one or more user terminals 150 (e.g., of a target service area). Because the satellites 120-e may be configured for unidirectional crosslink relays, if a crosslink is used between a gateway terminal 130 and a user terminal 150, bidirectional communications for user terminal 150 (e.g., as a concurrent combination of forward link signaling and return link signaling) may necessarily involve a forward path 610 that is different than a return path 620 (e.g., using different subsets of satellites 120-e). In other words, if a satellite 120-e is transmitting crosslink signals 175 and receiving crosslink signals 175, the satellite 120-e may be allocated as either forward crosslink relay, or return crosslink relay, but not both (e.g., concurrently)

In the example of communication system implementation 600, a forward path 610 for a set of one or more user terminals 150 that includes the user terminal 150-d may include the satellites 120-e-1, 120-e-2, and 120-e-3. Forward link signaling propagated along the forward path 610 may be included in a forward uplink signal 132-j transmitted from the gateway terminal 130-d-1 (e.g., in accordance with a forward link polarization), which may be received by the satellite 120-e-1. In some examples, the gateway terminal 130-d-1 may be selected to support the forward path 610 from a set of gateway terminals 130-d based on various criteria, such as availability, network traffic, communications criteria (e.g., throughput, latency, priority), and other criteria. In some examples, the gateway terminal 130-d-1 may be selected to support forward link signaling to the user terminal 150-d based on an availability of satellites 120-e-1 (e.g., a crosslink transmitting satellite 120), 120-e-2 (e.g., a crosslink relay satellite 120), and 120-e-3 (e.g., a crosslink receiving satellite 120) to support forward crosslink signaling.

The satellite 120-e-1 may receive the forward uplink signal 132-j (e.g., in accordance with the forward link polarization), and may relay the forward link signaling by transmitting forward crosslink signal 175-j-1 (e.g., in accordance with a crosslink polarization, by activating a signal path 505-c of the satellite 120-e-1, in accordance with a payload implementation 500-c), which may be received by the satellite 120-e-2. In some cases, the relaying of the forward link signaling may include the satellite 120-e-1 converting the frequency of the forward link signaling from an uplink frequency range of the forward uplink signal 132-j to a crosslink frequency range of the forward crosslink signal 175-j-1 (e.g., from an uplink frequency band between 81 GHz and 86 GHz to a crosslink frequency band between 61 GHz and 66 GHZ). To receive the forward uplink signal 132-j, the satellite 120-e-1 may be configured to generate a beam 125-j-1 (e.g., a receive beam) along a beam direction 127-j-1 toward the gateway terminal 130-d-1. The beam 125-j-1 may be formed using a beamforming network (e.g., a beamforming network 420-b), which may be configured by a control system 460 (e.g., to implement beam weights at the beamforming network to align directional reception along the beam direction 127-j-1, to generate the beam 125-j-1). To transmit the forward crosslink signal 175-j-1, the satellite 120-e-1 may be configured to generate a beam 125-j-2 (e.g., a transmit beam) along a beam direction 127-j-2 toward the satellite 120-e-2. The beam 125-j-2 may be formed using a beamforming network (e.g., a different beamforming network than used for the beam 125-j-1, such as a beamforming network 440-b or 440-c, to form a crosslink beam), which may also be configured by the control system 460 (e.g., to implement beam weights at the beamforming network to align directional transmission along the beam direction 127-j-2). In some examples, the satellite 120-e-1 may be configured to activate one or more other signal paths of a payload 400. For example, the satellite 120-e-1 may (e.g., concurrently with the forward link relaying, concurrently with the activated signal path 505-c) activate a signal path 505-f to support return crosslink-to-downlink relays (e.g., in accordance with the payload implementation 500-f), or activate a signal path 505-g to support return uplink-to-downlink relays of a service area (e.g., in accordance with the payload implementation 500-g, to the gateway terminal 130-d-1 or another gateway terminal 130), depending on an availability of power or an orientation of respective antenna arrays and signaling directions.

The satellite 120-e-2 may receive the forward crosslink signal 175-j-1 (e.g., in accordance with the crosslink polarization), and may relay the forward link signaling by transmitting forward crosslink signal 175-j-2 (e.g., in accordance with the crosslink polarization, by activating a signal path 505-d of the satellite 120-e-2, in accordance with a payload implementation 500-d), which may be received by the satellite 120-e-3. In some cases, the relaying of the forward link signaling may include the satellite 120-e-2 maintaining the crosslink frequency range of the forward crosslink signal 175-j-1 for the forward crosslink signal 175-j-2 (e.g., the crosslink frequency band between 61 GHz and 66 GHZ, without a frequency conversion). To receive the forward crosslink signal 175-j-1, the satellite 120-e-2 may be configured to generate a beam 125-j-3 (e.g., a receive beam) along a beam direction 127-j-3 toward the satellite 120-e-1. The beam 125-j-3 may be formed using a beamforming network (e.g., a beamforming network 420-c), which may be configured by a control system 460 (e.g., to implement beam weights at the beamforming network to align directional reception along the beam direction 127-j-3, to generate the beam 125-j-3). To transmit the forward crosslink signal 175-j-2, the satellite 120-e-2 may be configured to generate a beam 125-j-4 (e.g., a transmit beam) along a beam direction 127-j-4 toward the satellite 120-e-3. The beam 125-j-4 may be formed using a beamforming network (e.g., a different beamforming network than used for the beam 125-j-3, such as a beamforming network 440-b or 440-c, to form a crosslink beam), which may also be configured by the control system 460 (e.g., to implement beam weights at the beamforming network to align directional transmission along the beam direction 127-j-4). In some examples, the satellite 120-e-2 may be configured to activate one or more other signal paths of a payload 400. For example, the satellite 120-e-2 may (e.g., concurrently with the forward link relaying, concurrently with the activated signal path 505-d) activate a signal path 505-a to support forward uplink-to-downlink relays of a service area (e.g., in accordance with the payload implementation 500-a), or activate a signal path 505-g to support return uplink-to-downlink relays of a service area (e.g., in accordance with the payload implementation 500-g), or both (e.g., with one or more other gateway terminals 130, with one or more other user terminals 150, depending on an availability of power, depending on an orientation of respective antenna arrays and signaling directions). Although the illustrated example of forward path 610 includes the satellite 120-e-2 as a single forward crosslink relay satellite 120, a forward path 610 in accordance with the described techniques may implement any quantity of one or more forward crosslink relay satellites 120, which may be configured in accordance with one or more aspects described with reference to the satellite 120-e-2, or may omit a forward crosslink relay satellite 120.

The satellite 120-e-3 may receive the forward crosslink signal 175-j-2 (e.g., in accordance with the crosslink polarization), and may relay the forward link signaling by transmitting forward downlink signal 172-j (e.g., in accordance with the forward polarization, by activating a signal path 505-b of the satellite 120-e-3, in accordance with the payload implementation 500-b), which may be received by the user terminal 150-d. In some cases, the relaying of the forward link signaling may include the satellite 120-e-3 converting the frequency of the forward link signaling from the crosslink frequency range of the forward crosslink signal 175-j-2 to a downlink frequency range of the forward downlink signal 172-j (e.g., from a crosslink frequency band between 61 GHz and 66 GHz to a downlink frequency band between 71 GHz and 76 GHz). To receive the forward crosslink signal 175-j-2, the satellite 120-e-3 may be configured to generate a beam 125-j-5 (e.g., a receive beam) along a beam direction 127-j-5 toward the satellite 120-e-2. The beam 125-j-5 may be formed using a beamforming network (e.g., a beamforming network 420-c), which may be configured by a control system 460 (e.g., to implement beam weights at the beamforming network to align directional reception along the beam direction 127-j-5, to generate the beam 125-j-5). To transmit the forward downlink signal 172-j, the satellite 120-e-3 may be configured to generate a beam 125-j-6 (e.g., a transmit beam) along a beam direction 127-j-6 toward the user terminal 150-d. The beam 125-j-6 may be formed using a beamforming network (e.g., a different beamforming network than used for the beam 125-j-5, such as a beamforming network 440-b, to form a downlink beam), which may also be configured by the control system 460 (e.g., to implement beam weights at the beamforming network to align directional transmission along the beam direction 127-j-6). In some examples, the satellite 120-e-3 may be configured to activate one or more other signal paths of a payload 400. For example, the satellite 120-e-3 may (e.g., concurrently with the forward link relaying, concurrently with the activated signal path 505-b) activate a signal path 505-e to support return uplink-to-crosslink relays (e.g., in accordance with the payload implementation 500-e), or activate a signal path 505-g to support return uplink-to-downlink relays of a service area (e.g., in accordance with the payload implementation 500-g), from the user terminal 150-d or one or more other user terminals 150, depending on an availability of power or an orientation of respective antenna arrays and signaling directions.

In the example of communication system implementation 600, the user terminal 150-d may be configured for bidirectional communication. For example, the bidirectional communication by the user terminal 150-d may refer to the user terminal 150-d being configured to receive signaling (e.g., forward link signaling) in a first direction and transmit signaling (e.g., return link signaling) in a second direction different than the first direction. For example, the user terminal 150-d may receive the forward downlink signal 172-j, including the forward link signaling, from the satellite 120-e-3. The user terminal 150-d may also transmit a return uplink signal 173-j, including return link signaling, to a satellite 120-e-4 along the return path 620.

In the example of communication system implementation 600, a return path 620 for a set of one or more user terminals 150 that includes the user terminal 150-d may include the satellites 120-e-4, 120-e-5, and 120-e-6. The subset of the satellites 120-e that are allocated to the return path 620 may be different than the subset of the satellites 120-e that are allocated to the forward path 610 which, in some examples, may be related to at least one of the satellites 120-e being configured with a single crosslink pathway (e.g., a pathway 540). In some implementations (e.g., as illustrated in the example of communication system implementation 600), the satellites 120-e of the forward path 610 may be exclusive of the satellites 120-e of the return path 620. In some examples, such configurations may support relatively low-cost satellites 120-e that are suitable for implementation in a constellation of many satellites 120, such as in an NGSO communication system 100. Return link signaling propagated along the return path 620 may be included in the return uplink signal 173-j transmitted from the user terminal 150-d (e.g., in accordance with a return link polarization), which may be received by the satellite 120-e-4.

The satellite 120-e-4 may receive the return uplink signal 173-j (e.g., in accordance with the return link polarization), and may relay the return link signaling by transmitting return crosslink signal 175-j-3 (e.g., in accordance with a crosslink polarization, by activating a signal path 505-e of the satellite 120-e-4, in accordance with the payload implementation 500-e), which may be received by the satellite 120-e-5. In some cases, the relaying of the return link signaling may include the satellite 120-e-1 converting the frequency of the return link signaling from an uplink frequency range of the return uplink signal 173-j to a crosslink frequency range of the return crosslink signal 175-j-3 (e.g., from an uplink frequency band between 81 GHz and 86 GHz to a crosslink frequency band between 61 GHz and 66 GHZ). To receive the return uplink signal 173-j, the satellite 120-e-4 may be configured to generate a beam 125-j-7 (e.g., a receive beam) along a beam direction 127-j-7 toward the user terminal 150-d. The beam 125-j-7 may be formed using a beamforming network (e.g., a beamforming network 420-a), which may be configured by a control system 460 (e.g., to implement beam weights at the beamforming network to align directional reception along the beam direction 127-j-7, to generate the beam 125-j-7). To transmit the return crosslink signal 175-j-3, the satellite 120-e-4 may be configured to generate a beam 125-j-8 (e.g., a transmit beam) along a beam direction 127-j-8 toward the satellite 120-e-5. The beam 125-j-8 may be formed using a beamforming network (e.g., a different beamforming network than used for the beam 125-j-7, such as a beamforming network 440-b or 440-c, to form a crosslink beam), which may also be configured by the control system 460 (e.g., to implement beam weights at the beamforming network to align directional transmission along the beam direction 127-j-8). In some examples, the satellite 120-e-4 may be configured to activate one or more other signal paths of a payload 400. For example, the satellite 120-e-4 may (e.g., concurrently with the return link relaying, concurrently with the activated signal path 505-e) activate a signal path 505-a to support forward uplink-to-downlink relays of a service area (e.g., in accordance with the payload implementation 500-a), or activate a signal path 505-b to support forward crosslink-to-downlink relays (e.g., in accordance with the payload implementation 500-b), to the user terminal 150 or one or more other user terminals 150, depending on an availability of power or an orientation of respective antenna arrays and signaling directions).

The satellite 120-e-5 may receive the return crosslink signal 175-j-3 (e.g., in accordance with the crosslink polarization), and may relay the return link signaling by transmitting return crosslink signal 175-j-4 (e.g., in accordance with the crosslink polarization, by activating a signal path 505-d of the satellite 120-e-5, in accordance with the payload implementation 500-d), which may be received by the satellite 120-e-6. In some cases, the relaying of the return link signaling may include the satellite 120-e-5 maintaining the crosslink frequency range of the return crosslink signal 175-j-3 for the return crosslink signal 175-j-4 (e.g., the crosslink frequency band between 61 GHz and 66 GHZ). To receive the return crosslink signal 175-j-3, the satellite 120-e-5 may be configured to generate a beam 125-j-9 (e.g., a receive beam) along a beam direction 127-j-9 toward the satellite 120-e-4. The beam 125-j-9 may be formed using a beamforming network (e.g., a beamforming network 420-c), which may be configured by a control system 460 (e.g., to implement beam weights at the beamforming network to align directional reception along the beam direction 127-j-9, to generate the beam 125-j-9). To transmit the return crosslink signal 175-j-4, the satellite 120-e-5 may be configured to generate a beam 125-j-10 (e.g., a transmit beam) along a beam direction 127-j-10 toward the satellite 120-e-6. The beam 125-j-10 may be formed using a beamforming network (e.g., a different beamforming network than used for the beam 125-j-9, such as a beamforming network 440-b or 440-c, to form a crosslink beam), which may also be configured by the control system 460 (e.g., to implement beam weights at the beamforming network to align directional transmission along the beam direction 127-j-10). In some examples, the satellite 120-e-5 may be configured to activate one or more other signal paths of a payload 400. For example, the satellite 120-e-5 may (e.g., concurrently with the return link relaying, concurrently with the activated signal path 505-d) activate a signal path 505-a to support forward uplink-to-downlink relays of a service area (e.g., in accordance with the payload implementation 500-a), or activate a signal path 505-g to support return uplink-to-downlink relays of a service area (e.g., with one or more other gateway terminals 130, with one or more other user terminals 150, in accordance with the payload implementation 500-g), or both (e.g., depending on an availability of power, depending on an orientation of respective antenna arrays and signaling directions). Although the illustrated example of return path 620 includes the satellite 120-5-2 as a single return crosslink relay satellite 120, a return path 620 in accordance with the described techniques may implement any quantity of one or more return crosslink relay satellites 120, which may be configured in accordance with one or more aspects described with reference to the satellite 120-e-5, or may omit a return crosslink relay satellite 120.

The satellite 120-e-6 may receive the return crosslink signal 175-j-4 (e.g., in accordance with the crosslink polarization), and may relay the return link signaling by transmitting return downlink signal 133-j (e.g., in accordance with the return polarization, by activating a signal path 505-f of the satellite 120-e-6, in accordance with the payload implementation 500-f). In some cases, the relaying of the return link signaling may include the satellite 120-e-6 converting the frequency of the return link signaling from the crosslink frequency range of the return crosslink signal 175-j-4 to a downlink frequency range of the return downlink signal 133-j (e.g., from a crosslink frequency band between 61 GHz and 66 GHz to a downlink frequency band between 71 GHz and 76 GHz). To receive the return crosslink signal 175-j-2, the satellite 120-e-6 may be configured to generate a beam 125-j-11 (e.g., a receive beam) along a beam direction 127-j-11 toward the satellite 120-e-5. The beam 125-j-11 may be formed using a beamforming network (e.g., a beamforming network 420-a), which may be configured by a control system 460 (e.g., to implement beam weights at the beamforming network to align directional reception along the beam direction 127-j-11, to generate the beam 125-j-1). In some examples, the satellite 120-e-6 may be configured to activate one or more other signal paths of a payload 400. For example, the satellite 120-e-6 may (e.g., concurrently with the return link relaying, concurrently with the activated signal path 505-f) activate a signal path 505-a to support forward uplink-to-downlink relays of a service area (e.g., in accordance with the payload implementation 500-a), or activate a signal path 505-b to support forward uplink-to-crosslink relays (e.g., in accordance with the payload implementation 500-b), from the gateway terminals 130-d-1 or 130-d-2 or one or more other gateway terminals 130, depending on an availability of power or an orientation of respective antenna arrays and signaling directions.

In various examples, the return downlink signal 133-j may be received by the gateway terminal 130-d-1 (e.g., a same gateway that transmitted the forward uplink signal 132-j, a same gateway as a beginning of the forward path 610), or the return downlink signal may be received by a gateway terminal 130-d-2 (e.g., a different gateway than the one that transmitted the forward uplink signal 132-j, a different gateway than one that starts the forward path 610). In other words, for bidirectional communications of a given user terminal 150, a forward path 610 and a return path 620 may form a closed loop via a same gateway terminal 130, or may not form such a closed loop. In various examples, a selection of one or more gateway terminals 130 for bidirectional communications of a user terminal 150 may be based on a quantity of satellites 120 involved in such relaying (e.g., selecting a relatively lower quantity of relays for either forward or return signaling), a difference in service characteristics for or between forward and return signaling (e.g., a difference in latency requirements, a difference in throughput requirements, a difference in relative priority between forward and return communications), an availability of satellites 120 for crosslink relaying, a priority of communications of the subject user terminal 150 relative to other user terminals 150, among other considerations or combinations thereof. To transmit the return downlink signal 133-j to the gateway terminal 130-d-1, for example, the satellite 120-e-6 may be configured to generate a beam 125-j-12 (e.g., a transmit beam) along a beam direction 127-j-12 toward the gateway terminal 130-d-1. Alternatively, to transmit the return downlink signal 133-j to the gateway terminal 130-d-2, the satellite 120-e-6 may be configured to generate a beam 125-j-13 along a beam direction 127-j-13 toward the gateway terminal 130-d-2. The beam 125-j-12 or the beam 125-j-13 may be formed using a beamforming network (e.g., a different beamforming network than used for the beam 125-j-11, such as a beamforming network 440-a, to form a downlink beam), which may also be configured by the control system 460 (e.g., to implement beam weights at the beamforming network to align directional transmission along the beam direction 127-j-12 or 127-j-13).

In some cases, a respective positioning and steering system of each satellite 120-e may be configured to orient a direction of the satellite 120-e toward a target or location. For example, a respective positioning and steering system of the satellites 120-e-1, 120-e-3, 120-e-4, and 120-e-6 may orient respective directions (e.g., of one or more of a side 211, 212, 215, 315, or 316, of one or more of an axis 245, 255, 265, or 275) toward a location within a service area (e.g., a target 510). A service area may be a geographical coverage area associated with a respective set of one or more gateway terminals 130, or a respective set of one or more user terminals 150, or both. In some implementations, the location may be a fixed location associated with a service area (e.g., a ground location, a central location). In some examples, the location may be a central location (e.g., a center) of a service area, and aligning the direction toward the location may facilitate relatively small scan angles (e.g., scan angles within a threshold) for beamforming beams 125 toward different locations within the service area (e.g., along various directions, toward user terminals 150 for user beams 125, toward gateway terminals 130 for gateway beams). Additionally, a respective positioning and steering system of the satellites 120-e-2 and 120-e-5 may orient the respective directions between pairs of satellites 120 to support crosslink communications. For example, the satellite 120-e-2 may be oriented based on the position of the satellites 120-e-1 and 120-e-3, and the satellite 120-e-5 may be oriented based on the position of the satellites 120-e-4 and 120-e-6 (e.g., in accordance with a payload implementation 500-d). While servicing communications of a service area, the satellites 120-e may steer the toward a target continuously or discontinuously (e.g., in accordance with multiple discrete steering impulses).

Although the example of communication system implementation 600 shows certain combinations of satellites 120-e, and their configurations, for supporting a forward path 610 and a return path 620, a forward path 610 and a return path 620 may change over time for supporting communications with a given user terminal 150. For example, a satellite 120 may be added to, removed from, or swapped from a forward path 610, a return path 620, or both. Such changes may be based on changes in locations 525 of one or more satellites 120 along respective orbital paths 520, or changes in communications utilization (e.g., changes in traffic for the user terminal 150 or other user terminals 150, addition of user terminals 150, changes in priority of communications, changes in performance characteristics of communications). Further, such changes may be based on adding gateway terminals 130 to a communication system 100, which may support bidirectional communications with fewer crosslink relays, or a gateway terminal 130 dropping from or being removed from service, which may involve more crosslink relays being implemented to support relatively remote user terminals, among other examples. Additionally, or alternatively, such changes may be based on changes among one or more gateway terminals 130 being selected to support forward link communications, return link communications, or both (e.g., a change between using a single gateway terminal 130 for bidirectional communications and multiple gateway terminals 130 for bidirectional communications, a change from one gateway terminal 130 to another based on a change in communications type or a change in target network device 141).

Thus, in accordance with these and other examples, one or more devices of a communication system 100 (e.g., one or more gateway terminals 130, one or more network devices such as a scheduling entity) may configure a user terminal 150 for bidirectional communications during a duration, configure one or more first satellites 120 along a forward path 610 for relaying forward signaling of the bidirectional communications to the user terminal 150 during the duration, and configure one or more second satellites 120 (e.g., different than the one or more first satellites 120, exclusive of the one or more first satellites 120) along a return path 620 for relaying return signaling of the bidirectional communications from the user terminal 150 during the duration. In some examples, at least one of the satellites 120 may be configured as a crosslink relay to receive forward signaling or return signaling from a crosslink transmitting satellite 120 (e.g., via an reception array 260 on a first side of the satellite 120 within a first frequency band, and to transmit the forward signaling or the return signaling to a crosslink receiving satellite 120 (via a transmission array 270 or a transmission array 250, on a second side of the satellite) within the first frequency band (e.g., without a frequency conversion between the reception and the transmission). Such techniques may be implemented to leverage relatively less complex and less-costly satellites 120 that may support deployment in large constellations of satellites 120, such as in an NGSO satellite communication system 100.

A communication system 100 may be configured to perform operations of the communication system implementation 600 by various means. For example, the gateway terminal(s) 130-d, the satellites 120-e, or the user terminal 150-d may be configured by one or more devices of the corresponding communication system 100, such as one or more controllers of a ground segment 101, which may transmit configuration signaling to the gateway terminal(s) 130-d, the satellites 120-e, or the user terminal 150-d (e.g., directly, relayed via another device). The one or more controllers may determine information, such as information about communications allocations, terminal locations, characteristics of orbital paths 520, information about targets 510, directions 127, beamforming weights, and other information. The one or more controllers may signal one or more aspects of the information from the ground segment to the satellites 120-e or the user terminal 150-d (e.g., via uplink signals 132, signals 181, signals 183, signals 173, signals 175 or a combination thereof, signals from a gateway terminal 130 received along an earlier point on the orbital path 520, which may be relayed via another satellite 120 or a satellite 180). For example, a network device 141 or a gateway terminal 130 (e.g., a network controller) may determine various aspects of the configuration of the satellites 120-e or user terminal 150-d to support one or more configurations for relaying signaling (e.g., forward signaling, return signaling), and may configure the satellites 120-e or user terminal 150-d by way of signaling to the satellites 120-e or user terminal 150-d.

FIG. 7 shows a flowchart illustrating a method 700 that supports single-direction crosslinks in satellite communication systems in accordance with aspects of the present disclosure. The operations of the method 700 may be implemented by a satellite communications system or its components as described herein. For example, the operations of the method 700 may be performed by components of a satellite communication system as described with reference to FIGS. 1 through 6. In some examples, aspects of a satellite communication system may execute a set of instructions to control functional elements of the satellite communications system to perform the described functions. Additionally, or alternatively, the satellite communications system may perform aspects of the described functions using one or more instances of special-purpose hardware. Although the method 700 is illustrated with example operations in an illustrative order, various operations of the method 700 may be modified, omitted, added, or performed in a different order in accordance with the described techniques.

At 705, the method may include configuring a user terminal for bidirectional communications during a duration.

At 710, the method may include configuring one or more first satellites along a forward path for relaying first signaling of the bidirectional communications to the user terminal during a duration.

At 715, the method may include configuring one or more second satellites (e.g., different than the one or more first satellites, exclusive of the one or more first satellites) along a return path for relaying second signaling of the bidirectional communications from the user terminal during the duration, wherein at least one satellite of the one or more first satellites or the one or more second satellites is configured as a crosslink relay to receive one of the first signaling or the second signaling from a crosslink transmitting satellite via a first antenna array on a first side of the at least one satellite within a first frequency band and transmit the one of the first signaling or the second signaling to a crosslink receiving satellite via a second antenna array on a second side of the at least one satellite, different than the first side, within the first frequency band (e.g., without a frequency conversion between the reception and the transmission).

In some examples of the method 700, configuring a first satellite of the one or more first satellites for relaying the first signaling comprises configuring the first satellite to steer, through the duration, based at least in part on an orientation of a side of the first satellite relative to a service area location, and configuring a second satellite of the one or more second satellites for relaying the second signaling comprises configuring the second satellite to steer, through the duration, based at least in part on an orientation of a first side of the second satellite relative to the service area location and an orientation of a second side of the second satellite relative to a location of the at least one satellite; and configuring the at least one satellite comprises configuring a third satellite of the at least one satellite to steer, through the duration, based at least in part on an orientation of a side of the at least one satellite relative to a location of the second satellite or relative to a location of the first satellite.

In some examples of the method 700, configuring the first satellite for relaying the first signaling comprises configuring the first satellite to transmit the first signaling to the user terminal using a first transmit beam of an antenna array of the first satellite that is located on the side of the first satellite, the first transmit beam formed along a first direction relative to the orientation of the side of the first satellite, configuring the second satellite for relaying the second signaling comprises; configuring the second satellite to receive the second signaling from the user terminal using a first receive beam of a first antenna array of the second satellite that is located on the first side of the second satellite, the first receive beam formed along a second direction relative to the orientation of the first side of the second satellite, configuring the second satellite to transmit the second signaling to one of the at least one satellite using a second transmit beam of a second antenna array of the second satellite that is located on the second side of the second satellite, the second transmit beam formed along a third direction relative to the orientation of the second side of the second satellite, and configuring the third satellite comprises configuring the third satellite to receive the second signaling from the second satellite using a second receive beam of an antenna array of the third satellite that is located on the first side of the third satellite, the second receive beam formed along a fourth direction relative to the orientation of the side of the third satellite.

In some examples of the method 700, the orientation of the second side of the second satellite is different than the orientation of the first side of the second satellite.

In some examples of the method 700, configuring a fourth satellite of the one or more first satellites for relaying the first signaling during the duration; wherein; configuring the first satellite for relaying the first signaling comprises configuring the first satellite to steer, through the duration, based at least in part on an orientation of a second side of the first satellite relative to a location of the fourth satellite, and configuring the fourth satellite for relaying the first signaling comprises configuring the fourth satellite to steer, through the duration, based at least in part on an orientation of a side of the fourth satellite relative to a location of the first satellite.

In some examples of the method 700, configuring the first satellite for relaying the first signaling comprises configuring the first satellite to transmit the first signaling to the user terminal within a second frequency band exclusive of the first frequency band; configuring the second satellite for relaying the second signaling comprises configuring the second satellite to receive the second signaling from the user terminal within a third frequency band that is exclusive of the first frequency band and the second frequency band and to transmit the second signaling to the at least one satellite of the one or more second satellites within the first frequency band, and configuring the third satellite for relaying the second signaling comprises configuring the third satellite to receive the second signaling from the second satellite within the first frequency band.

In some examples of the method 700, configuring the second satellite for relaying the second signaling includes operations, features, circuitry, logic, means, or instructions, or any combination thereof for configuring the second satellite to implement a signal path associated with a frequency conversion between the third frequency band and the first frequency band.

In some examples of the method 700, the first satellite is configured in a first non-geostationary orbit and the second satellite is configured in a second non-geostationary orbit that is different than the second non-geostationary orbit.

In some examples of the method 700, an orientation of the second side of the at least one satellite is perpendicular to an orientation of the first side of the at least one satellite.

In some examples of the method 700, an orientation of the second side of the at least one satellite is opposite an orientation of the first side of the at least one satellite.

In some examples of the method 700, configuring the one or more first satellites for relaying the first signaling comprises transmitting first configuration signaling from a ground segment to the one or more first satellites and configuring the one or more second satellites for relaying the second signaling comprises transmitting second configuration signaling from the ground segment to the one or more second satellites.

Some examples of the method 700 may further include configuring a gateway terminal for transmitting the first signaling during the duration and configuring the gateway terminal for receiving the second signaling during the duration.

Some examples of the method 700 may further include configuring a first gateway terminal for transmitting the first signaling during the duration and configuring a second gateway terminal, different than the first gateway terminal, for receiving the second signaling during the duration.

In some examples, an apparatus as described herein may perform aspects of a method or methods, such as the method 700. The apparatus may include features, circuitry, logic, means, or instructions (e.g., a non-transitory computer-readable medium storing instructions executable by a processor), or any combination thereof for performing aspects of the method 700.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The “configuring” operations of the techniques described herein may refer to various techniques that support the described operations or variations thereof. In some examples, one or more aspects of such configuring may refer to one or more operations performed at the satellite 120 (e.g., “configuring, at a satellite”). For example, such “configuring” may refer to one or more operations of the satellite 120 configuring (e.g., activating) one or more signal paths, configuring one or more aspects of beamforming (e.g., configuring directional reception, configuring directional transmission, or both), configuring (e.g., steering) an orientation of the satellite 120, or any combination thereof. In various implementations, such configuring may be based at least in part on information (e.g., instructions, parameters) stored at the satellite 120, or conveyed via signals (e.g., signals 132, signals 183, signals 173) received at the satellite 120, or any combination thereof, which may be processed by one or more processors (e.g., a control system) of the satellite 120.

Additionally, or alternatively, in some examples, one or more aspects of such “configuring” may refer to one or more operations performed at one or more entities of a ground segment 101 (e.g., “transmitting an indication for a satellite to configure,” “determining a configuration for a satellite”), which may be performed at a gateway terminal 130, a network device 141 such as an NOC or a gateway command center, among other devices or combinations thereof. For example, such “configuring” may be implemented by way of one or more indications (e.g., commands, instructions, parameters) signaled to a satellite 120, which may involve signals 132, signals 181, signals 182, signals 183, signals 173, signals 175, or any combination thereof). For example, such “configuring” may refer to one or more gateway terminals 130 (e.g., to the satellite 120) transmitting one or more indications, which a satellite 120 may respond to by performing one or more operations to implement related functionality. In various examples, such indications may be determined by the one or more entities of the ground segment 101 based on various criteria, such as determinations regarding traffic scheduling, traffic demands, traffic priorities, device locations, device capabilities, attenuation environments, and other criteria.

The detailed description set forth above in connection with the appended drawings describes examples and does not represent the only examples that may be implemented or that are within the scope of the claims. The term “example,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include random access memory (RAM), read-only memory (ROM), electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for satellite communications, comprising:
configuring a user terminal for bidirectional communications during a duration;
configuring one or more first satellites along a forward path for relaying first signaling of the bidirectional communications to the user terminal during the duration; and
configuring one or more second satellites, exclusive of the one or more first satellites, along a return path for relaying second signaling of the bidirectional communications from the user terminal during the duration,
wherein at least one satellite of the one or more first satellites or the one or more second satellites is configured as a crosslink relay to:
receive one of the first signaling or the second signaling from a crosslink transmitting satellite via a first antenna array on a first side of the at least one satellite within a first frequency band; and
transmit the one of the first signaling or the second signaling to a crosslink receiving satellite via a second antenna array on a second side of the at least one satellite, different than the first side, within the first frequency band.

2. The method of claim 1, wherein:
configuring a first satellite of the one or more first satellites for relaying the first signaling comprises configuring the first satellite to steer, through the duration, based at least in part on an orientation of a side of the first satellite relative to a service area location;
configuring a second satellite of the one or more second satellites for relaying the second signaling comprises configuring the second satellite to steer, through the duration, based at least in part on an orientation of a first side of the second satellite relative to the service area location and an orientation of a second side of the second satellite relative to a location of the at least one satellite; and
configuring the at least one satellite comprises configuring a third satellite of the at least one satellite to steer, through the duration, based at least in part on an orientation of a side of the at least one satellite relative to a location of the second satellite or relative to a location of the first satellite.

3. The method of claim 2, wherein:
configuring the first satellite for relaying the first signaling comprises configuring the first satellite to transmit the first signaling to the user terminal using a first transmit beam of an antenna array of the first satellite that is located on the side of the first satellite, the first transmit beam formed along a first direction relative to the orientation of the side of the first satellite;
configuring the second satellite for relaying the second signaling comprises:
configuring the second satellite to receive the second signaling from the user terminal using a first receive beam of a first antenna array of the second satellite that is located on the first side of the second satellite, the first receive beam formed along a second direction relative to the orientation of the first side of the second satellite; and
configuring the second satellite to transmit the second signaling to one of the at least one satellite using a second transmit beam of a second antenna array of the second satellite that is located on the second side of the second satellite, the second transmit beam formed along a third direction relative to the orientation of the second side of the second satellite; and
configuring the third satellite comprises configuring the third satellite to receive the second signaling from the second satellite using a second receive beam of an antenna array of the third satellite that is located on the first side of the third satellite, the second receive beam formed along a fourth direction relative to the orientation of the side of the third satellite.

4. The method of claim 3, wherein the orientation of the second side of the second satellite is different than the orientation of the first side of the second satellite.

5. The method of claim 2, further comprising:
configuring a fourth satellite of the one or more first satellites for relaying the first signaling during the duration,
wherein:
configuring the first satellite for relaying the first signaling comprises configuring the first satellite to steer, through the duration, based at least in part on an orientation of a second side of the first satellite relative to a location of the fourth satellite; and
configuring the fourth satellite for relaying the first signaling comprises configuring the fourth satellite to steer, through the duration, based at least in part on an orientation of a side of the fourth satellite relative to a location of the first satellite.

6. The method of claim 2, wherein:
configuring the first satellite for relaying the first signaling comprises configuring the first satellite to transmit the first signaling to the user terminal within a second frequency band exclusive of the first frequency band;
configuring the second satellite for relaying the second signaling comprises configuring the second satellite to receive the second signaling from the user terminal within a third frequency band that is exclusive of the first frequency band and the second frequency band and to transmit the second signaling to the at least one satellite of the one or more second satellites within the first frequency band; and
configuring the third satellite for relaying the second signaling comprises configuring the third satellite to receive the second signaling from the second satellite within the first frequency band.

7. The method of claim 6, wherein configuring the second satellite for relaying the second signaling comprises:
configuring the second satellite to implement a signal path associated with a frequency conversion between the third frequency band and the first frequency band.

8. The method of claim 2, wherein:
the first satellite is configured in a first non-geostationary orbit; and
the second satellite is configured in a second non-geostationary orbit that is different than the second non-geostationary orbit.

9. The method of claim 1, wherein an orientation of the second side of the at least one satellite is perpendicular to an orientation of the first side of the at least one satellite.

10. The method of claim 1, wherein an orientation of the second side of the at least one satellite is opposite an orientation of the first side of the at least one satellite.

11. The method of claim 1, wherein:
configuring the one or more first satellites for relaying the first signaling comprises transmitting first configuration signaling from a ground segment to the one or more first satellites; and
configuring the one or more second satellites for relaying the second signaling comprises transmitting second configuration signaling from the ground segment to the one or more second satellites.

12. The method of claim 1, further comprising:
configuring a gateway terminal for transmitting the first signaling during the duration; and
configuring the gateway terminal for receiving the second signaling during the duration.

13. The method of claim 1, further comprising:
configuring a first gateway terminal for transmitting the first signaling during the duration; and
configuring a second gateway terminal, different than the first gateway terminal, for receiving the second signaling during the duration.

14-26. (canceled)

27. A system for satellite communications, comprising:
a plurality of satellites each in a respective non-geostationary orbit; and
a processing system in communication with the plurality of satellites, the processing system operable to cause the system to:
configure a user terminal for bidirectional communications during a duration;
configure one or more first satellites along a forward path for relaying first signaling of the bidirectional communications to the user terminal during the duration; and
configure one or more second satellites, exclusive of the one or more first satellites, along a return path for relaying second signaling of the bidirectional communications from the user terminal during the duration,
wherein at least one satellite of the one or more first satellites or the one or more second satellites is configured as a crosslink relay to:
receive one of the first signaling or the second signaling from a crosslink transmitting satellite via a first antenna array on a first side of the at least one satellite within a first frequency band; and
transmit the one of the first signaling or the second signaling to a crosslink receiving satellite via a second antenna array on a second side of the at least one satellite, different than the first side, within the first frequency band.

28. The system of claim 27, wherein:
configuring a first satellite of the one or more first satellites for relaying the first signaling comprises configuring the first satellite to steer, through the duration, based at least in part on an orientation of a side of the first satellite relative to a service area location;
configuring a second satellite of the one or more second satellites for relaying the second signaling comprises configuring the second satellite to steer, through the duration, based at least in part on an orientation of a first side of the second satellite relative to the service area location and an orientation of a second side of the second satellite relative to a location of the at least one satellite; and
configuring the at least one satellite comprises configuring a third satellite of the at least one satellite to steer, through the duration, based at least in part on an orientation of a side of the at least one satellite relative to a location of the second satellite or relative to a location of the first satellite.

29. The system of claim 28, wherein:
configuring the first satellite for relaying the first signaling comprises configuring the first satellite to transmit the first signaling to the user terminal using a first transmit beam of an antenna array of the first satellite that is located on the side of the first satellite, the first transmit beam formed along a first direction relative to the orientation of the side of the first satellite;
configuring the second satellite for relaying the second signaling comprises:
configuring the second satellite to receive the second signaling from the user terminal using a first receive beam of a first antenna array of the second satellite that is located on the first side of the second satellite, the first receive beam formed along a second direction relative to the orientation of the first side of the second satellite; and
configuring the second satellite to transmit the second signaling to one of the at least one satellite using a second transmit beam of a second antenna array of the second satellite that is located on the second side of the second satellite, the second transmit beam formed along a third direction relative to the orientation of the second side of the second satellite; and
configuring the third satellite comprises configuring the third satellite to receive the second signaling from the second satellite using a second receive beam of an antenna array of the third satellite that is located on the first side of the third satellite, the second receive beam formed along a fourth direction relative to the orientation of the side of the third satellite.

30. The system of claim 29, wherein the orientation of the second side of the second satellite is different than the orientation of the first side of the second satellite.

31. The system of claim 28, wherein the system is further configured to:
configuring a fourth satellite of the one or more first satellites for relaying the first signaling during the duration,
wherein:
configuring the first satellite for relaying the first signaling comprises configuring the first satellite to steer, through the duration, based at least in part on an orientation of a second side of the first satellite relative to a location of the fourth satellite; and
configuring the fourth satellite for relaying the first signaling comprises configuring the fourth satellite to steer, through the duration, based at least in part on an orientation of a side of the fourth satellite relative to a location of the first satellite.

32. The system of claim 28, wherein:
configuring the first satellite for relaying the first signaling comprises configuring the first satellite to transmit the first signaling to the user terminal within a second frequency band exclusive of the first frequency band;
configuring the second satellite for relaying the second signaling comprises configuring the second satellite to receive the second signaling from the user terminal within a third frequency band that is exclusive of the first frequency band and the second frequency band and to transmit the second signaling to the at least one satellite of the one or more second satellites within the first frequency band; and
configuring the third satellite for relaying the second signaling comprises configuring the third satellite to receive the second signaling from the second satellite within the first frequency band.

33. The system of claim 32, wherein configuring the second satellite for relaying the second signaling comprises:
configuring the second satellite to implement a signal path associated with a frequency conversion between the third frequency band and the first frequency band.

34. The system of claim 28, wherein:
the first satellite is configured in a first non-geostationary orbit; and
the second satellite is configured in a second non-geostationary orbit that is different than the second non-geostationary orbit.

35. The system of claim 27, wherein an orientation of the second side of the at least one satellite is perpendicular to an orientation of the first side of the at least one satellite.

36. The system of claim 27, wherein an orientation of the second side of the at least one satellite is opposite an orientation of the first side of the at least one satellite.

37. The system of claim 27, wherein:
configuring the one or more first satellites for relaying the first signaling comprises transmitting first configuration signaling from a ground segment to the one or more first satellites; and
configuring the one or more second satellites for relaying the second signaling comprises transmitting second configuration signaling from the ground segment to the one or more second satellites.

38. The system of claim 27, wherein the system is further configured to:
configuring a gateway terminal for transmitting the first signaling during the duration; and
configuring the gateway terminal for receiving the second signaling during the duration.

39. The system of claim 27, wherein the system is further configured to:
configuring a first gateway terminal for transmitting the first signaling during the duration; and
configuring a second gateway terminal, different than the first gateway terminal, for receiving the second signaling during the duration.
